(19) United States
(12) Patent Application Publication
(10) Pub. No.: US 2009/0037212 A1
(43) Pub. Date: Feb. 5, 2009

(54) AIR TRAVEL COORDINATION, COMMUNICATION AND DOCUMENTATION SYSTEM, METHOD AND COMPUTER PROGRAM

(75) Inventors: Feng Chen, Houston, TX (US); Roberto Cormack, Cypress, TX (US); Rose Dossett, Houston, TX (US); John Legh-Page, Houston, TX (US)

Correspondence Address: HAYNES AND BOONE, LLP;IP Section, 2323 Victory Avenue, Suite 700, Dallas, TX, 75219, US

(73) Assignee: AIR ROUTING INTERNATIONAL, L.P., Houston, TX (US)

(21) Appl. No.: 12/182,458

(22) Filed: Jul. 30, 2008

Related U.S. Application Data
(60) Provisional application No. 60/952,777, filed on Jul. 30, 2007.

(51) Int. Cl. G06Q 10/00

(52) U.S. Cl. 705/1

(57) ABSTRACT

System and method for the coordination, communication and documentation of air travel, including design and instructions for a computer program that maintains and operates the system and method.

### CROSS REFERENCE TO RELATED APPLICATIONS

The present application claims the benefit of U.S. Provisional Application No. 60/952,777 filed Jul. 30, 2007, the entire contents of which is specifically incorporated herein by reference without disclaimer.

### BACKGROUND OF THE INVENTION

Aviation service providers plan and execute air travel trips for clients by making arrangements with vendors who provide facilities and services necessary to carryout a trip. The provider typically receives from a client a request for specific services relating to a specific air travel trip along with the basic trip plan, including starting and ending points and schedule requirements. The provider must then create a comprehensive trip plan that includes arrangements with various vendors for a wide variety of services both for the aviator and for travelers. A comprehensive service package could include arrangements for airport landing space, fueling, ground transportation, security personnel, hotel accommodations and the like.

To keep track of and manage the elements of the services package, providers have used various commercially available software packages and relational databases that enable the provider to organize and store data relating to the elements of the air travel trip. Those packages are generally static information storage and retrieval systems.

### BRIEF DESCRIPTION OF THE DRAWINGS

FIG. 1 illustrates an exemplary overview of a Flight Management System (“FMS”) according to one embodiment of the present disclosure.

FIG. 2 illustrates an exemplary user interface for the FMS of FIG. 1.

FIG. 3 illustrates an exemplary data engine for the FMS of FIG. 1.

FIG. 4 illustrates an exemplary support database for the FMS of FIG. 1.

FIG. 5 illustrates an exemplary aircraft table for the support database of FIG. 4.

FIG. 6 illustrates an exemplary airport table for the support database of FIG. 4.

FIG. 7 illustrates an exemplary card table for the support database of FIG. 4.

FIG. 8 illustrates an exemplary city table for the support database of FIG. 4.

FIG. 9 illustrates an exemplary client table for the support database of FIG. 4.

FIG. 10 illustrates an exemplary communications table for the support database of FIG. 4.

FIG. 11 illustrates an exemplary country table for the support database of FIG. 4.

FIG. 12 illustrates an exemplary identification and passwords table for the support database of FIG. 4.

FIG. 13 illustrates an exemplary macro table for the support database of FIG. 4.

FIG. 14 illustrates an exemplary miscellaneous communications table for the support database of FIG. 4.

FIG. 15 illustrates an exemplary persons table for the support database of FIG. 4.

FIG. 16 illustrates an exemplary services table for the support database of FIG. 4.

FIG. 17 illustrates an exemplary vendor providers table for the support database of FIG. 4.

FIG. 18 illustrates an exemplary missing waypoint table for the support database of FIG. 4.

FIG. 19 illustrates an exemplary aircraft type table for the support database of FIG. 4.

FIG. 20 illustrates an exemplary trip database for the FMS of FIG. 1.

FIG. 21 illustrates an exemplary trip task table forming a part of the trip database of FIG. 20.

FIG. 22A-G is a flow chart illustration of an exemplary embodiment of the FMS of FIG. 1.

FIG. 23 shows a graphic user interface of an exemplary system login screen.

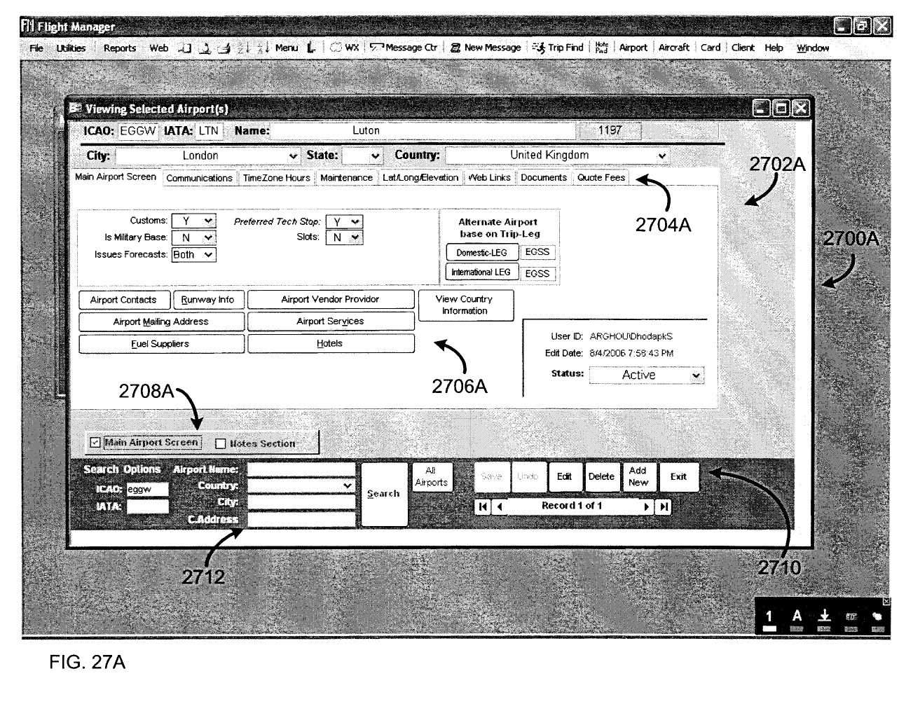

FIG. 24 shows a graphic user interface of an exemplary system main menu screen.

FIG. 25 shows a graphic user interface of an exemplary system maintenance menu screen.

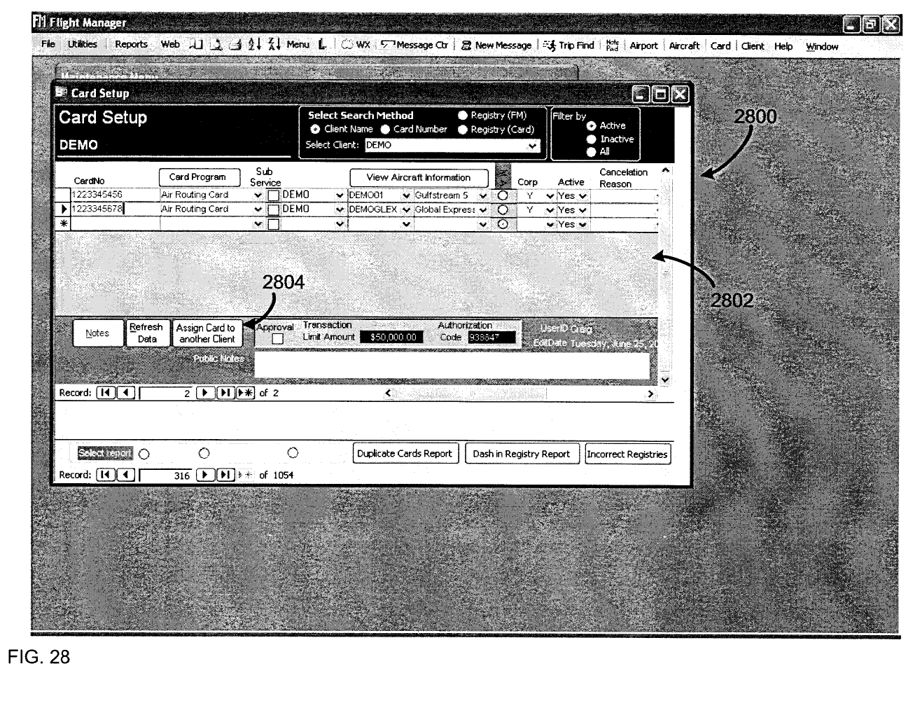

FIG. 26A shows a graphic user interface of an exemplary system aircraft table window.

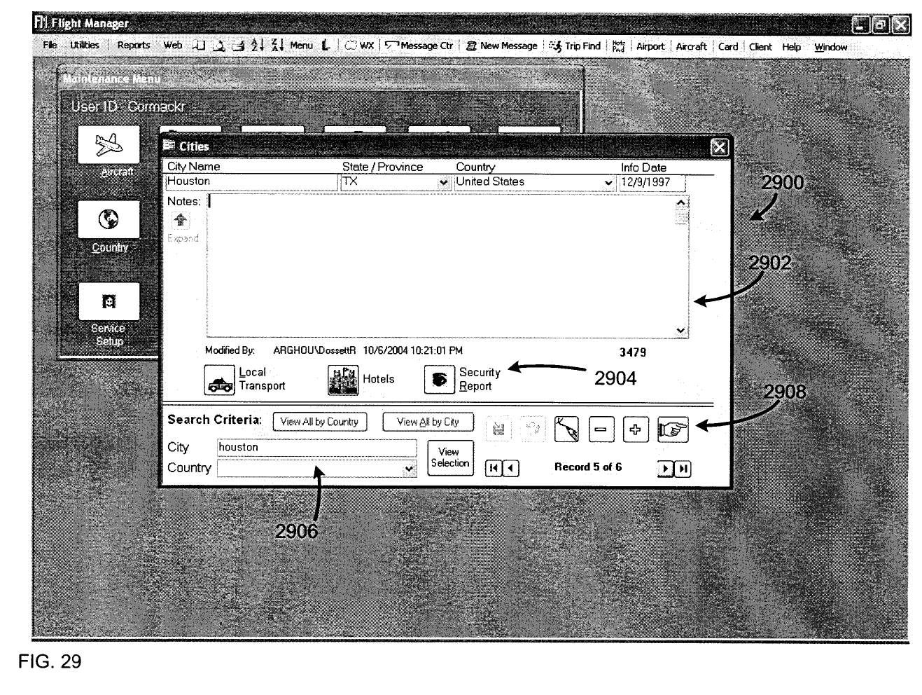

FIG. 26B shows a graphic user interface of an exemplary system supplemental aircraft table window.

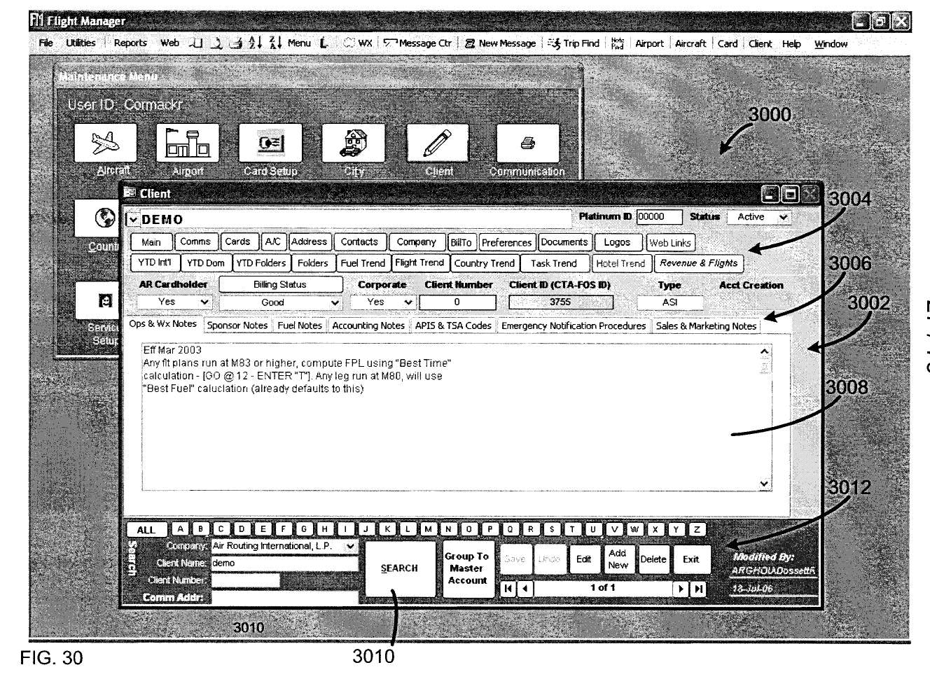

FIG. 27A shows a graphic user interface of an exemplary system airport table window.

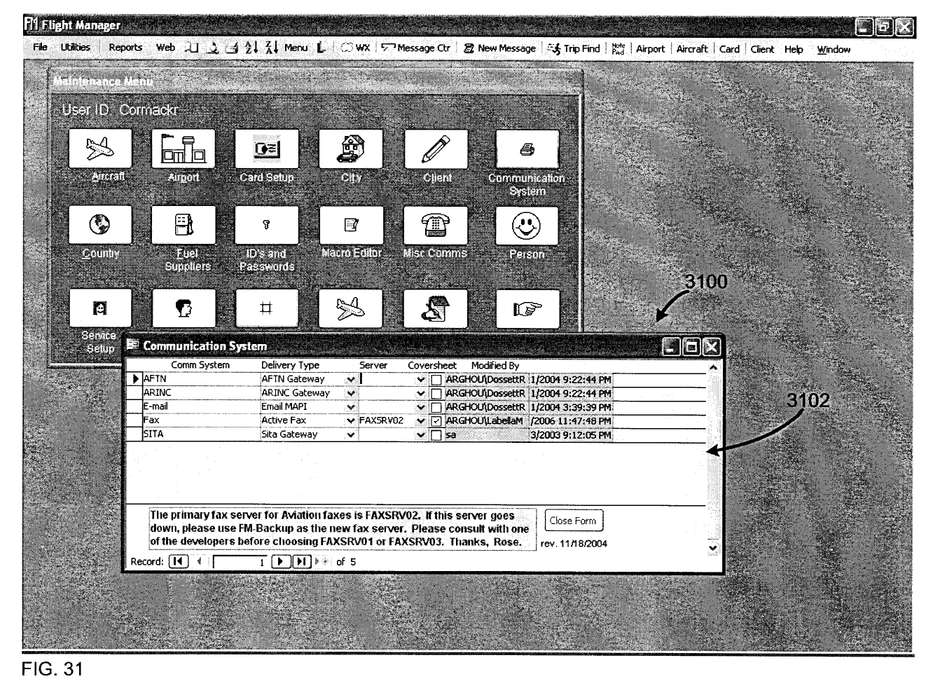

FIG. 27B shows a graphic user interface of an exemplary system airport table notes window.

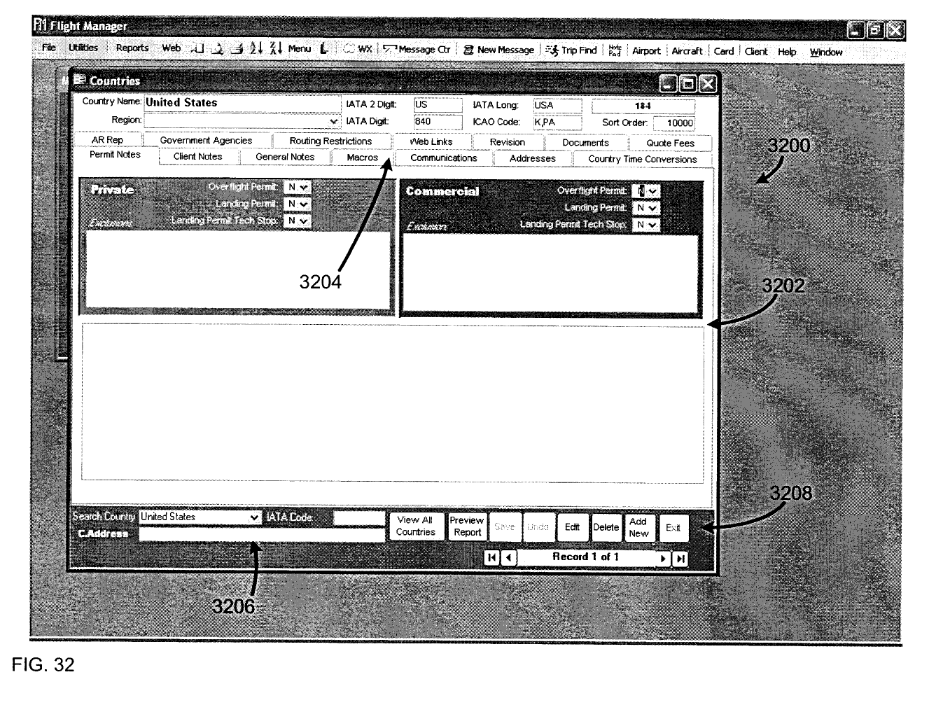

FIG. 28 shows a graphic user interface of a left-side portion of an exemplary system card table setup window.

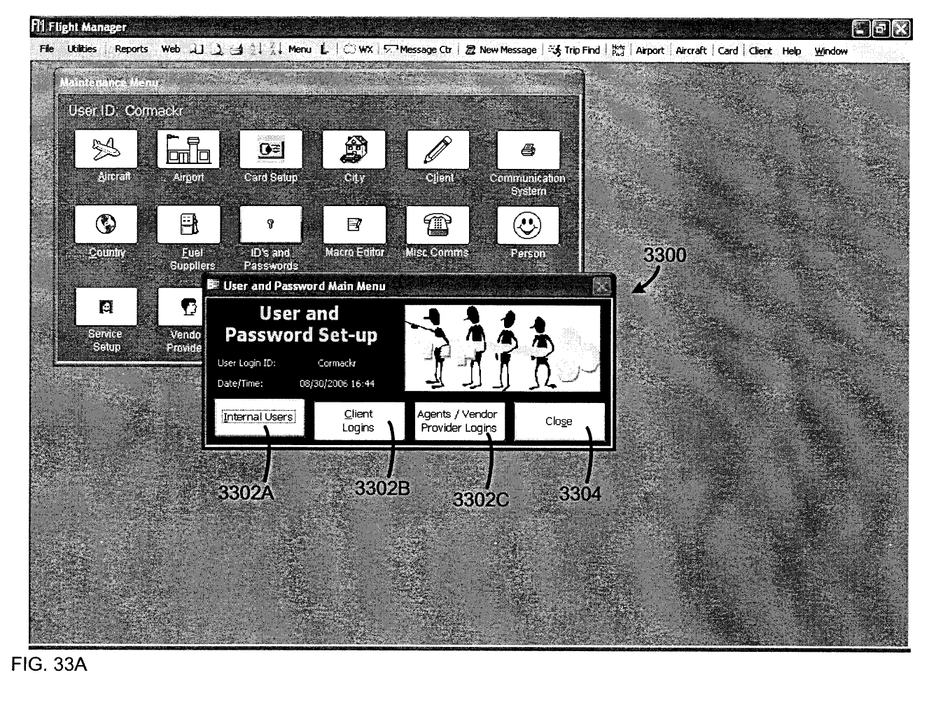

FIG. 29 shows a graphic user interface of an exemplary system city table window.

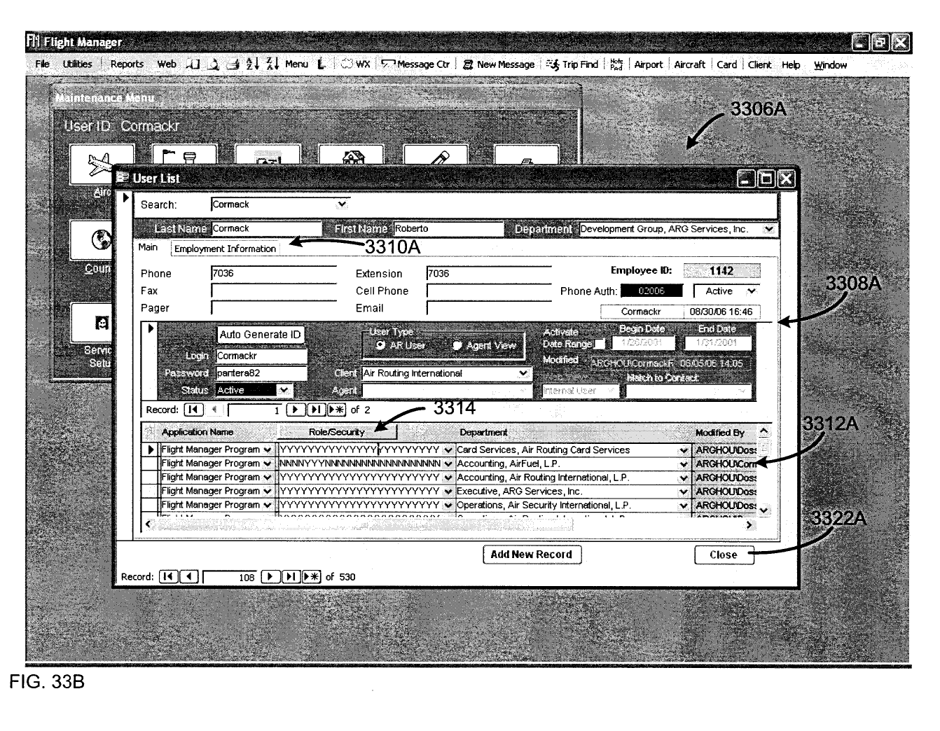

FIG. 30 shows a graphic user interface of an exemplary system client table window.

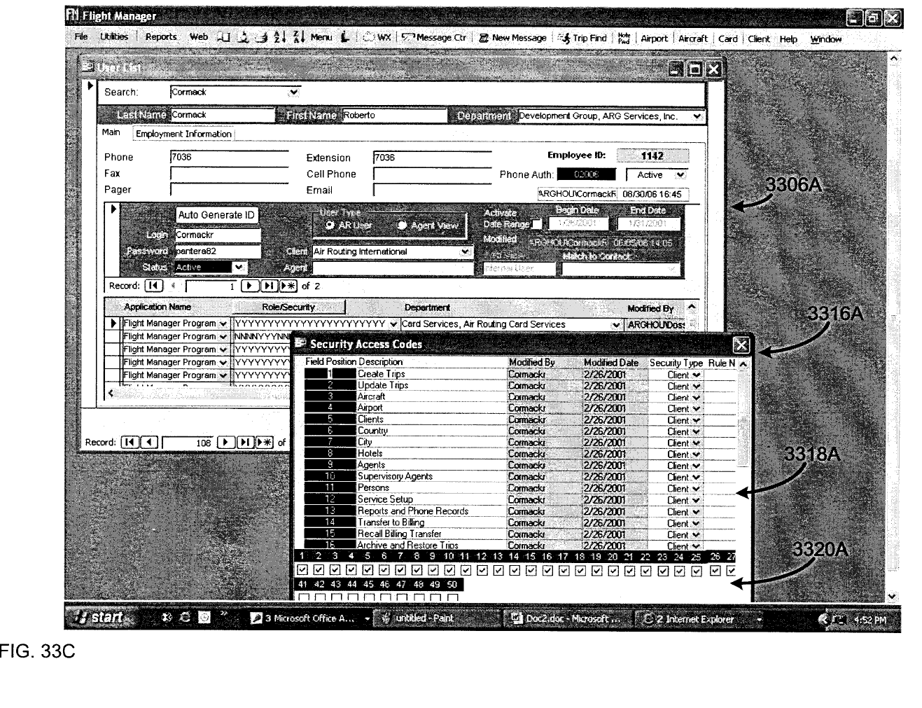

FIG. 31 shows a graphic user interface of an exemplary system communications systems table window.

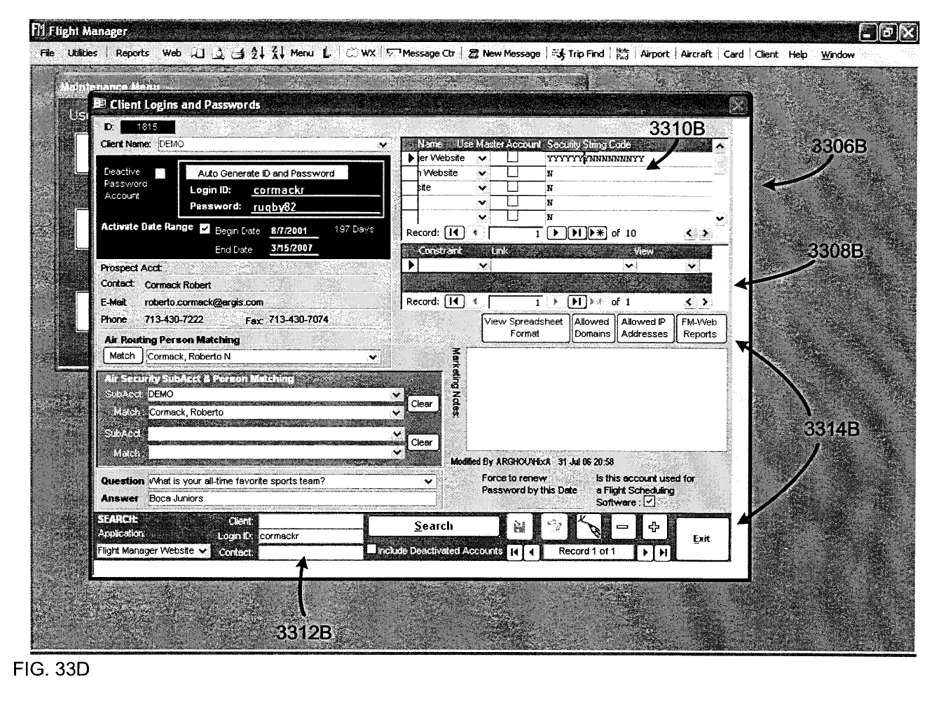

FIG. 32 shows a graphic user interface of an exemplary system country table window.

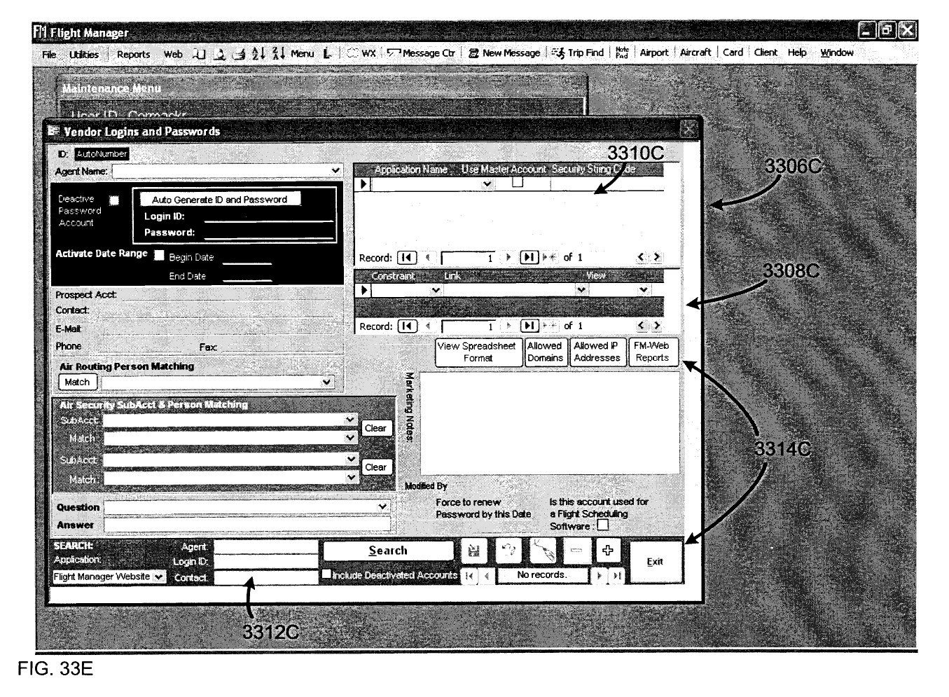

FIG. 33A-E shows a graphic user interface of exemplary system identification and passwords table windows.

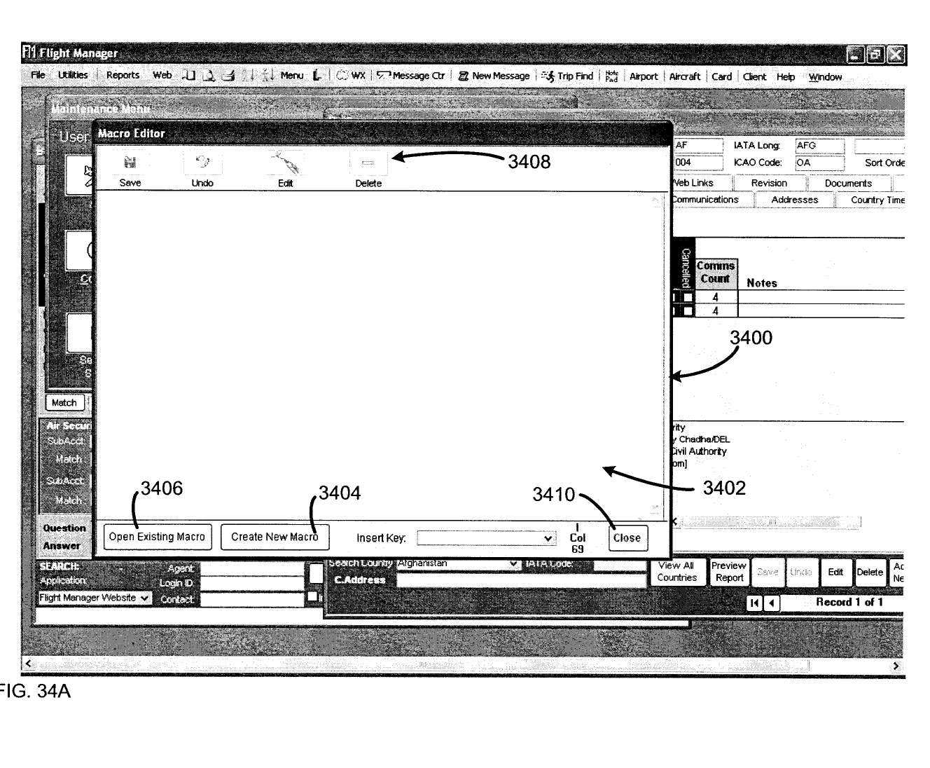

FIG. 34A shows a graphic user interface of exemplary system macro table windows.

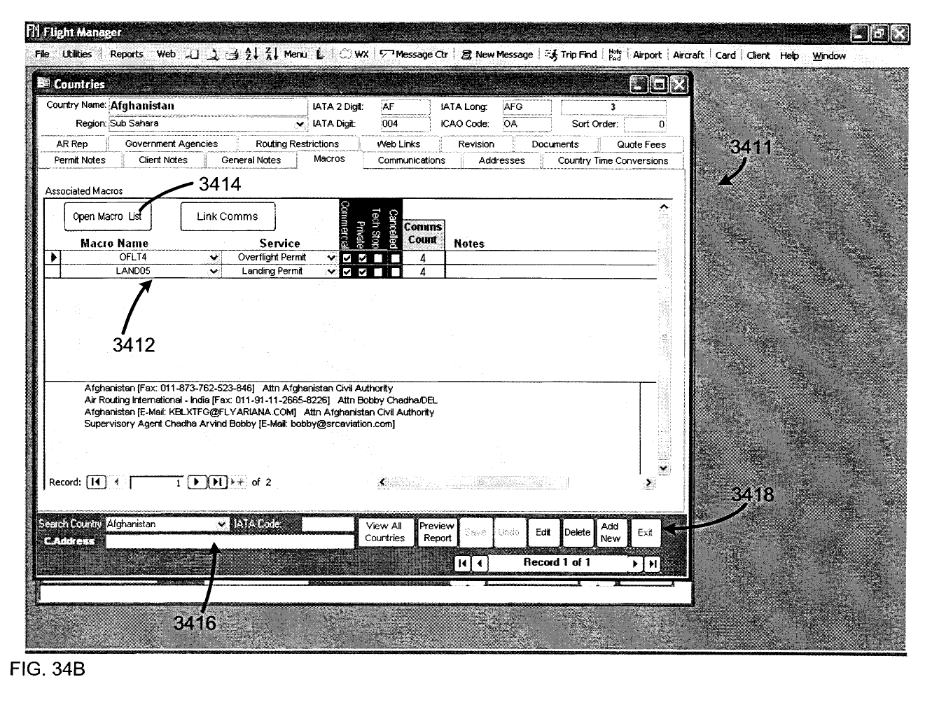

FIG. 34B shows a graphic user interface of exemplary system macro tab information page of a country table window, as in FIG. 32.

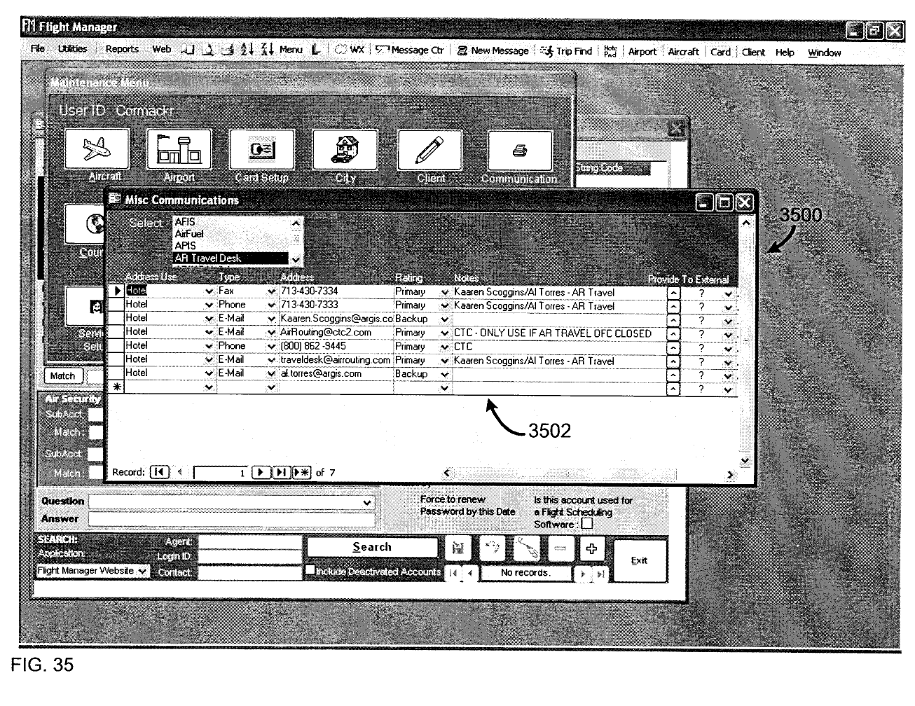

FIG. 35 shows a graphic user interface of an exemplary system miscellaneous communications table window.

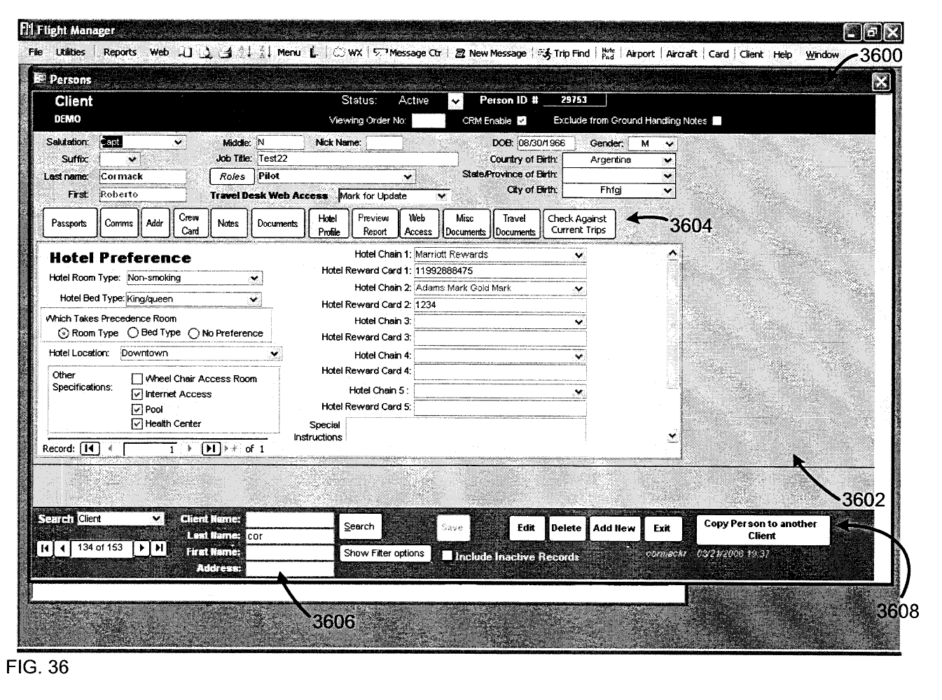

FIG. 36 shows a graphic user interface of an exemplary system persons table window.

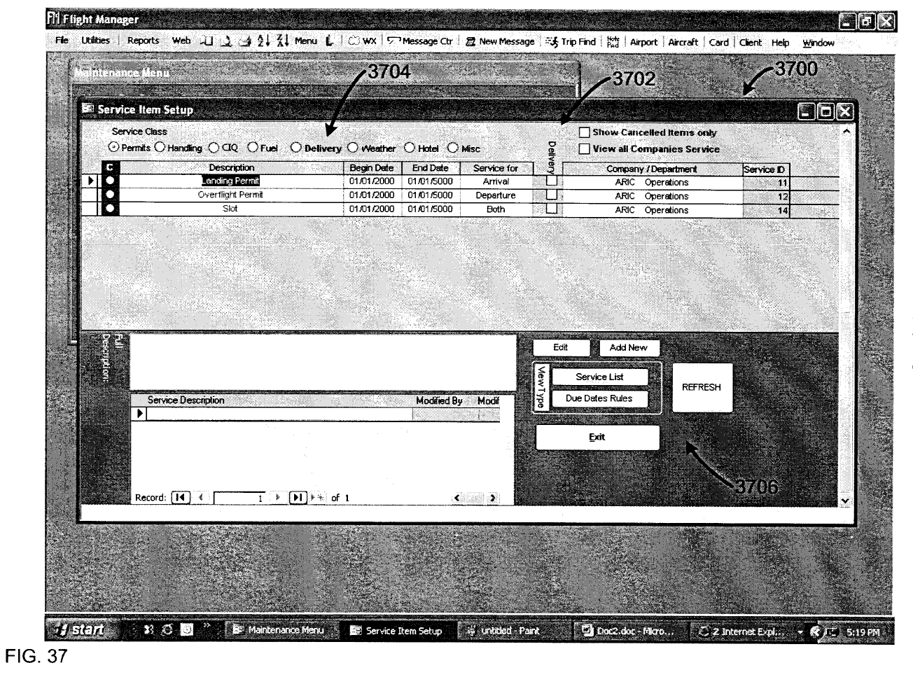

FIG. 37 shows a graphic user interface of an exemplary system services table setup window.

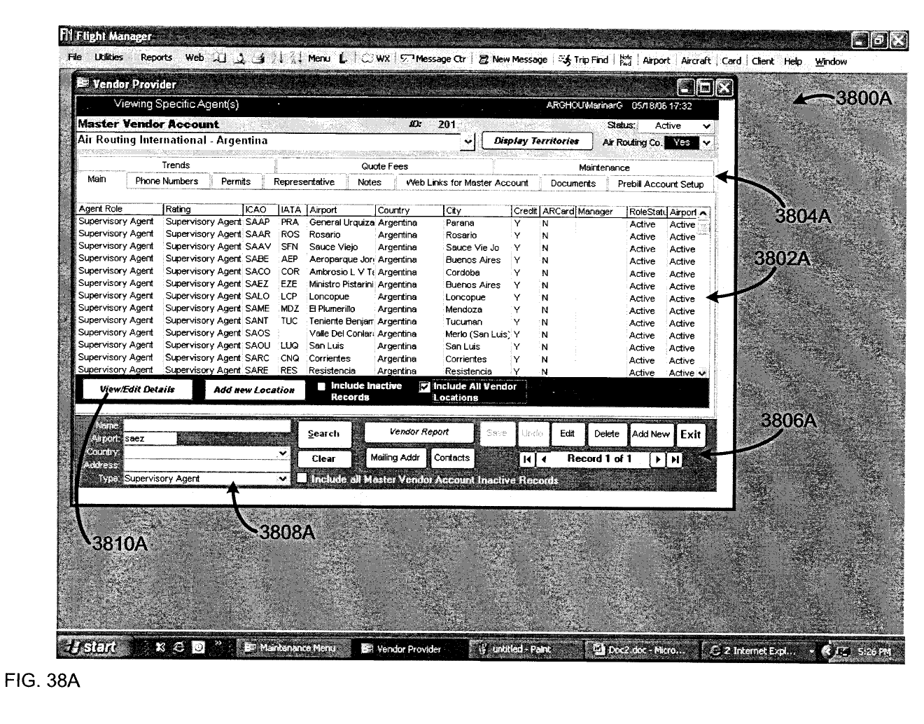

FIG. 38A-B shows a graphic user interface of exemplary system vendor providers table windows.

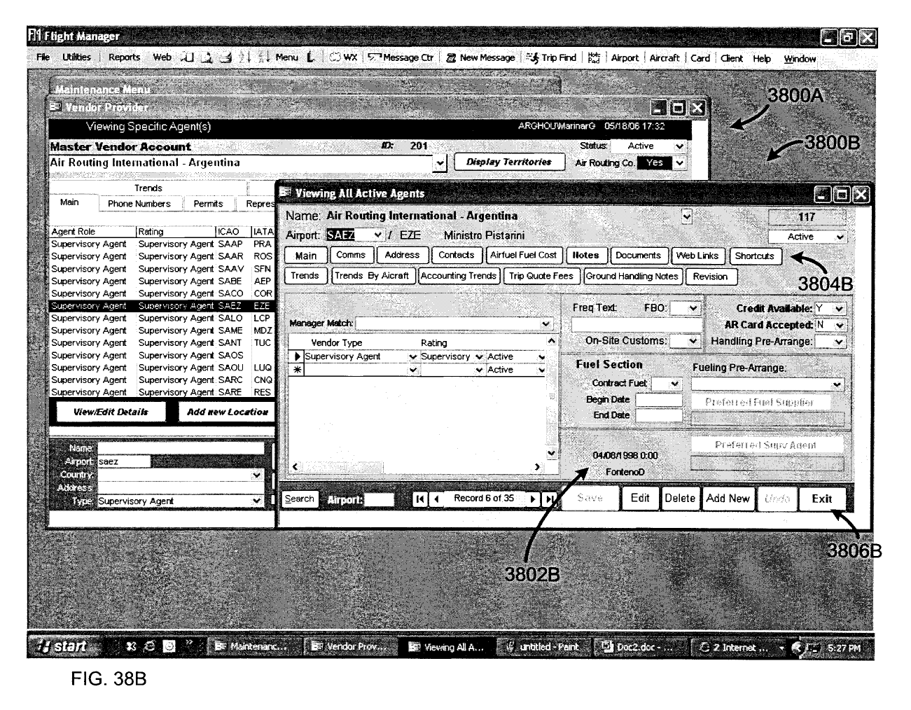

FIG. 39 shows a graphic user interface of an exemplary system missing waypoint table window.

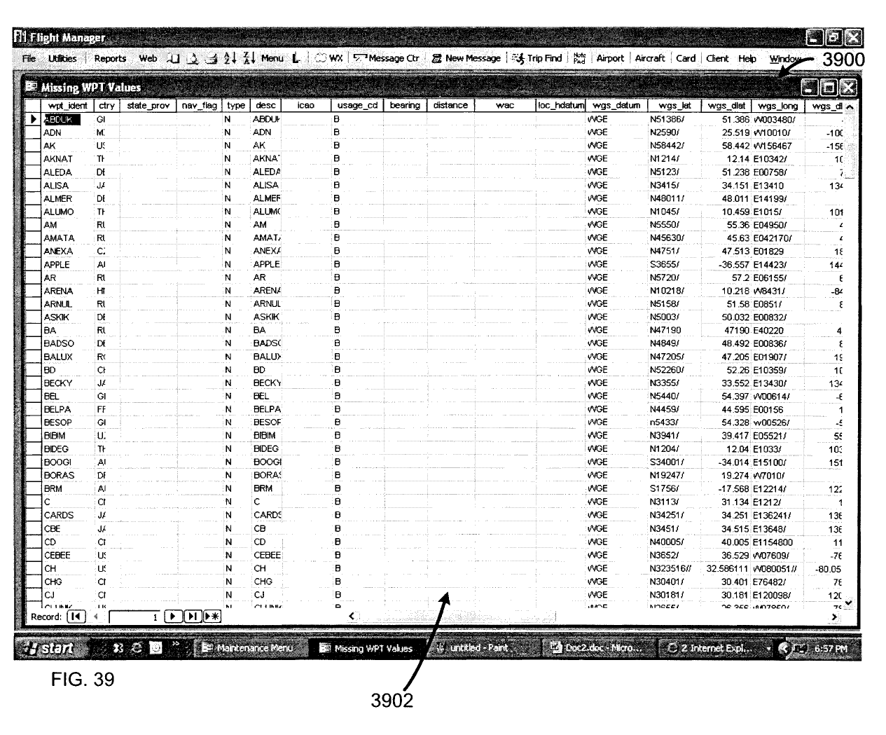

FIG. 40 shows a graphic user interface of an exemplary system aircraft type table window.

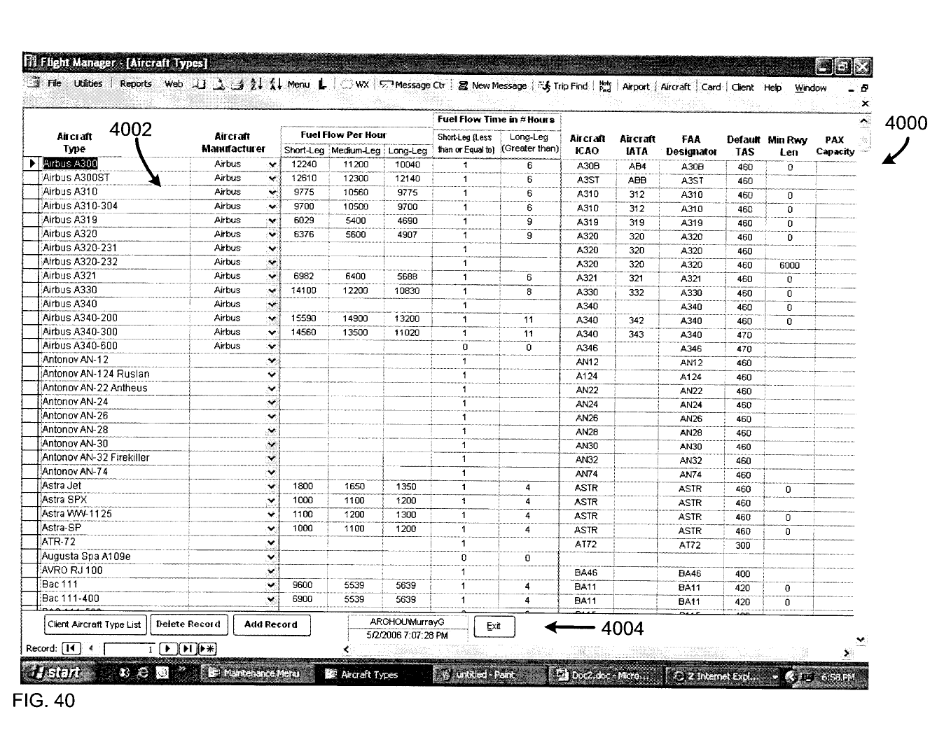

FIG. 41 shows a graphic user interface of an exemplary system managed trip folder list window.

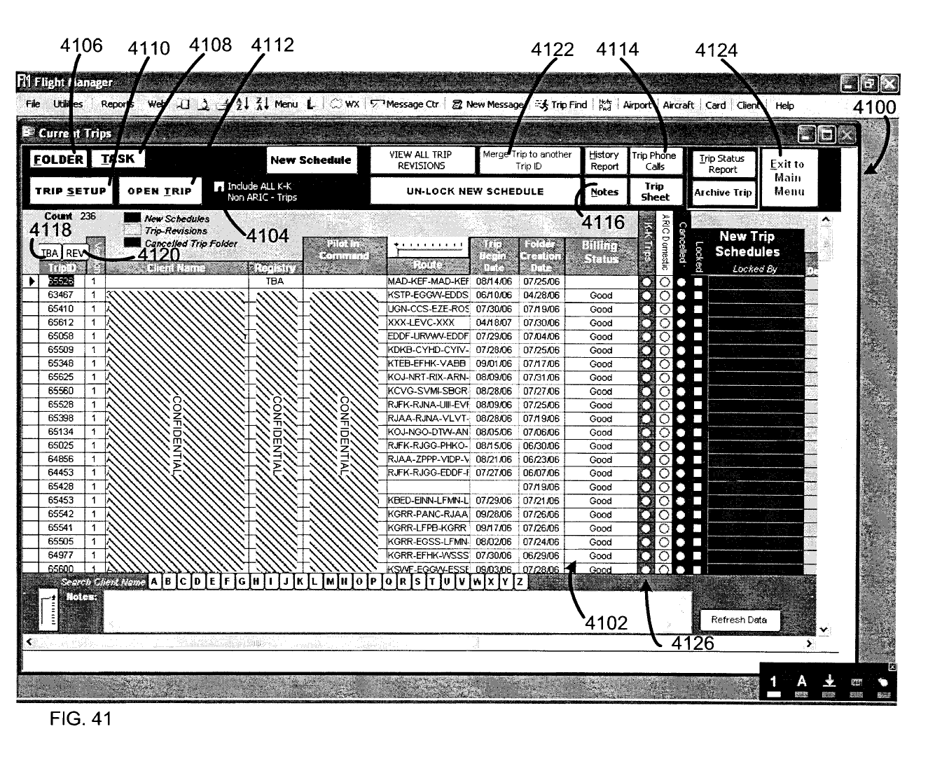

FIG. 42 shows a graphic user interface of an exemplary system complete trip folder list window.

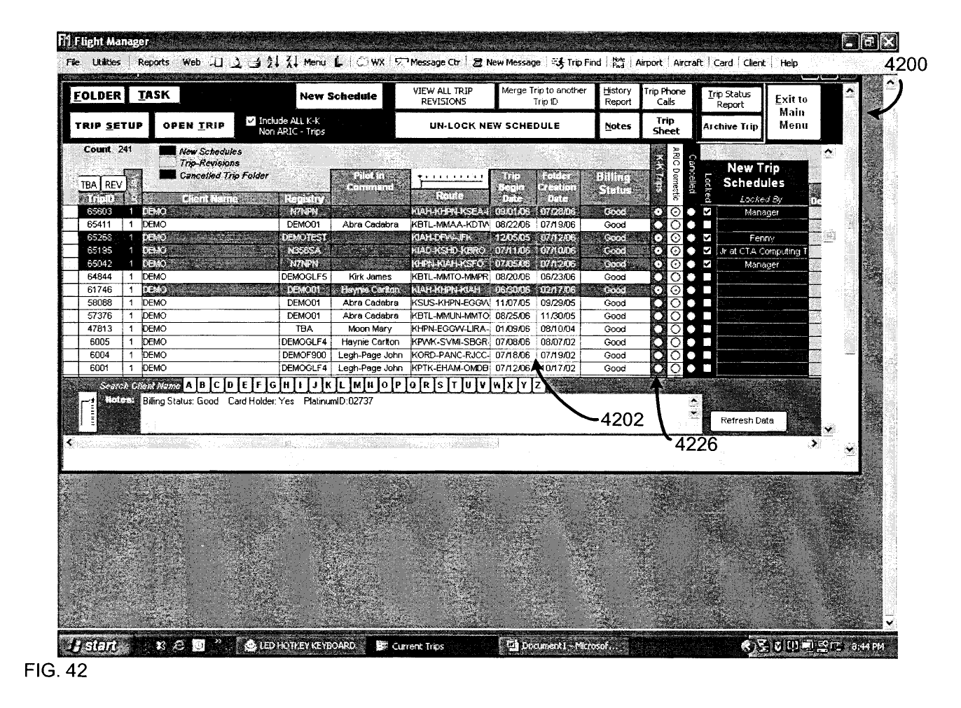

FIG. 43 shows a graphic user interface of an exemplary system trip task list window.

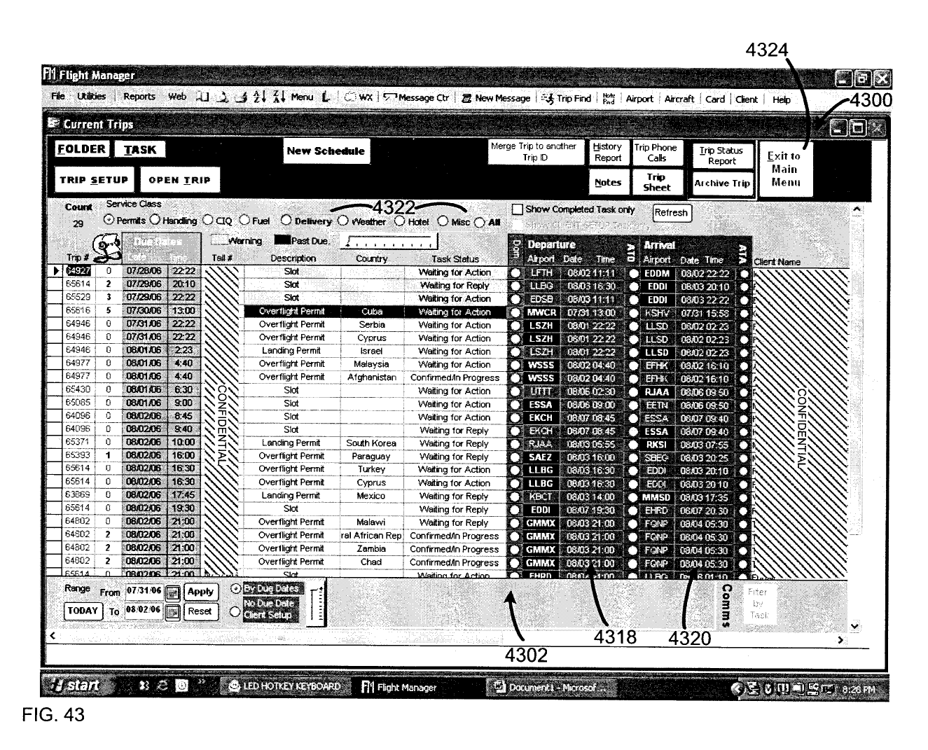

FIG. 44 shows a graphic user interface of an exemplary system new trip setup window.

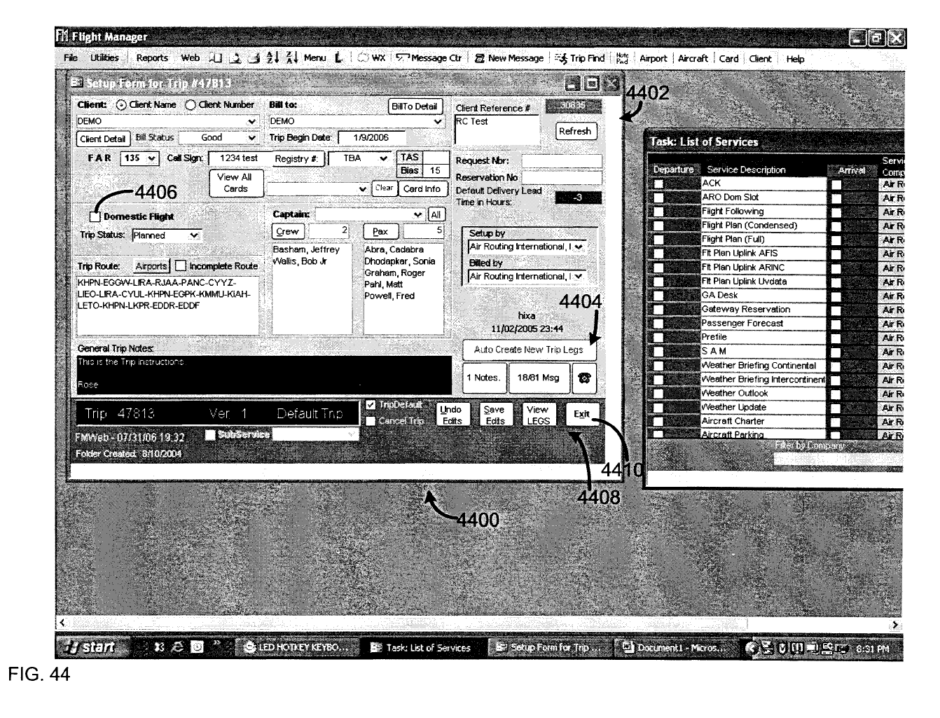

FIG. 45 shows a graphic user interface of an exemplary system list of services window.

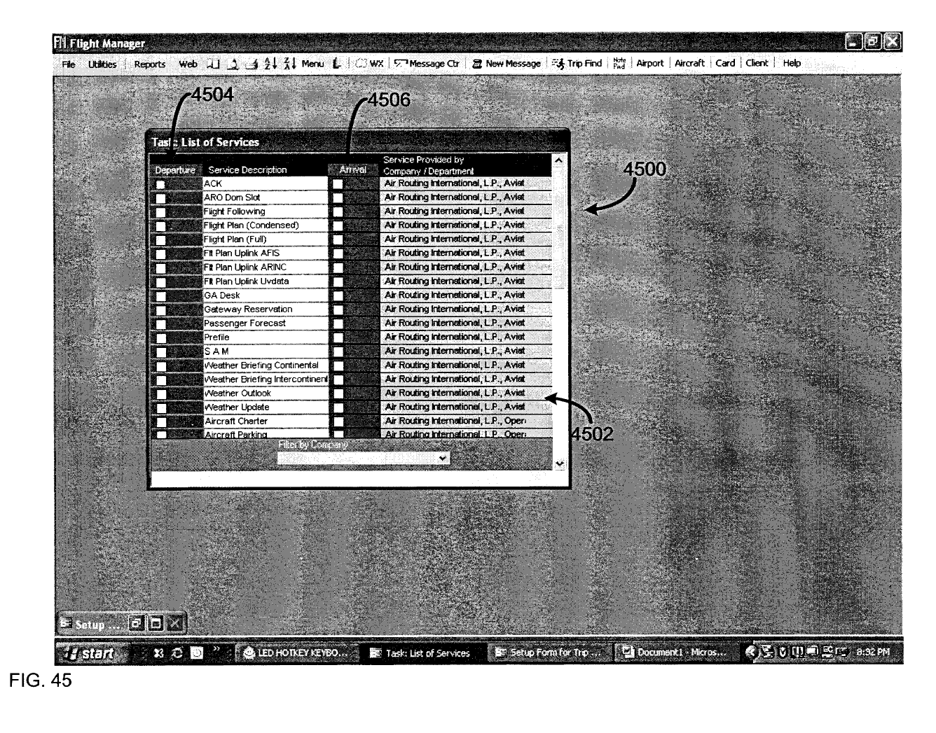

FIG. 46 shows a graphic user interface of an exemplary system trip leg list window.

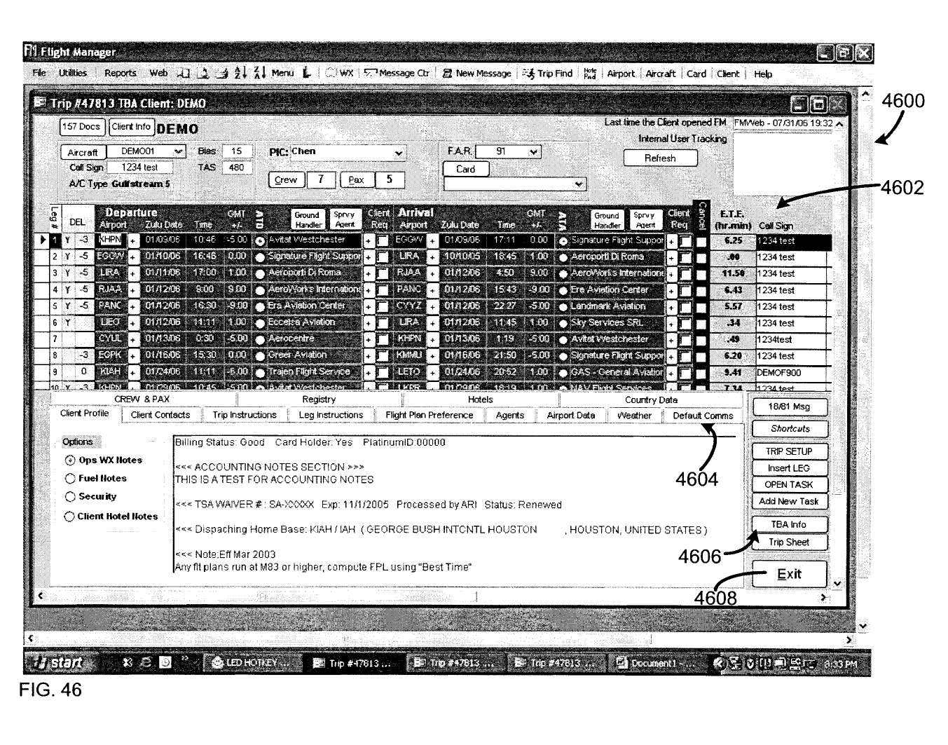

FIG. 47 shows a graphic user interface of exemplary left-side portions of an exemplary system departure task window and arrival task window.

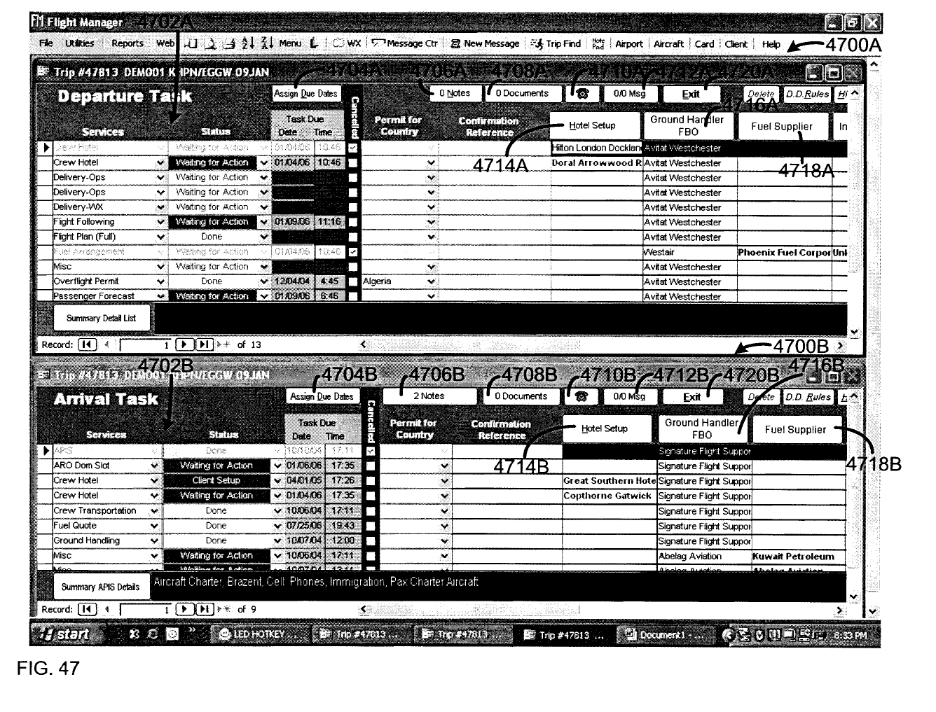

FIG. 48 shows a graphic user interface of an exemplary system ground handler details window.

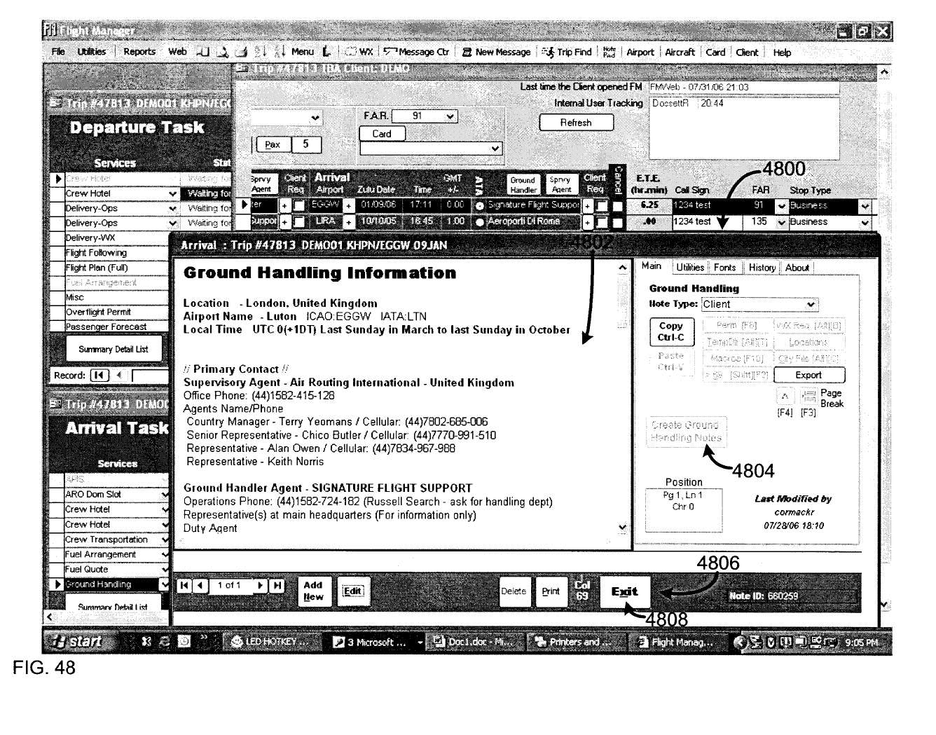

FIG. 49 shows a graphic user interface of an exemplary system documents window.

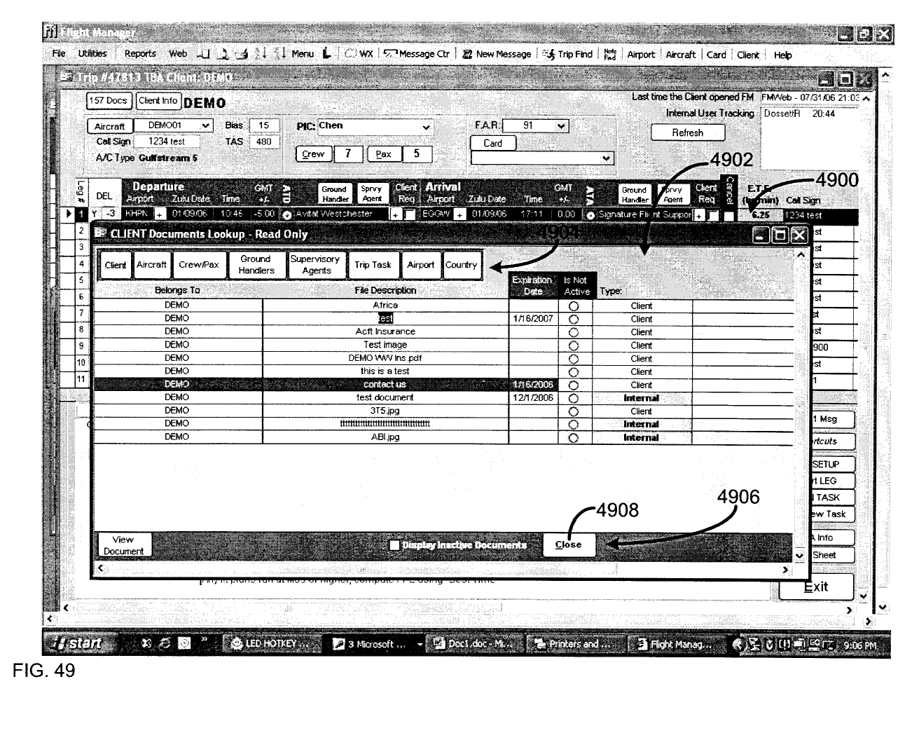

FIG. 50A shows a graphic user interface of an exemplary system communications classic view window.

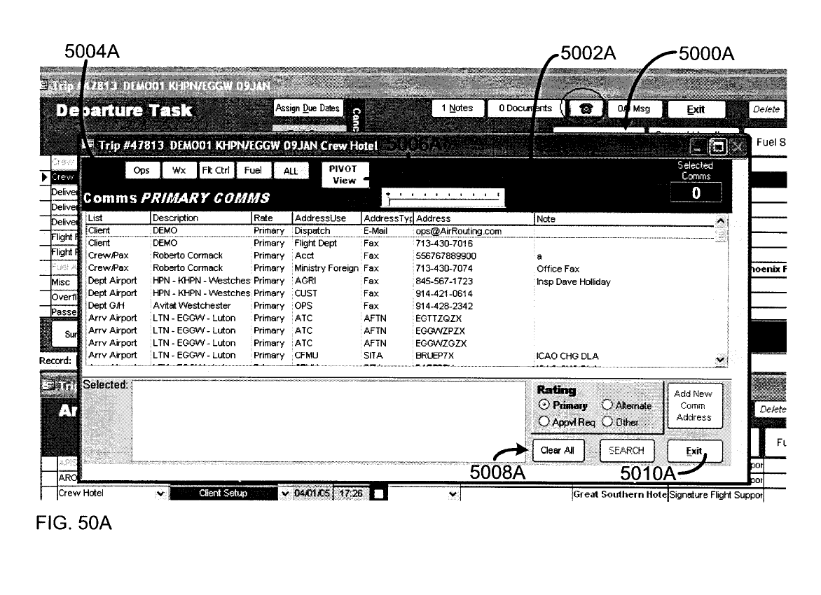

FIG. 50B shows a graphic user interface of an exemplary system communications pivot view window.

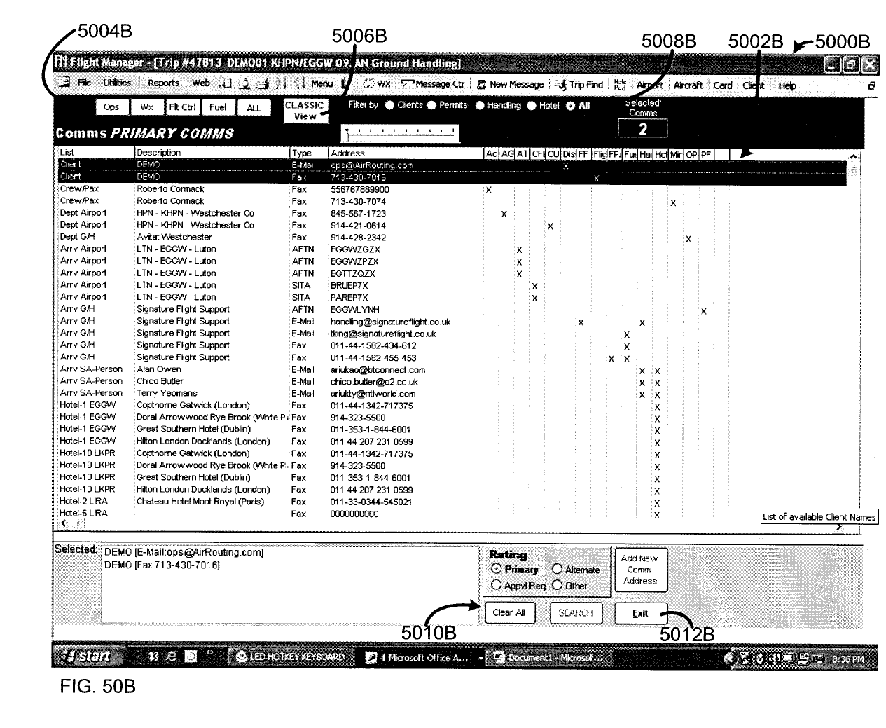

FIG. 51 shows a graphic user interface of an exemplary system trip message window.

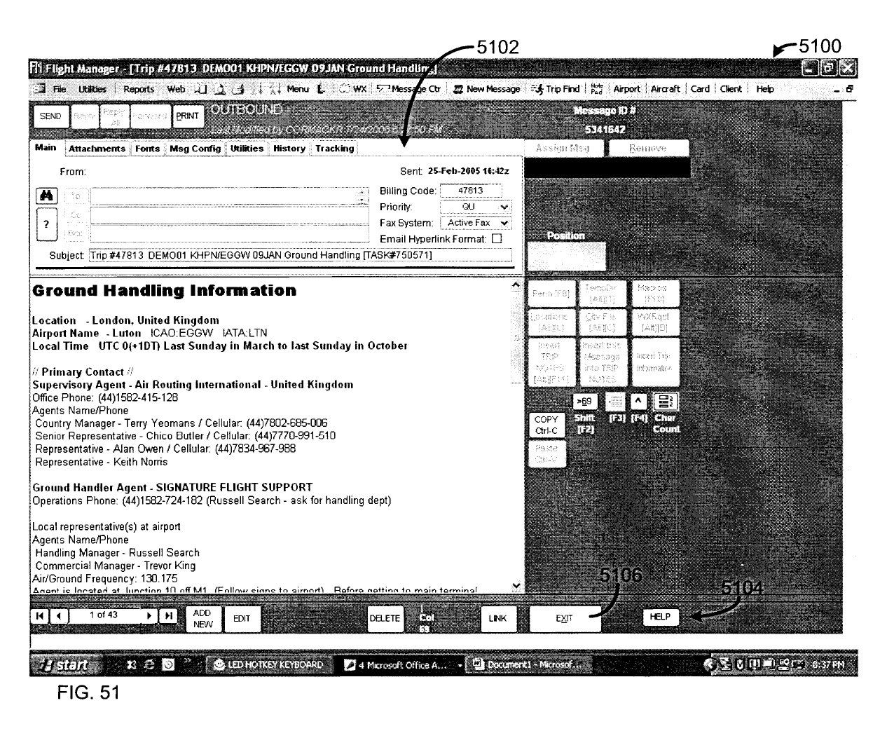

FIG. 52 shows a graphic user interface of an exemplary system hotel details window.

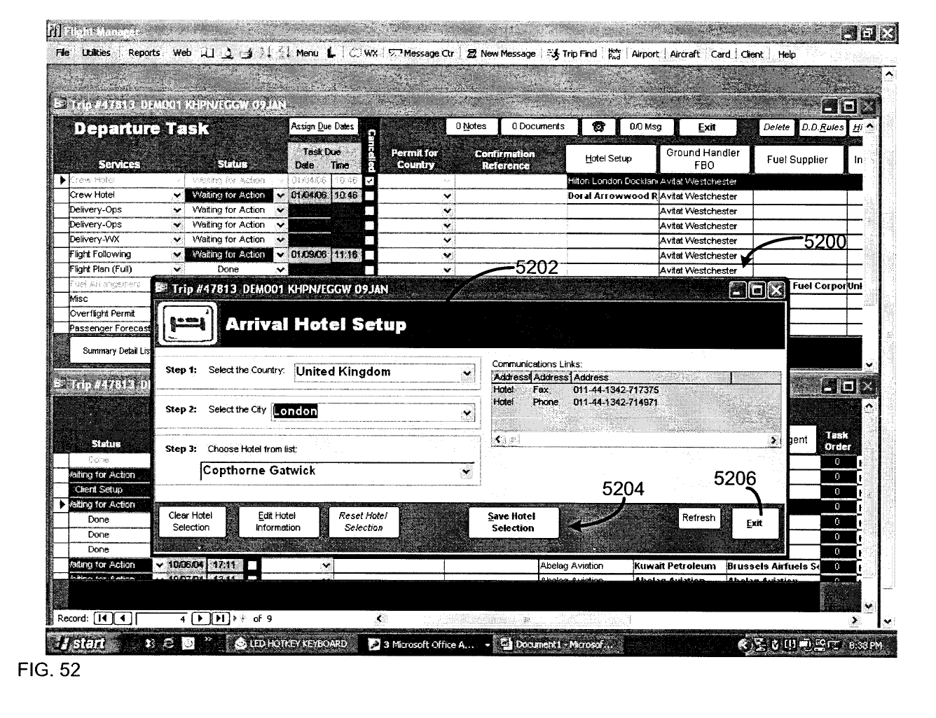

FIG. 53 shows a graphic user interface of an exemplary system merge window.

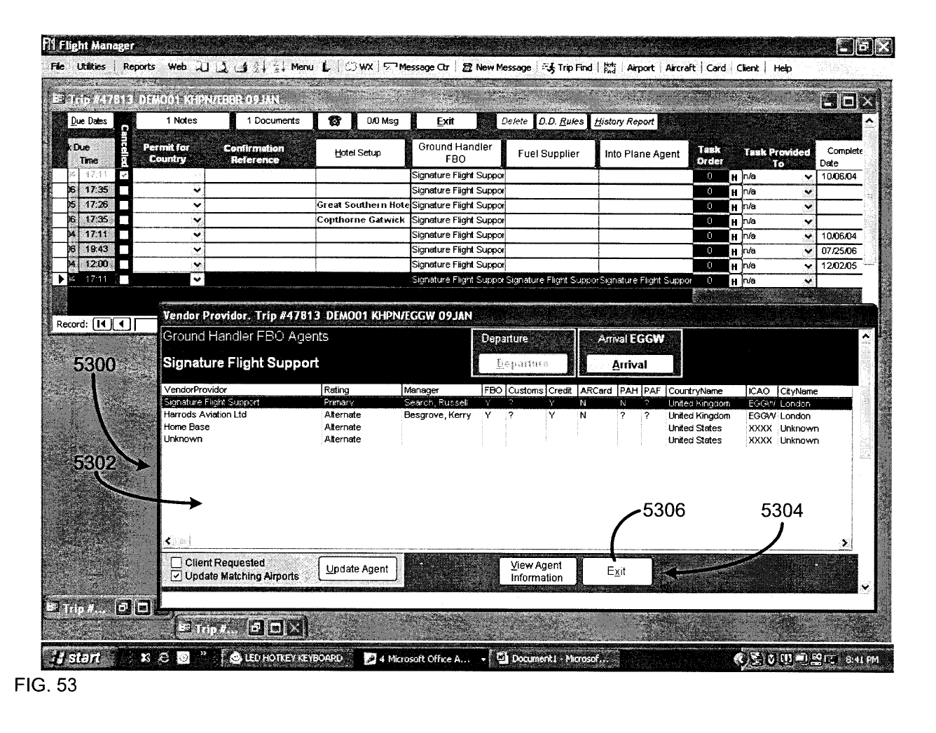

FIG. 54 shows a graphic user interface of an exemplary system ground handler agent details window.

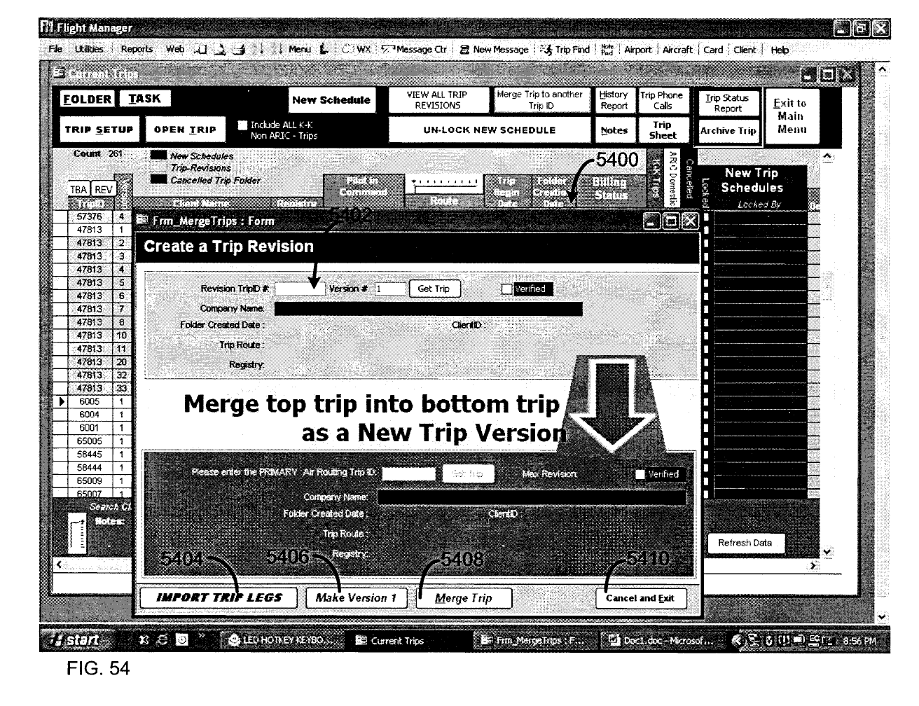

FIG. 55 shows a graphic user interface of an exemplary system trip exceptions window.

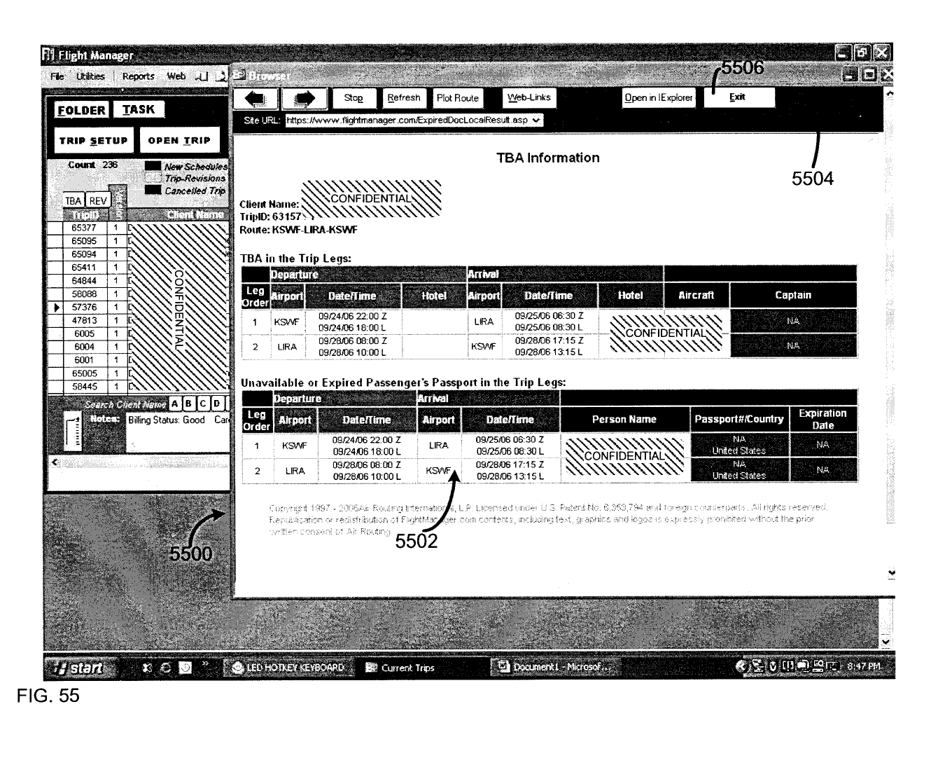

FIG. 56 shows a graphic user interface of an exemplary system revision comparison window.

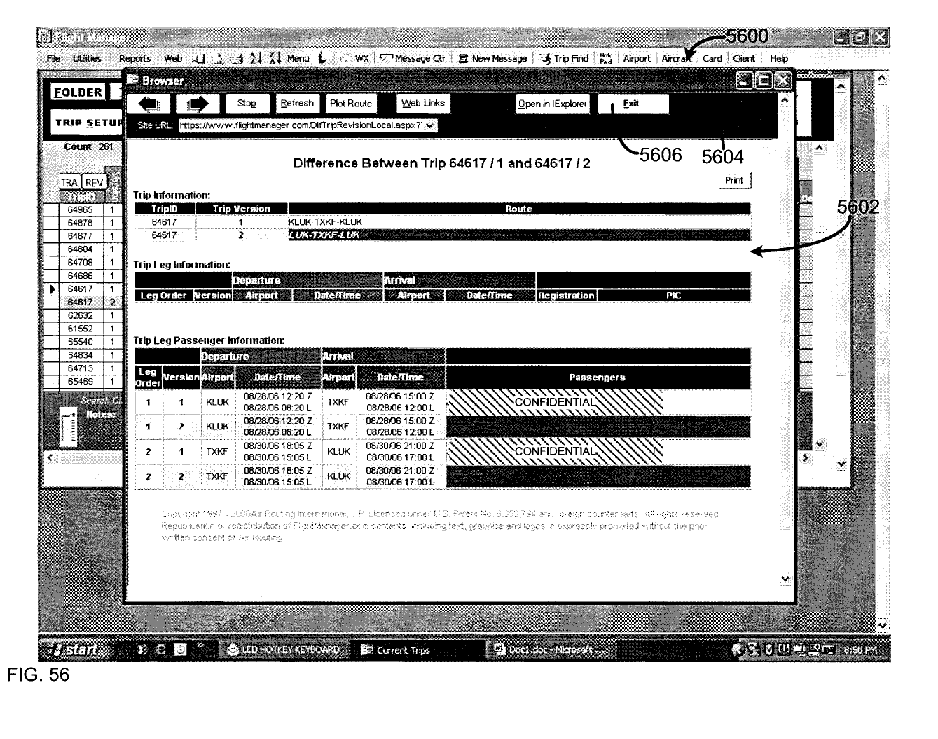

FIG. 57 shows a graphic user interface of an exemplary system trip upload confirmation window.

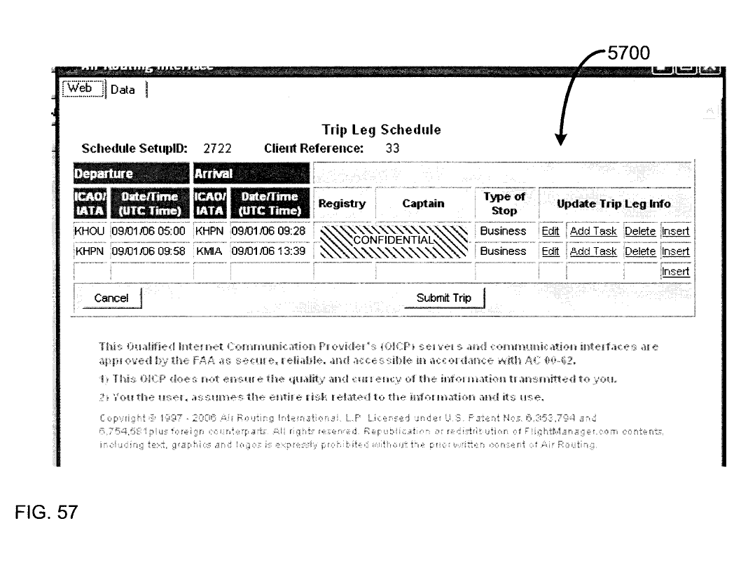

FIG. 58 shows a graphic user interface of an exemplary system messaging window.

FIG. 59 shows a graphic user interface of an exemplary system flight lookup window.

FIG. 60 shows a graphic user interface of an exemplary system reports menu window.

FIG. 61 shows a graphic user interface of an exemplary system fuel window and fuel sign-in window.

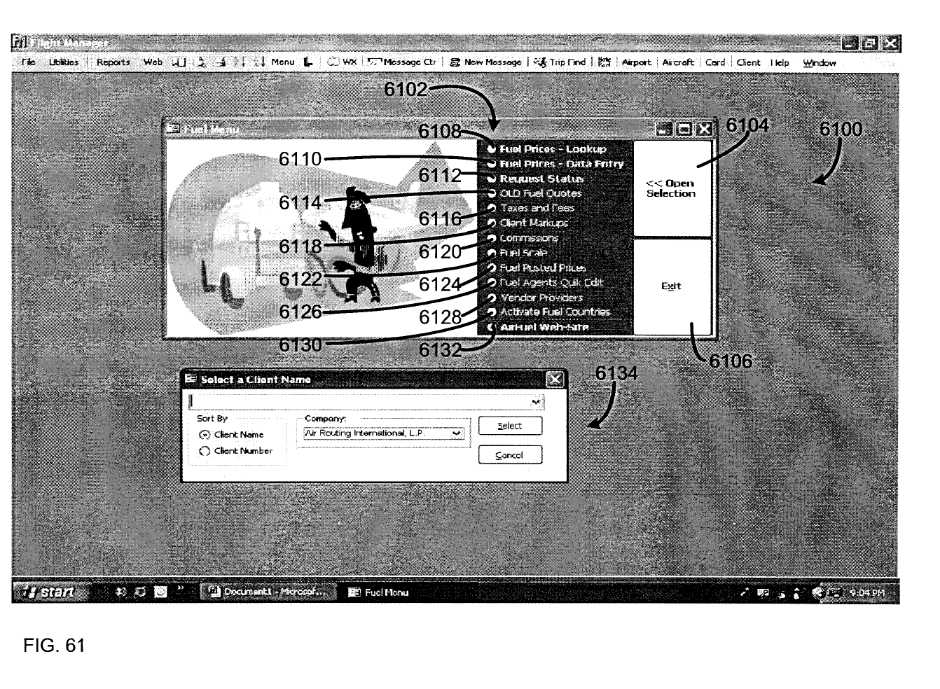

FIG. 62 shows a graphic user interface of an exemplary system fuel price lookup window.

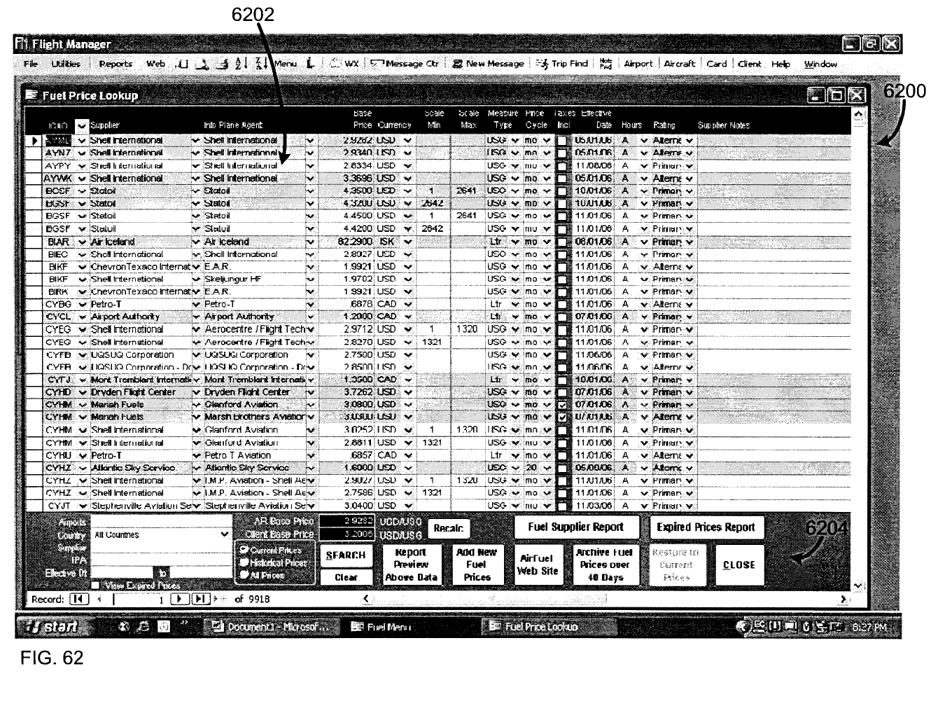

FIG. 63 shows a graphic user interface of an exemplary system fuel price entry window.

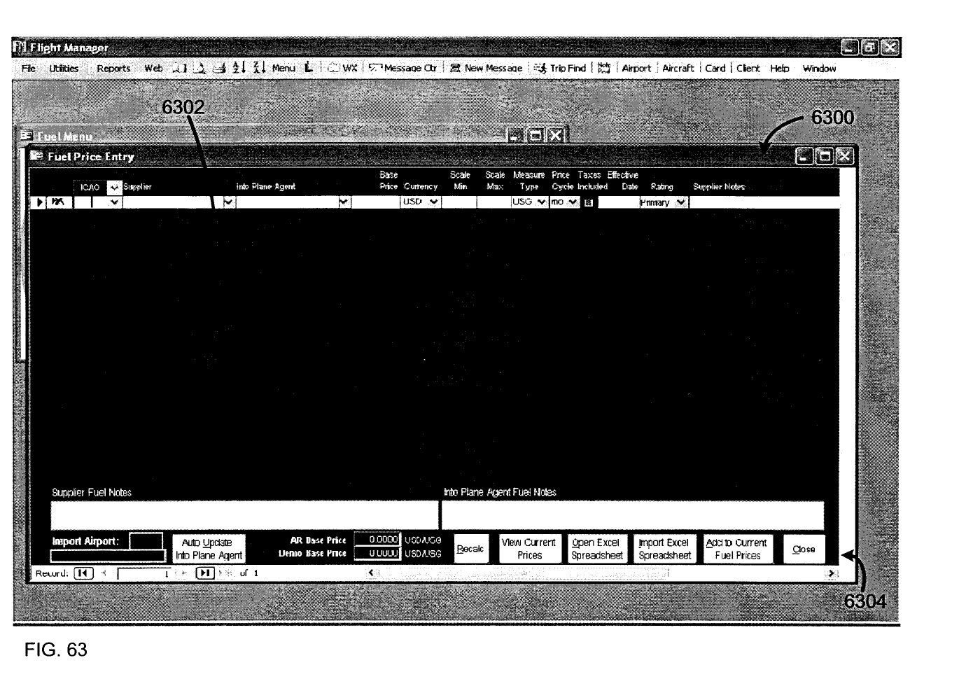

FIG. 64 shows a graphic user interface of an exemplary system fuel request status window.

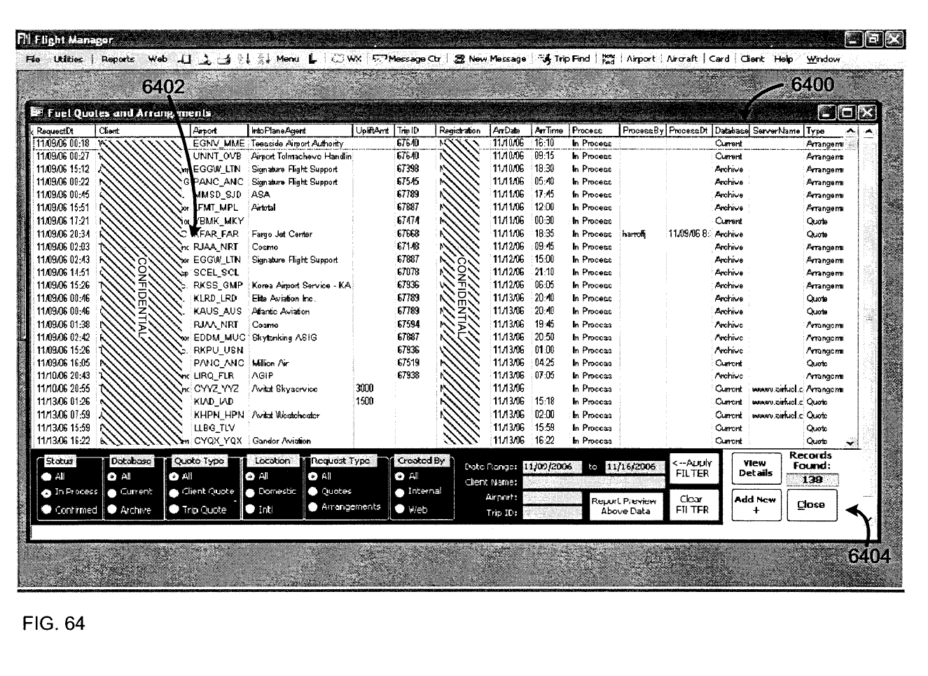

FIG. 65 shows a graphic user interface of an exemplary system fuel request detail window.

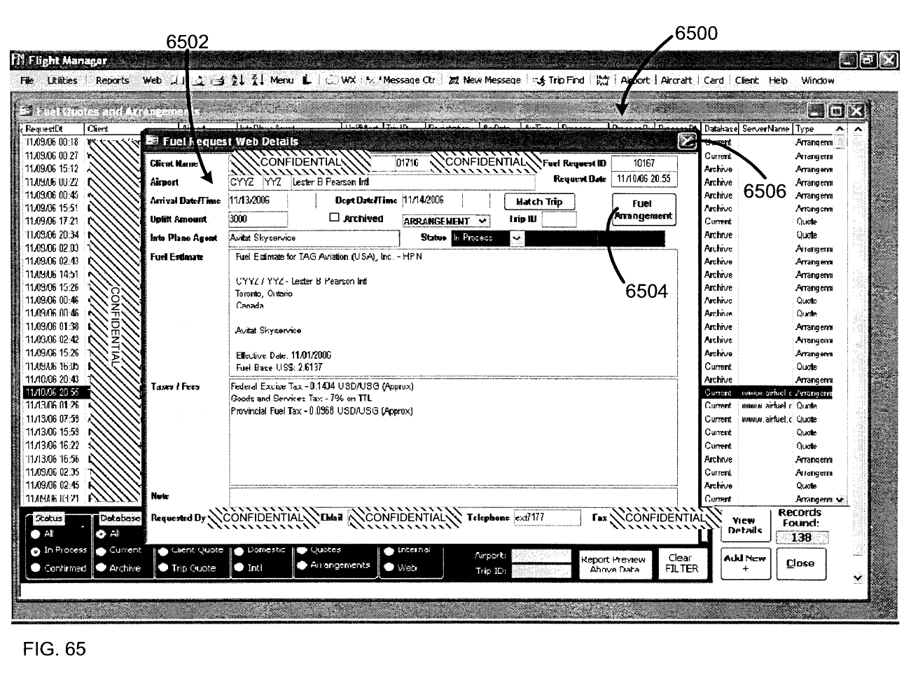

FIG. 66A shows a graphic user interface of an exemplary system fuel quote detail window.

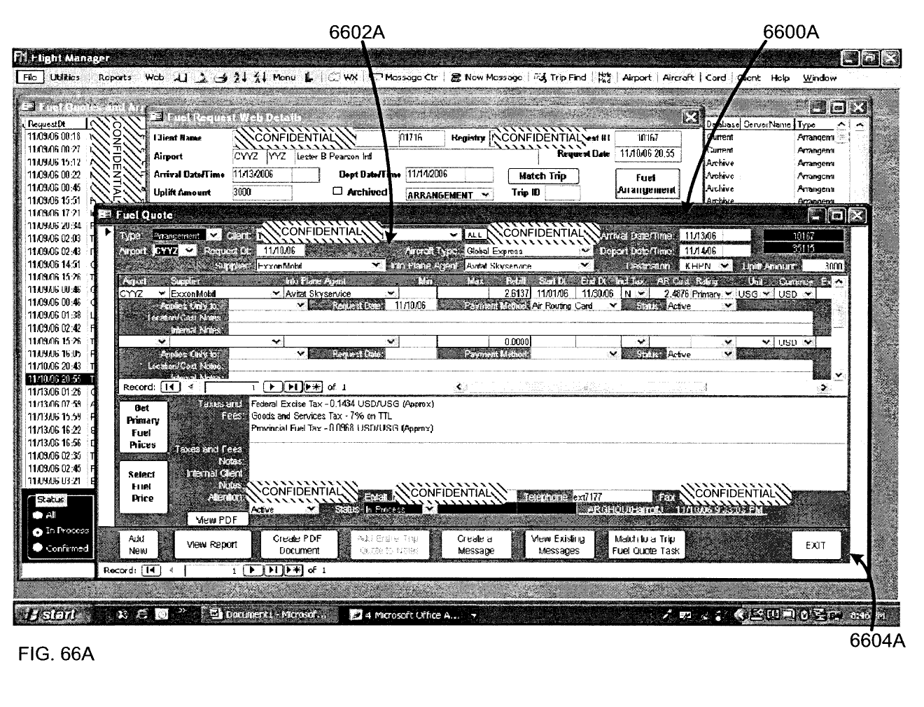

FIG. 66B shows a graphic user interface of an alternate exemplary system fuel quote detail window.

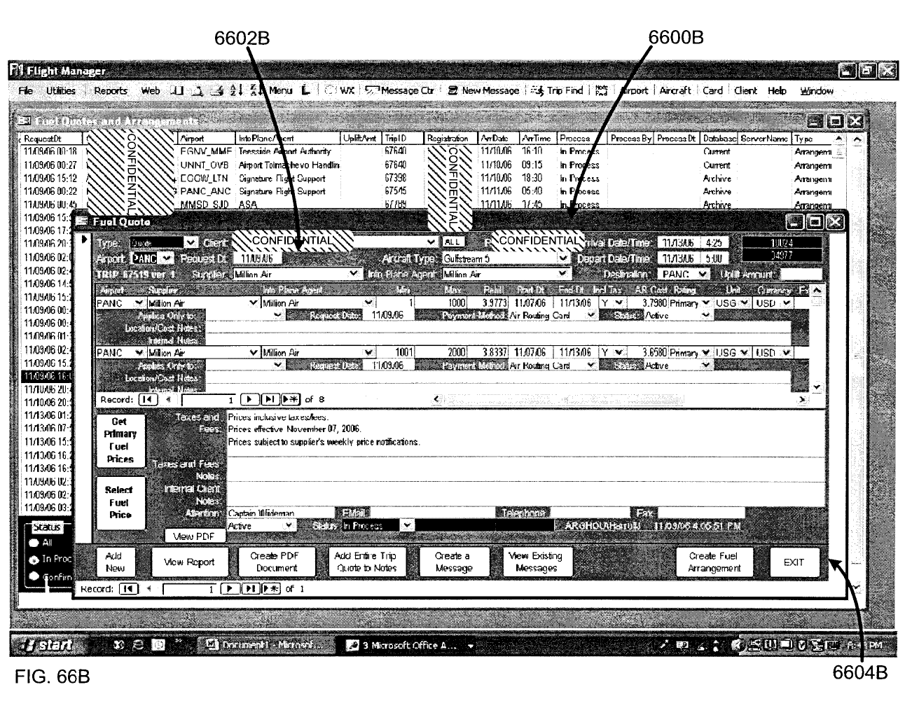

FIG. 67 shows a graphic user interface of an exemplary system fuel taxes and fees window.

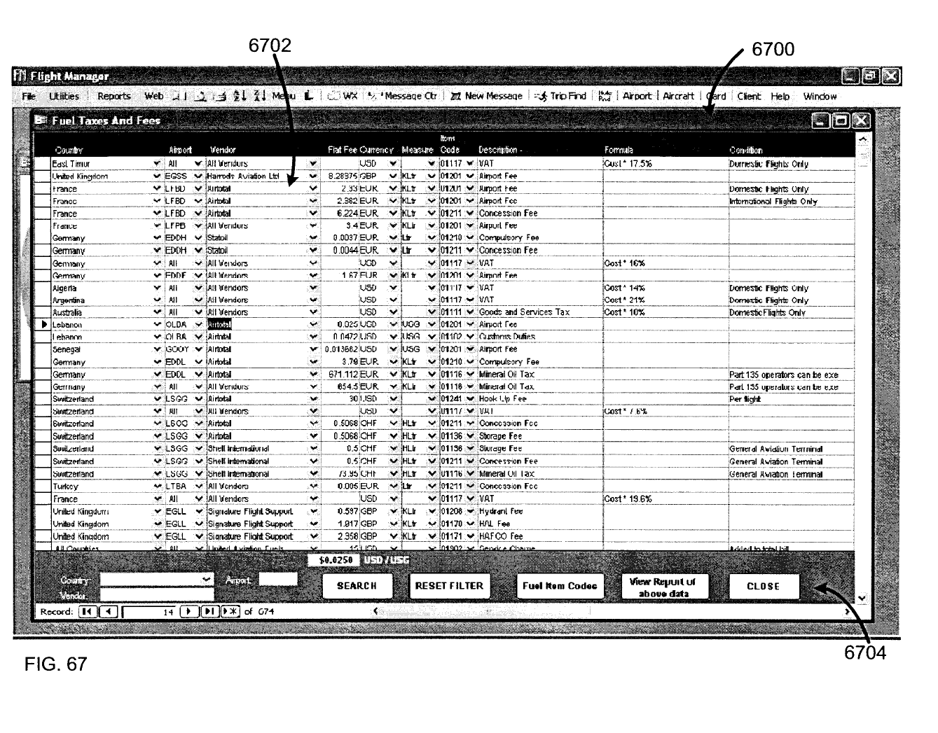

FIG. 68 shows a graphic user interface of a left-side portion of an exemplary system fuel client markup window.

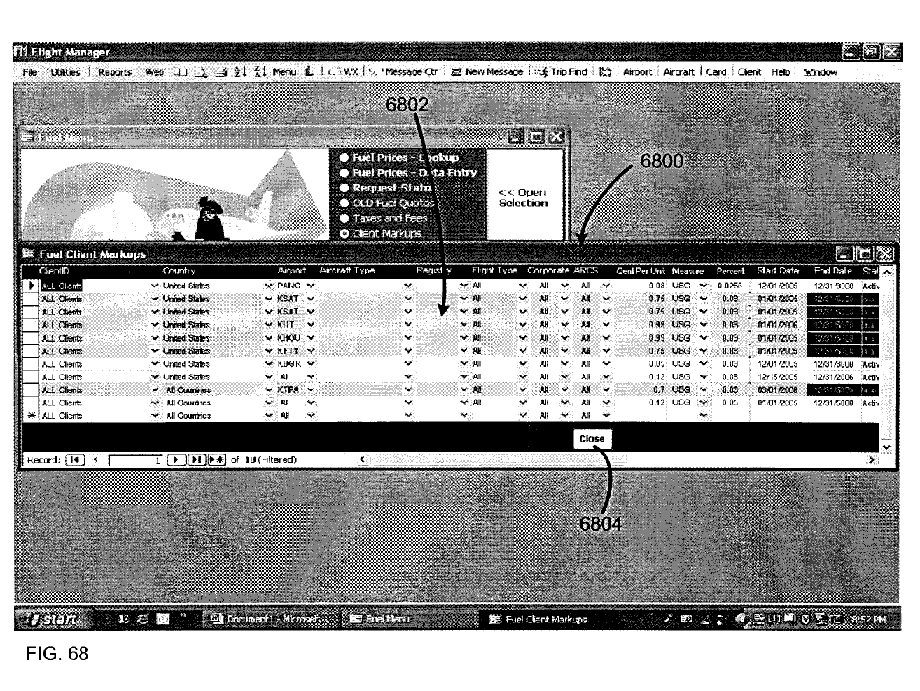

FIG. 69 shows a graphic user interface of an exemplary system fuel vendor quick edit window.

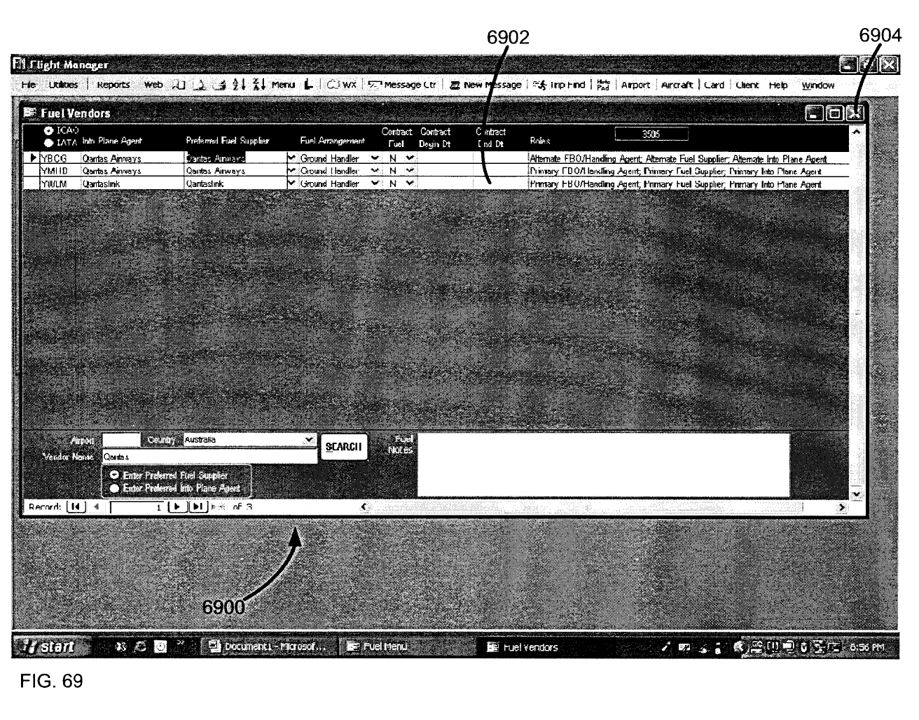

FIG. 70 shows a graphic user interface of an exemplary system country fuel activation window.

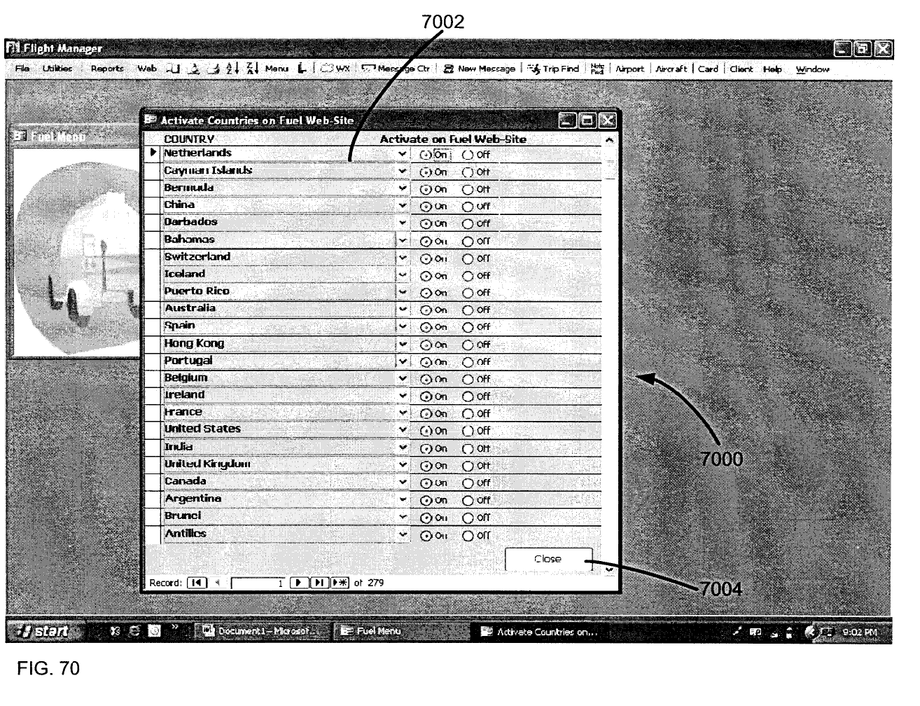

FIG. 71 shows a graphic user interface of an exemplary system client view emulation entry window.

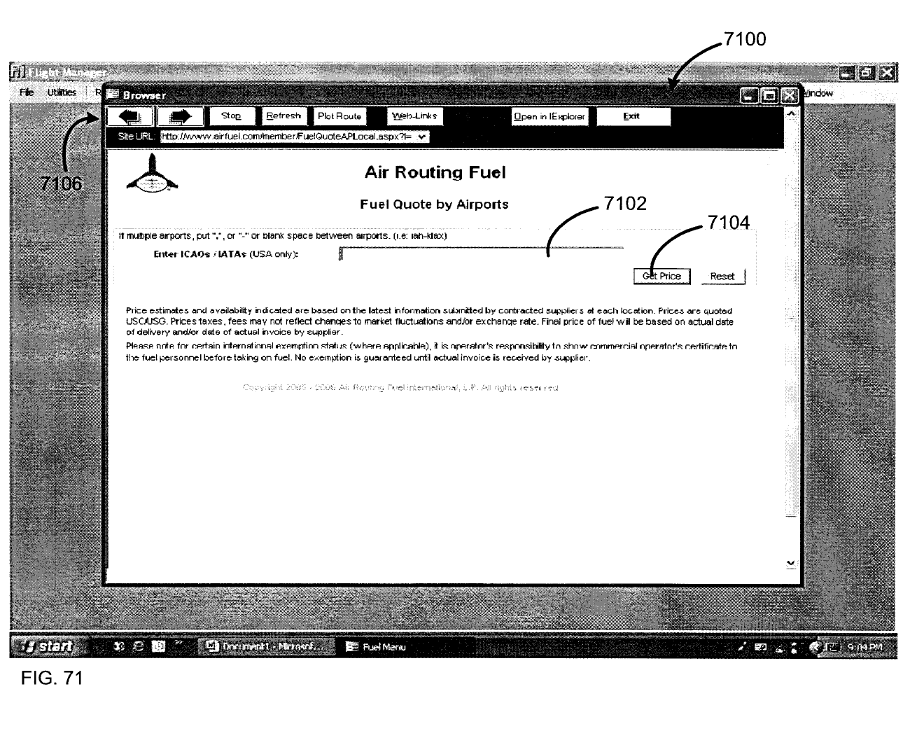

FIG. 72 shows a graphic user interface of an exemplary system client view emulation information window.

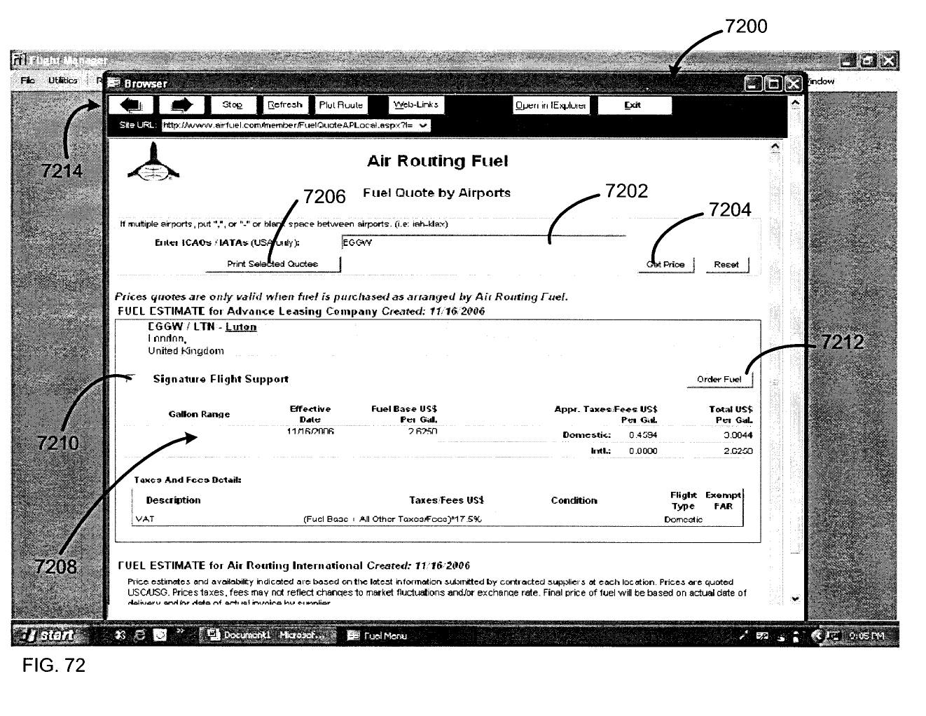

FIG. 73 shows a graphic user interface of an exemplary system client web-view entry window.

FIG. 74 shows a graphic user interface of an exemplary system client web-view information window.

### DESCRIPTION OF THE ILLUSTRATED EMBODIMENT

The exemplary Air Travel System includes a system and method that maintains and presents actual options and recommendations for a multiplicity of arrangements, services, and fees, in real-time, adaptable to a wide variety of communication systems, in order to match the client's needs, including communication, budgetary, services and preference needs. Either or both mobile and static communication devices can access the System, which through a computing device can provide a series of user-friendly, well-organized program screen displays. This disclosure, among other things, addresses efficiency needs by adding to the prior systems an integrated, dynamic planning and management function that enables integrated planning, coordinating, and managing arrangements to a degree not previously available. Additionally, this disclosure addresses the adaptability to a client's particular and changing needs, supporting a spectrum of services that may range from turn-key to simply ministerial. The System permits the client to determine the level of choices and control desired for each, all or any comprehensive trip plan. Beyond that, the System supports a fluidity of change in those choices and controls as situations and requirements develop and adjust.

This disclosure refers to “engines,” which are generally understood in the context of a system to mean an agent, instrument, or combination of either, or both, that may be associated to serve a purpose or accomplish a task. Agents and instruments may include individuals with particular skills or capabilities, computers, components of computers, programmable logic devices, microprocessors, software, software routines, communication equipment, networks, network services, and other elements and their equivalents that exist, are being developed and may be developed, which contribute to the purpose or task to be accomplished.

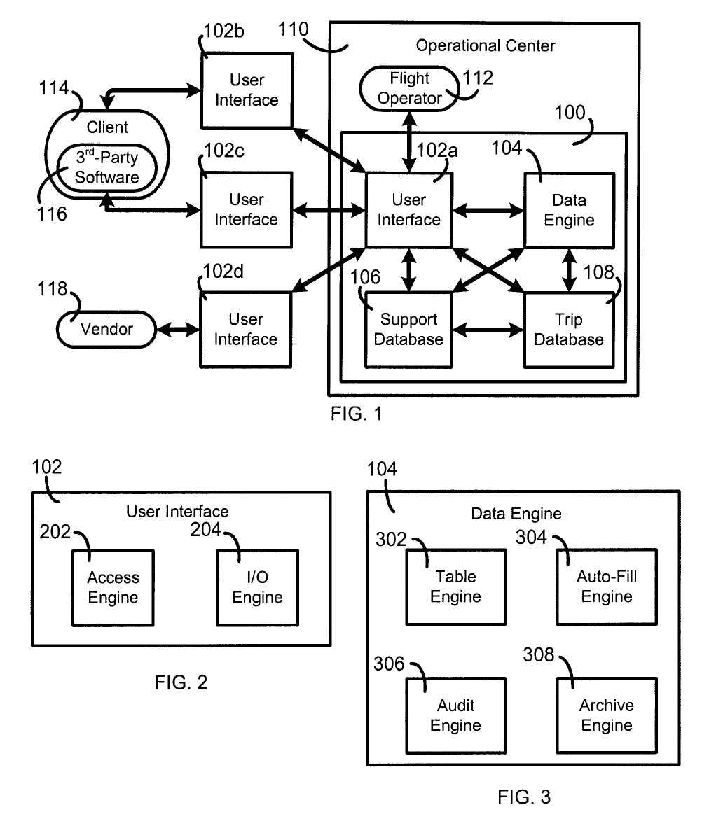

Referring now to FIG. 1, an overview of a flight management system 100 (“FMS”) is shown. The FMS 100 is implemented through networked computers. The FMS 100 includes a user interface 102a operably coupled to a software data engine 104. The data engine 104 processes various data stored in a support database 106 and a trip database 108.

The FMS 100 is installed at an operational center 110. A flight manager operator 112 (“FM operator”), having knowledge in a wide variety of flight operations and air travel procedure and scenarios, can interface with the FMS 100 through the user interface 102a within the operational center 110. A FM operator 112 can review, enter, and alter data within the support database 106 and the trip database 108. A client 114 can operably couple with FMS 100 through a user interface 102b, external to operational center 110. The client 114 may choose to employ third-party trip management software 116. The FMS 100 supports a variety of third-party software systems 116. The third-party software 116 can operably couple to the FMS 100 through user interface 102c. The client 114, either directly and/or through the third-party software 116, can review, enter, and alter data, related solely to the client 114, within the support database 106 and the trip database 108.

A vendor 118, who is capable of providing flight services, can operably couple with the FMS 100 through the user interface 102d. The vendor 118 can review, enter, and alter data, related solely to the vendor 118, within the support database 106 and the trip database 108.

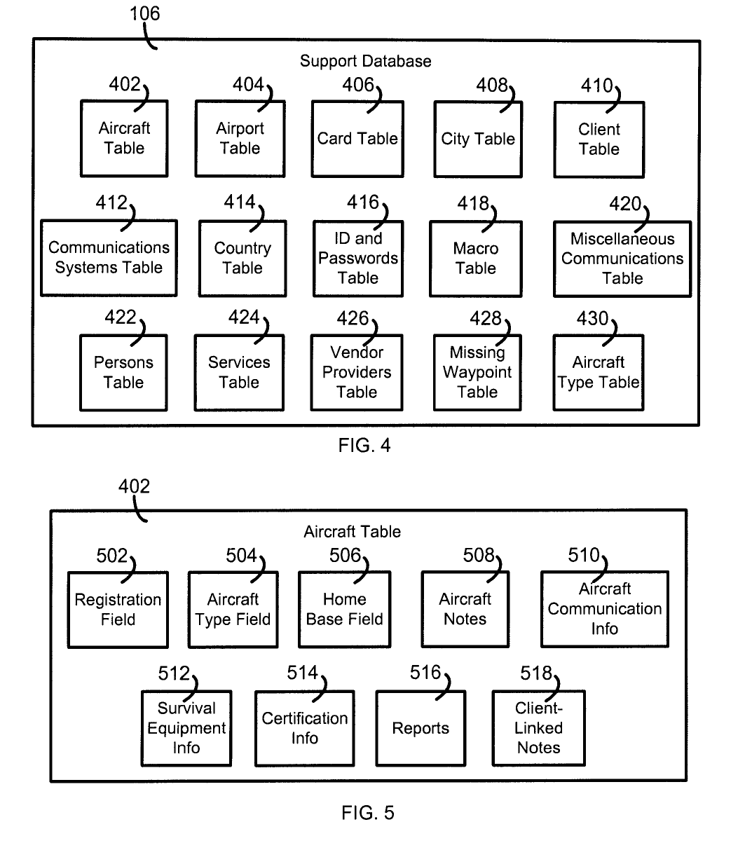

Referring to FIG. 2, user interface 102 includes an access engine 202, and an Input/Output (“I/O”) engine 204. The access engine 202 facilitates operational coupling between users and the FMS 100. A user accesses the user interface 102a through a log-in routine, and the access engine 202 establishes the particular user's identity and operational authority to review, enter, and alter data within the support database 106 and the trip database 108.

The I/O engine 204 supports input and output between the user and the FMS 100. The I/O engine 204 may be configured to support virtually any form of communication a user may choose to employ. In an exemplary embodiment, the I/O engine 204 may employ graphic elements that when activated execute certain functions. In this disclosure, the function of any particular graphic element may be described as being performed by the graphic element, and it is understood that it is the activation of the particular graphic element that initiates the function.

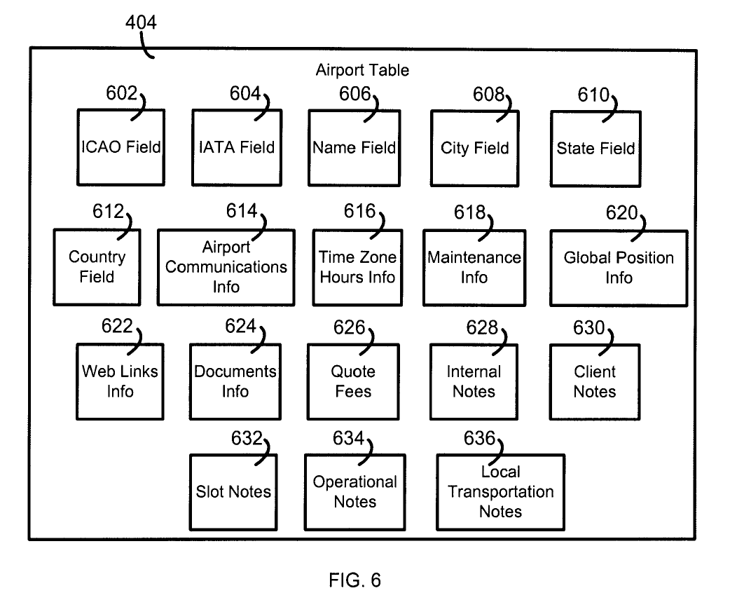

Referring to FIG. 3, the data engine 104 includes a table engine 302, an auto-fill engine 304, an audit engine 306, and an archive engine 308. Table engine 302 operates to access, retrieve, organize, and alter data stored in table structures within a database. Auto-fill engine 304 operates to select essential elements of a trip not specified by a client 114 in order to provide the client 114 with complete air travel preparation, as well as simplify entry of a new trip. The auto-fill engine 304 makes selections based on ratings of the various service providers for the particular element, as well as preferences noted by a user of the FMS 100.

The audit engine 306 generally operates to verify that data for a trip contains all the information necessary and prudent for a client 114 to successfully execute the planned trip. The audit engine 306 also checks for various anomalies in the data that may indicate an assortment of potential inconsistencies, discrepancies, and redundancies. The archive engine 308 operates to document all operations that may impact the data. The archive engine 308 records information concerning any review or alteration of the data. The information gathered by the archive engine 308 can be adapted to transfer information into any form, and retained indefinitely.

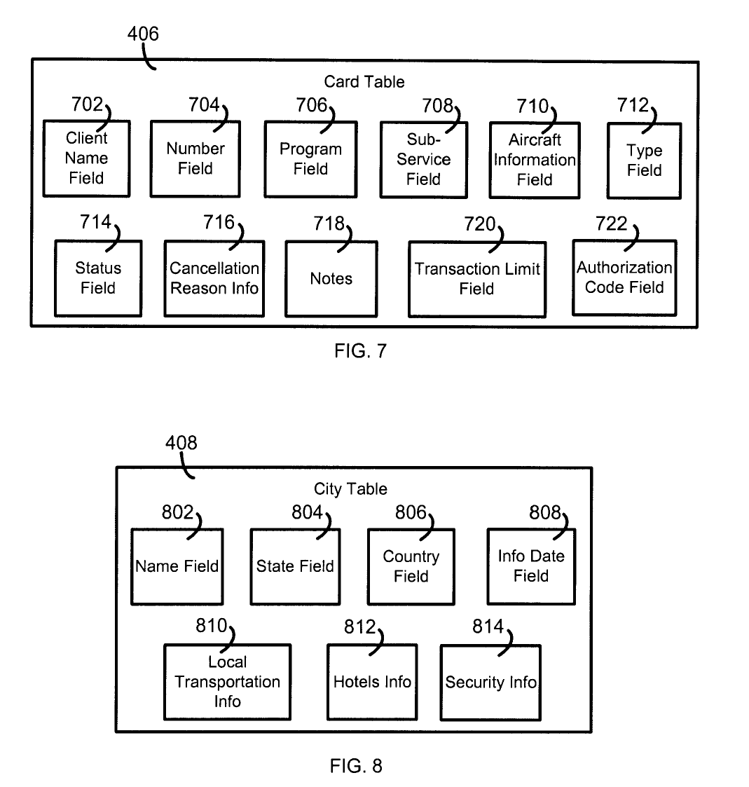

Referring to FIG. 4, the support database 106 includes fields of tables for compiling and organizing information. Information uniquely pertaining to the topic of a particular table is stored within the particular table structure, as part of the support database 106. Whereas, other information related to the information of the particular table may be uniquely pertinent to another table and merely temporarily populate the fields of the table through a data link. The support database 106 includes tables such as aircraft table 402, airport table 404, card table 406, city table 408, client table 410, communications systems table 412, country table 414, identification and passwords table 416, macro table 418, miscellaneous communications table 420, persons table 422, services table 424, vendor providers table 426, missing waypoint table 428, and aircraft type table 430. All data within the support database 106 is normalized in order to attempt to eliminate redundancy of information in multiple locations within the support database 106. Moreover, data held in various tables may be linked as needed, in order to have necessary or helpful data easily accessible, while avoiding duplication.

The aircraft table 402 contains information on particular aircrafts. The airport table 404 contains information on each particular airport. Information held in the aircraft table 402 is linked to data within the city table 408 and the country table 414. Card table 406 contains information on charge cards issued to a particular client 114, for use with a particular aircraft. City table 408 contains information on a particular city that may be of interest to an air traveler. Client table 410 contains information on all clients 114 and is linked to communications systems table 412, the identification and passwords table 416, and the persons table 422. The communications systems table 412 contains information on the means of communications, and their respective configuration, employed by all users of the FMS 100. The country table 414 contains information on particular countries. The identification and passwords table 416 contains identification and password information for all users of the FMS 100. Such information includes data sufficient to identify the particular user and verify the user's authority to operate within the parameters assigned to that user.

The macro table 418 may contain macros created to facilitate flight operations in accordance with various jurisdictions. The information held in the macro table 418 is linked, if known, to particular data within the aircraft table 402, the airport table 404, the city table 408, the client table 410, the country table 414, and the vendor providers table 426. The miscellaneous communications table 420 contains communication information that is useful and requires safekeeping, but that does not readily fit into one of the other tables. The persons table 422 contains information on all people associated with the use and operation of the FMS 100. The information held in the persons table 422 is linked, as applicable, to the client table 410, the country table 414, the identification and passwords table 416, and the vendor providers table 426. The services table 424 contains information necessary to define a service that may be required for a client 114 and provided by a vendor 118. The vendor providers table 426 contains information on all vendors 118 offering services through the FMS 100. The vendor providers table 426 is linked to the airport table 404, the city table 408, the country table 414, the persons table 422, and the services table 424. The missing waypoint table 428 contains information correcting waypoints that have been identified as missing, incorrect, or duplicated in a different part of the world. The aircraft type table 430 contains general information relating to particular manufacturers or models of aircraft and is further linked to the aircraft table 402.

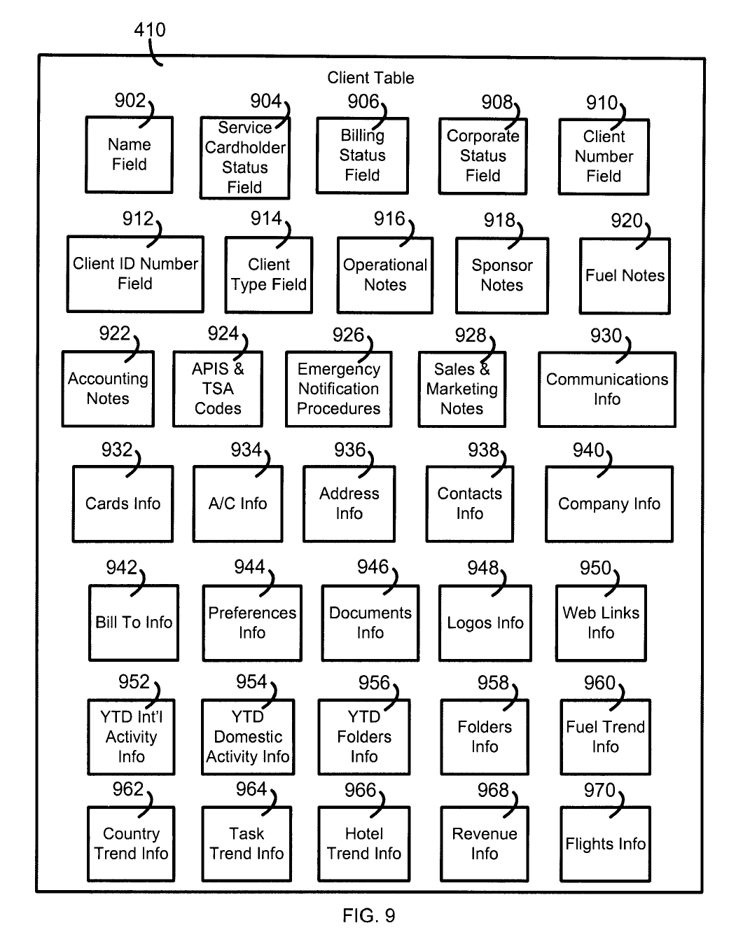

Referring to FIG. 5, the aircraft table 402 includes fields for compiling and organizing information regarding each particular aircraft managed in the FMS 100. The aircraft table includes a registration field 502, an aircraft type field 504, a home base field 506, an aircraft notes field 508, aircraft communications information 510, survival equipment information 512, certification information 514, reports 516, and client-linked notes 518. The registration field 502 houses information on the registration number for each particular aircraft. The aircraft type field 504 houses linked information from the aircraft type table 430 for each particular aircraft. The home base field 506 houses linked information from the airport table 404 on the home base airport for each particular aircraft. The aircraft notes field 508 houses miscellaneous information regarding each particular aircraft. The aircraft communication information field 510 houses information on systems one can use in order to communicate with each particular aircraft. The survival equipment information 512 houses information on survival equipment contained in each particular aircraft. The certification information 514 houses information on certifications for each particular aircraft. The reports field 516 houses information on any reports that may be available regarding each particular aircraft. The client-linked notes field 518 houses information specific to a client regarding each particular aircraft.

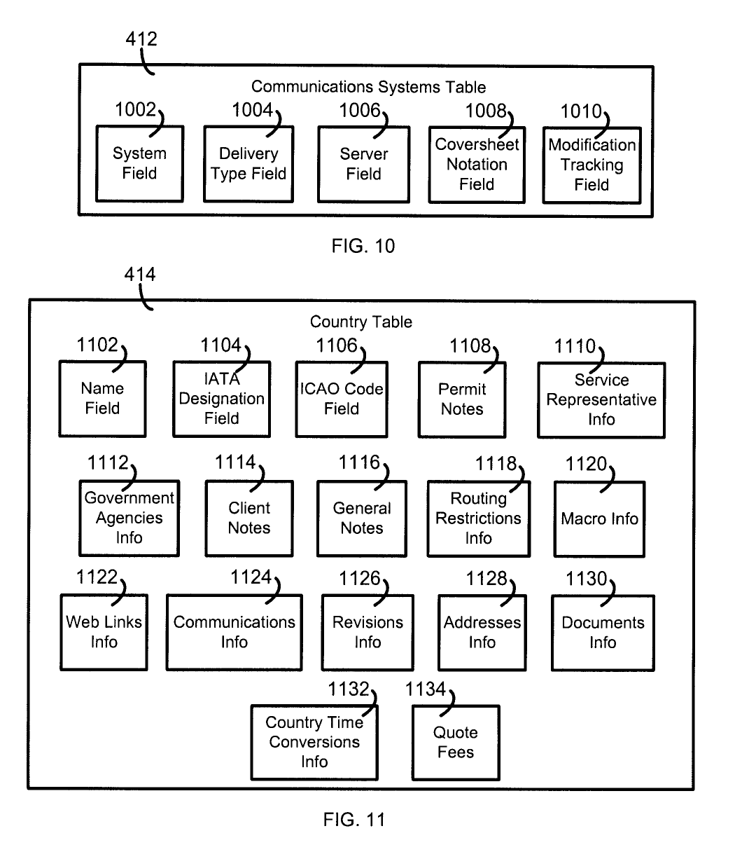

Referring now to FIG. 6, airport table 404 includes fields for compiling and organizing information regarding each particular airport managed in the FMS 100. The ICAO field 602 houses information on codes for the International Civil Aviation Organization for each particular airport. The IATA field 604 houses information on codes for the International Air Transport Association for each particular airport. The name field 606 houses information on the name of each particular airport. The city field 608 houses linked information from the city table 408 on the city for which each particular airport is located. The state field 610 houses linked information from the city table 408 on the state for which each particular airport is located. The country field 612 houses linked information from the country table 414 on the country for which each particular airport is located. The airport communications information field 614 houses information on how to communicate with each particular airport. The time zone hours information field 616 houses information on relative time at each particular airport with regard to standard times around the world. The maintenance information field 618 houses information pertaining to any maintenance matters for each particular airport. The global position information field 620 houses information on the location of each particular airport, including latitude, longitude and elevation. The web links information field 622 houses information on World Wide Web links and Internet sites for each particular airport. The documents information field 624 houses information on any documents required, held or distributed by each particular airport. The quote fees field 626 houses information on fees charge for obtaining usage quotes for each particular airport. The internal notes field 628 houses information on any items that the operator of the FMS 100 may find important or helpful, for each particular airport. The client notes field 630 houses information on anything the flight management client may find important or helpful for each particular airport. The slot notes field 632 houses information on slot scheduling for each particular airport. The operational notes field 634 houses information on the operation of each particular airport. The local transportation notes field 636 houses information on local transportation for each particular airport.

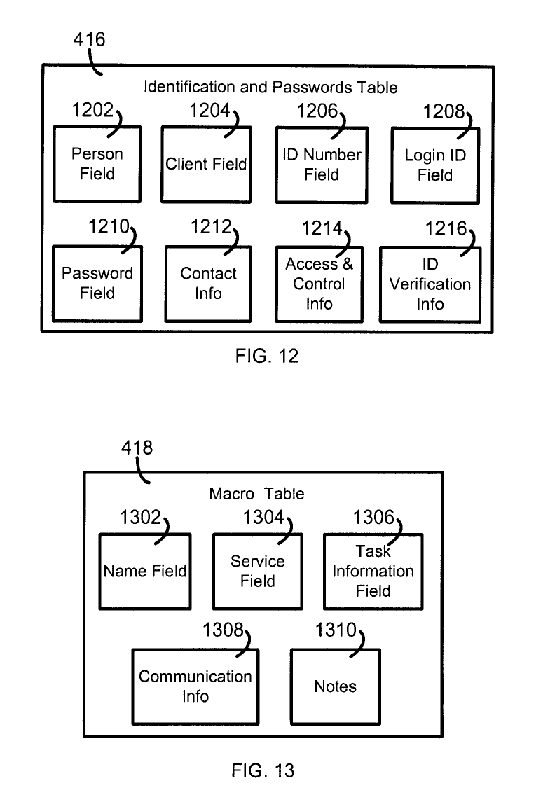

Referring now to FIG. 7, the card table 406 includes fields for compiling and organizing information regarding each particular charge card managed in the FMS 100. The client name field 702 houses information on name of the client for each particular charge card. The number field 704 houses information on the charge card number distinguishing each particular charge card. The program field 706 houses information on which program each particular charge card operates. The sub-service field 708 houses information on services provided for each particular charge card. The aircraft information field 710 houses information on any particular considerations a particular aircraft may impart for each particular charge card. The type field 712 houses information on the particular variety of each particular charge card. The status field 714 houses information on the status of each particular charge card. The cancellation reason information field 716 houses information on the cause of a particular charge card being cancelled. The notes field 718 houses information on any comments the operator of the FMS 100 may find important or helpful, for each particular charge card. The transaction limit field 720 houses information on the charge limit for each particular card. The authorization code field 722 houses information on an authorization code for each particular charge card.

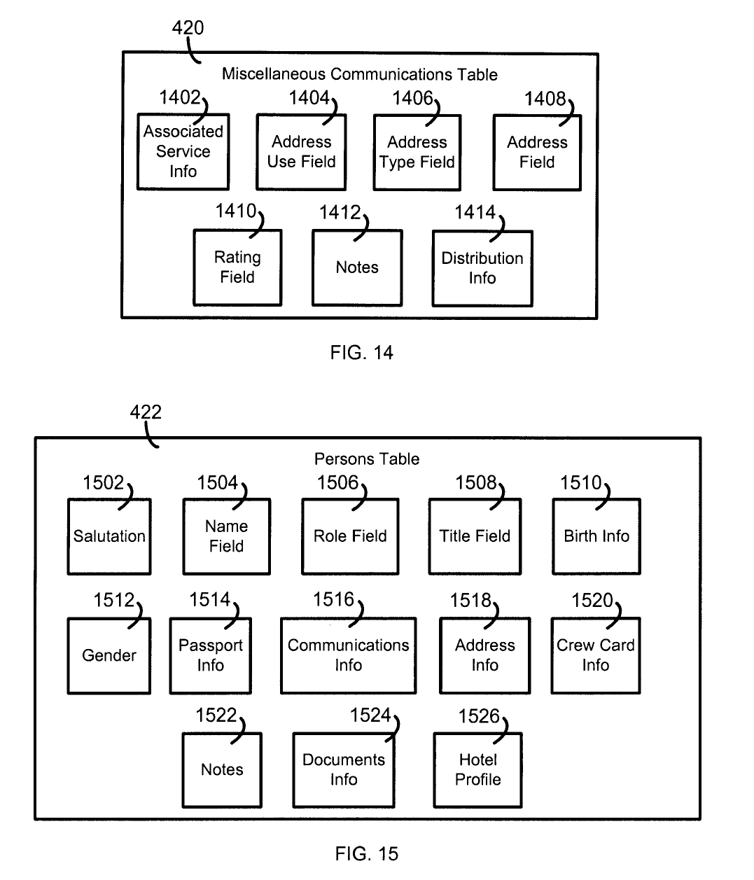

Referring now to FIG. 8, the city table 408 includes fields for compiling and organizing information regarding each particular city managed in the FMS 100. The name field 802 houses name information for each particular city. The state field 804 houses information on the state in which each particular city is located. The country field 806 houses linked information from the country table 414 on the country in which each particular city is located. The information date field 808 houses information on when the information regarding each particular city was documented. The local transportation information field 810 houses information on local transportation at each particular city. The hotels information field 812 houses information on hotels in each particular city. The security information field 814 houses information on security assessment and risks for each particular city.

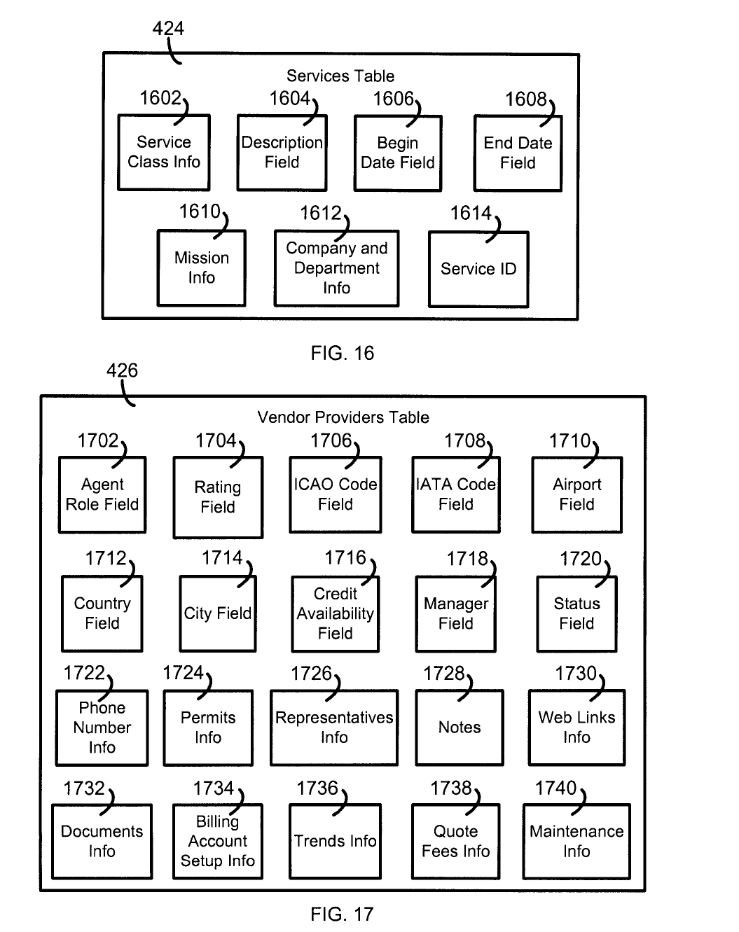

Referring now to FIG. 9, client table 410 includes fields for compiling and organizing information regarding each particular client managed in the FMS 100. The name field 902 houses name information for each particular client. The service cardholder status field 904 houses information on the status assigned by a credit card provider for each particular client. The billing status field 906 houses information on billing status of a credit card for each particular client. The corporate status field 908 houses information on whether each particular client falls under a corporate account. The client number field 910 houses information on an assigned client number for each particular client. The client identification number field 912 houses identification number information for each particular client issued by an official jurisdictional body. The client type field 914 houses classification assignment information for each particular client.

The operational notes field 916 houses information on any operational information or weather service information that may be helpful for each particular client. The sponsor notes field 918 houses information on a sponsor for each particular client. The fuel notes field 920 houses information on anything regarding fueling, for each particular client. The accounting notes field 922 houses information on anything regarding accounting the operator of FMS 100 may find useful, for each particular client.

The APIS and TSA codes field 924 may comprise codes from the U.S. Federal Aviation Administration's Approved Production Inspection System, and the U.S. Transportation Safety Administration, for each particular client. The emergency notification procedures field 926 houses emergency notification procedure information for each client, including who to notify, and how to reach them, in case of an emergency. The sales and marketing notes field 928 houses information on marketing efforts regarding each particular client.

The communications information field 930 houses contact information for each particular client. The cards information field 932 houses linked information from the cards table 406 for each particular client. The A/C information field 934 houses information on aircraft as may pertain to each particular client. The address information field 936 houses address information for each particular client. The contacts information field 938 houses linked information from the persons table 422 indicating persons associated with each particular client. The company information field 940 houses company information associated with each particular client. The bill to field 942 houses information on where to direct invoices for each particular client. The preferences information field 944 houses information on client preferences. The documents information field 946 houses information on any documents that relate to each particular client. The logos information field 948 houses information on logos that may be used to identify or designate each particular client. The web links information field 950 houses information on World Wide Web links and Internet sites for each particular client.

The year-to-date international activity information field 952 houses year-to-date information on activity for each particular client regarding international travel. The year-to-date domestic activity information field 954 houses year-to-date information on activity for each particular client regarding domestic travel. The year-to-date folders information field 956 houses year-to-date information on travel folders compiled for each particular client. The folders information 958 houses information on all current travel folders for each particular client.

The fuel trend information field 960 houses information on all fuel related activity for each particular client. The country trend information field 962 houses information on all country related activity for each particular client. The task trend information field 964 houses information on all task related activity either or both requested and performed for each particular client. The hotel trend information field 966 houses information on all hotel activity for each particular client. The revenue trend information field 968 houses information on all expenditures, collections, and payments for each particular client. The flights information field 970 houses information on flights documented for each particular client.

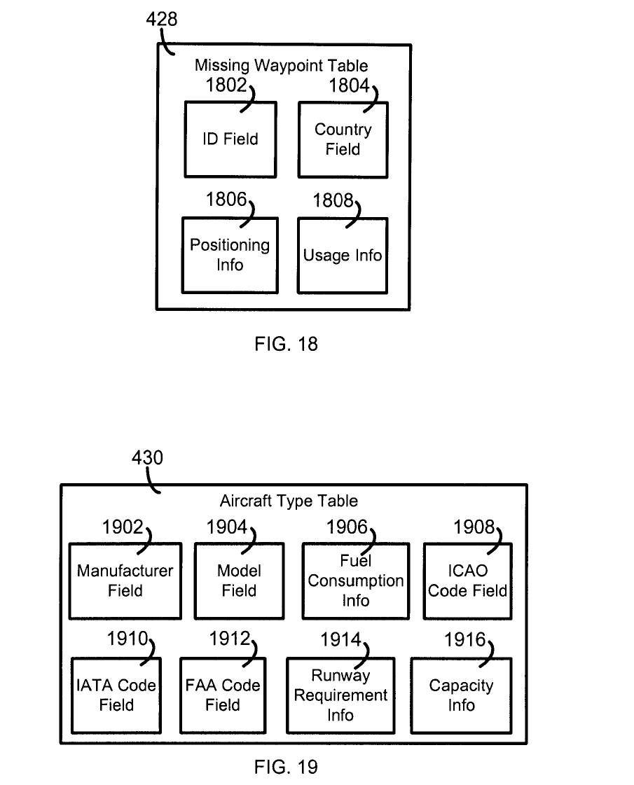

Referring now to FIG. 10, the communications systems table 412 includes fields for compiling and organizing information regarding each particular communications system managed in the FMS 100. The system field 1002 houses information on the general methods of communication available through the FMS 100. The delivery type field 1004 houses information on the nature of the system for each particular communications system. The server field 1006 houses information on the specific server that houses each particular communications system. The coversheet notation field 1008 houses information on whether to include a coversheet with communication by each particular communications system. The modification tracking field 1010 houses information on changes to each particular communications system.

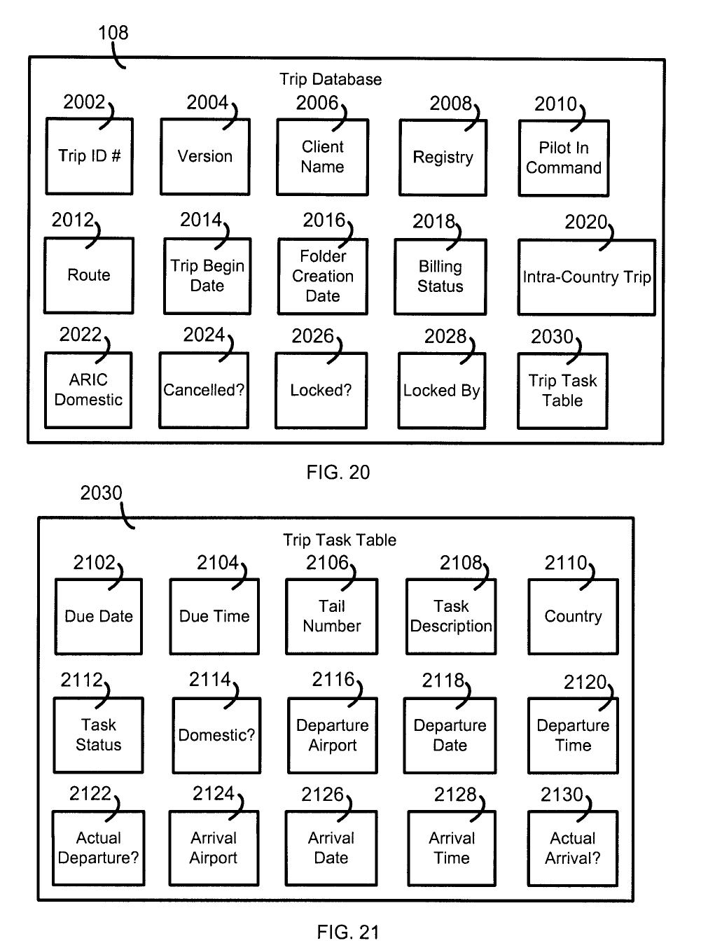

Referring now to FIG. 11, country table 414 includes fields for compiling and organizing information regarding each particular country managed in the FMS 100. The name field 1102 houses information on name of each particular country. The IATA designation field 1104 houses information on International Air Transport Association designations for each particular country. The ICAO code field 1106 houses information on International Civil Aviation Organization codes for each particular country. The permit notes 1108 house any information the operator of the FMS 100 desires to retain, for each particular country. The service representative information 1110 houses linked information from the persons table 422, on persons able to provide assistance regarding various matters, for each particular country.

The government agencies information field 1112 houses any information potentially helpful regarding governmental agencies for each particular country. The client notes 1114 house any information a client desires to retain for each particular country. The general notes 1116 houses any miscellaneous topic that the operator of the FMS 100 desires to retain for each particular country.

The routing restrictions information 1118 houses any information on restrictions to air travel for each particular country. The macro information 1120 houses links to document preparation macros for each particular country. The web links information 1122 houses information on World Wide Web links and Internet sites for each particular country. The communications information 1124 houses information on communication methods and procedures for each particular country. The revisions information 1126 houses information on changes made to information documented regarding each particular country.

The addresses information 1128 houses addresses applicable for coordinating, processing or executing air travel related to each particular country. The documents information 1130 houses information on documents relating to each particular country. The country time conversions information field 1132 houses information on time policies in relationship to the relative time for each particular country. The quote fees 1134 house information on fees charged for service quotes for each particular country.

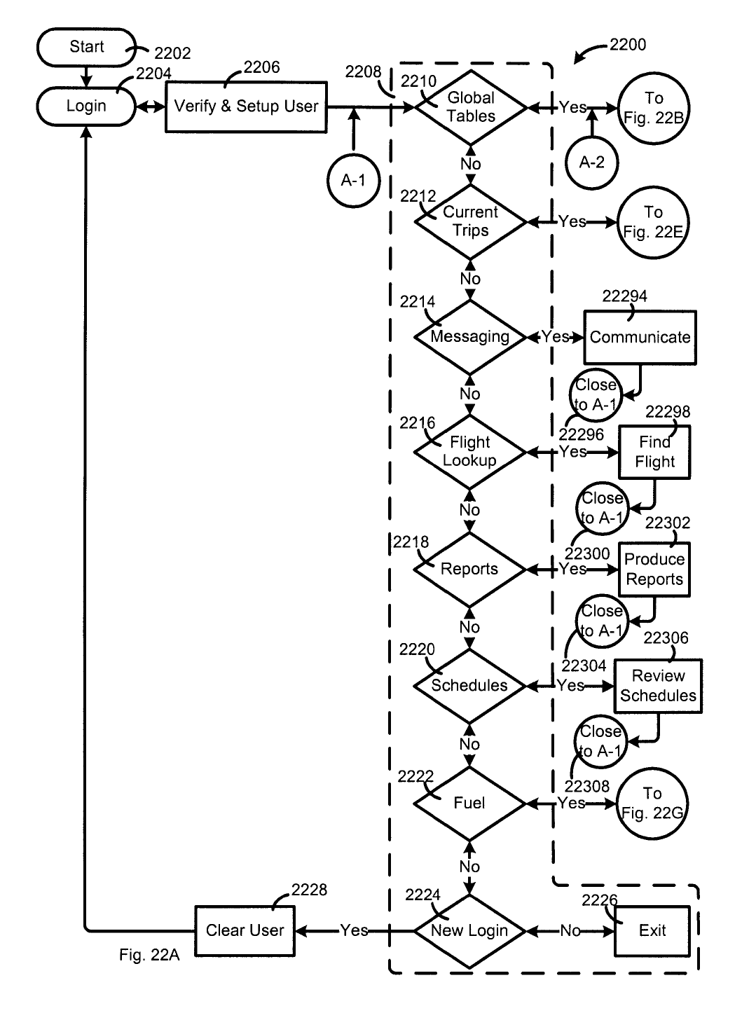

Referring now to FIG. 12, the identification and passwords table 416 includes fields for compiling and organizing information regarding each particular identification and passwords entry managed in the FMS 100. The person field 1202 houses linked information from the persons table 422, on persons for each particular identification and passwords entry. The client field 1204 houses linked information from the client table 410, on clients related to the persons for each particular identification and passwords entry. The identification number field 1206 houses information on an assigned number for each particular identification and passwords entry. The login identification field 1208 houses information on an identifier used at login for each particular identification and passwords entry. The password field 1210 houses information on a password for each particular identification and passwords entry. The contact field 1212 houses information on a point of contact regarding the related person, for each particular identification and passwords entry. The access and control information 1214 houses information on the specific rights and authorities held and useable by each particular identification and passwords entry. The identification verification information 1216 houses information for backup verification of the identity of the user for each particular identification and passwords entry.

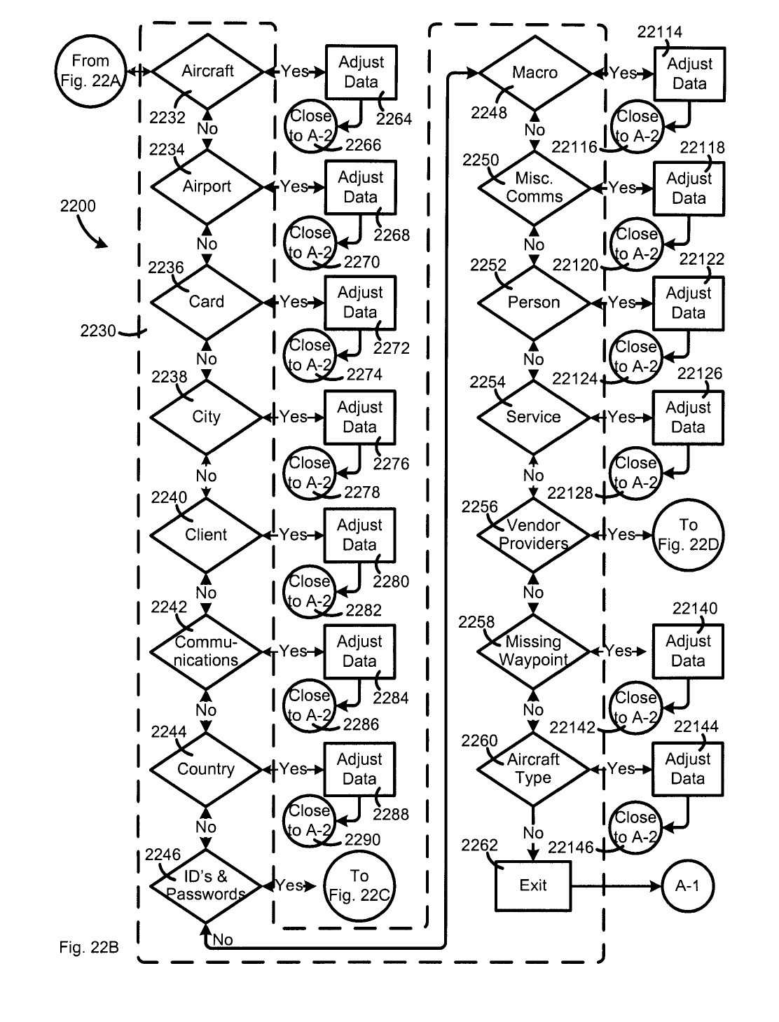

Referring now to FIG. 13, macro table 418 includes fields for compiling and organizing information regarding each particular macro managed in the FMS 100. The name field 1302 houses information for distinctive names for each particular macro. The service field 1304 houses information on the service affected by each particular macro. The task information field 1306 houses information on the particular task affected by each particular macro. The communication information 1308 houses information on the communication of the matter prepared by the macro that may be submitted for each particular macro. The notes field 1310 houses any information the operator of the FMS 100 desires to retain for each particular macro.

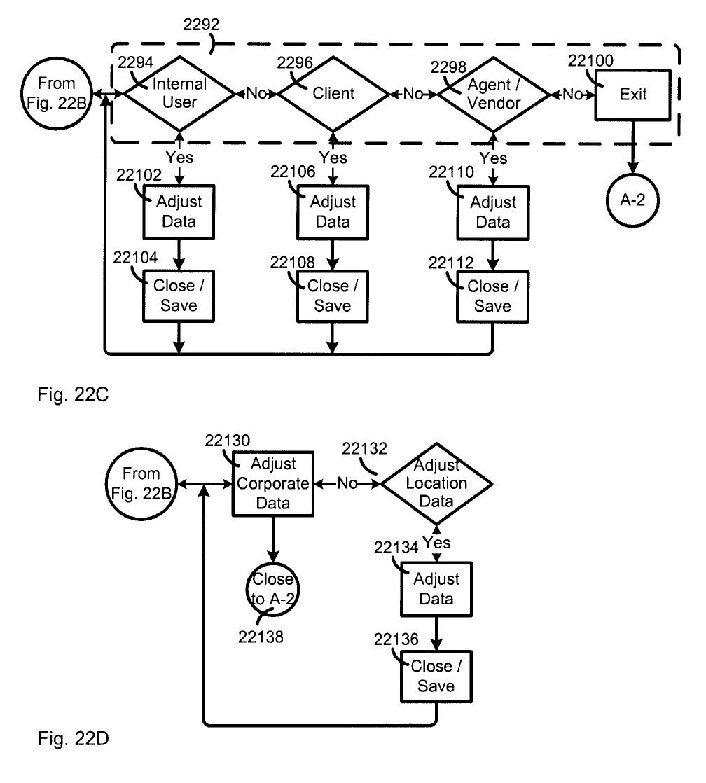

Referring now to FIG. 14, the miscellaneous communications table 420 includes fields for compiling and organizing information regarding each particular miscellaneous communications entry managed in the FMS 100. The associated service information 1402 houses information on the broad associated service contacted by each particular miscellaneous communications entry. The address use field 1404 houses information on the specific type of service contacted by each particular miscellaneous communications entry. The address type field 1406 houses information on communication means employed for each particular miscellaneous communications entry. The address field 1408 houses information on the particular contact information needed for each particular miscellaneous communications entry. The rating field 1410 houses assessed information on the degree of capability to provide the service for each particular miscellaneous communications entry. The notes field 1412 houses any other information the operator of the FMS 100 desires to retain for each particular miscellaneous communications entry. The distribution information 1414 houses information on the authorization to release the information outside the operational center 110 for each particular miscellaneous communications entry.

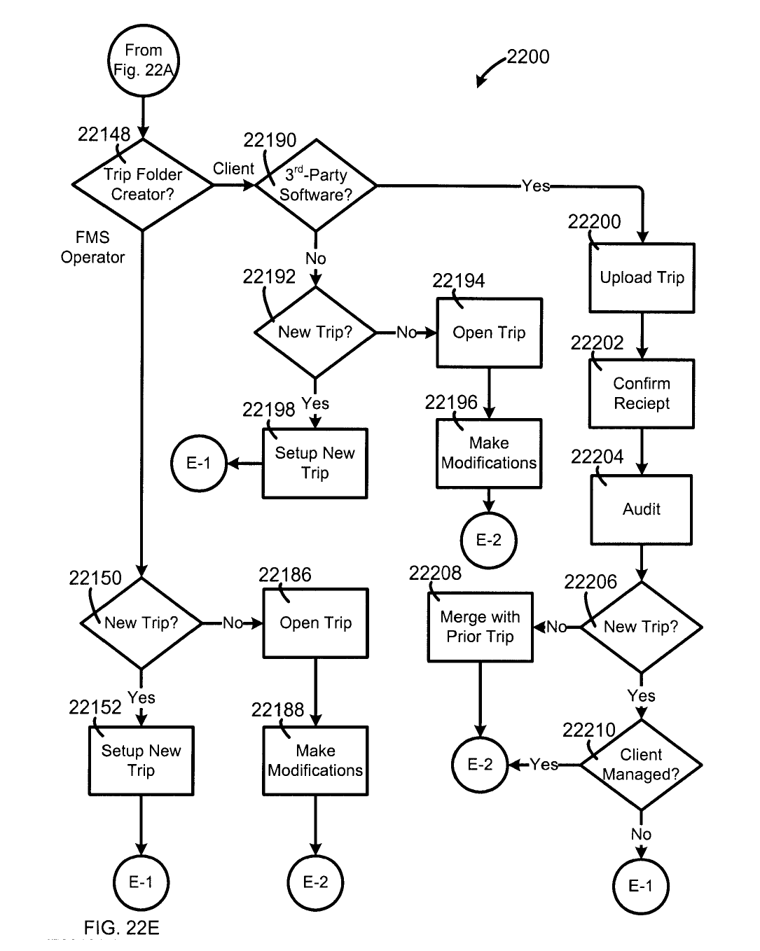

Referring now to FIG. 15, the persons table 422 includes fields for compiling and organizing information regarding each particular person managed in the FMS 100. The salutation field 1502 houses information on an appropriate salutation for each particular person. The name field 1504 houses information on the name of each particular person. The role field 1506 houses information on the role of each particular person with respect to air travel. The title field 1508 houses information on job title for each particular person. The birth field 1510 houses information on the date of birth of each particular person. The gender field 1512 houses information on the gender of each particular person. The passport field 1514 houses passport information for each particular person. The communications information 1516 houses information on communication methods to contact each particular person. The address information field 1518 houses address information for each particular person. The crew card information 1520 houses information on the crew identification card for each particular person. The notes field 1522 houses any other information the operator of the FMS 100 desires to retain for each particular person. The documents information field 1524 houses information on any documents relating to each particular person. The hotel profile field 1526 houses information on lodging documentation and preferences for each particular person.

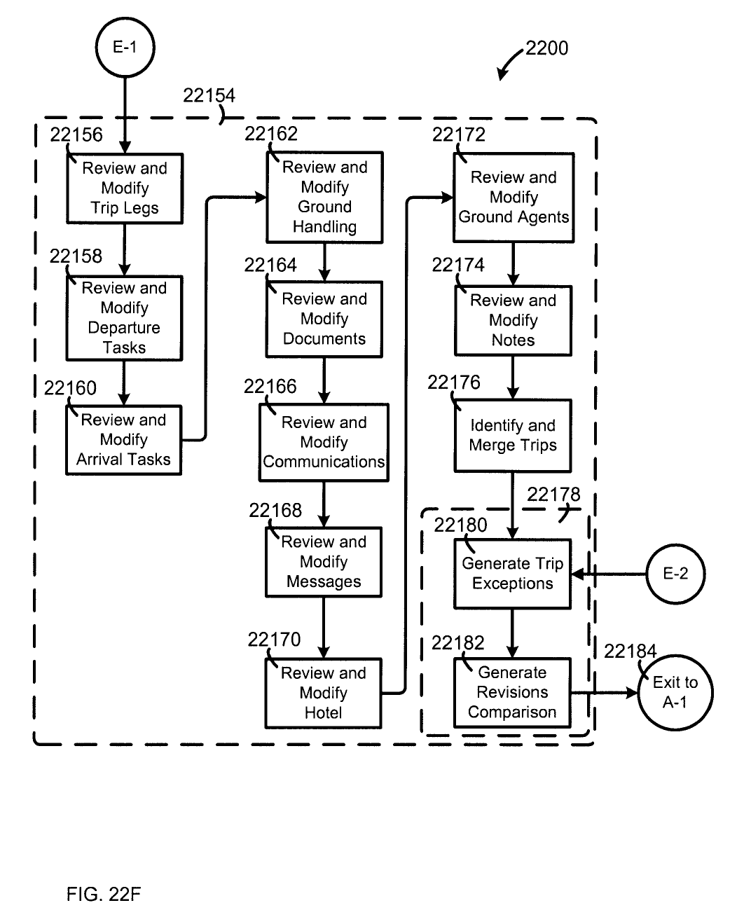

Referring now to FIG. 16, the services table 424 includes fields for compiling and organizing information regarding each particular service managed in the FMS 100. The service class information field 1602 houses information on the classification of each particular service. The description field 1604 houses a description of each particular service. The begin date field 1606 houses information on when the services start for each particular service. The end date field 1608 houses information on when the services end for each particular service. The mission information 1610 houses information on the purpose for each particular service. The company and department information 1612 houses information on the division of the service provider responsible for each particular service. The service identification field 1614 houses identifying information for each particular service.

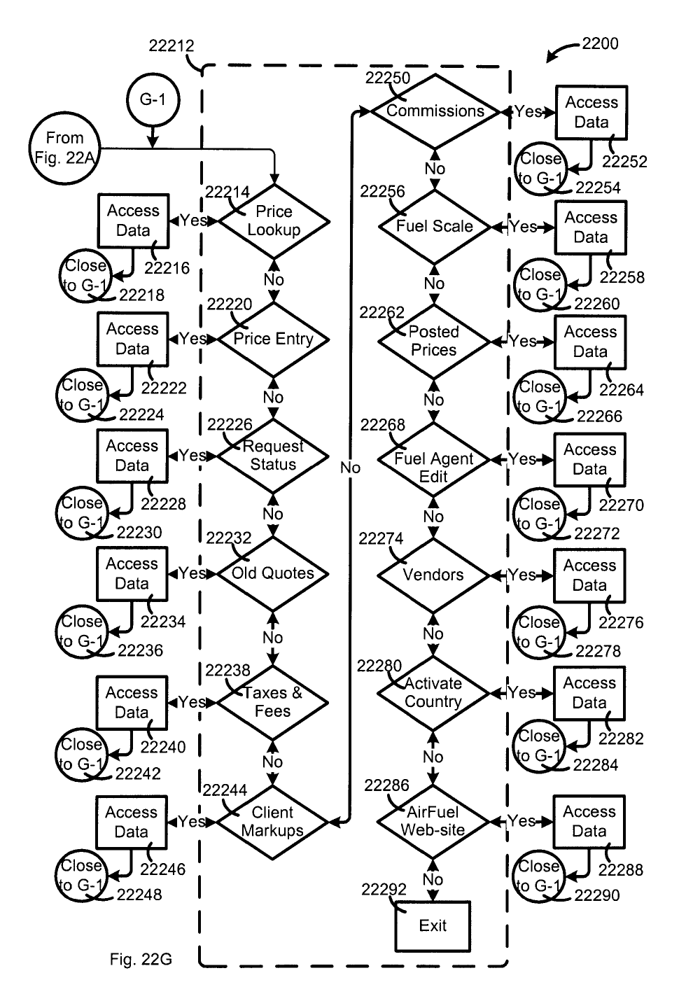

Referring now to FIG. 17, the vendor providers table 426 includes fields for compiling and organizing information regarding each particular vendor provider managed in the FMS 100. The agent role field 1702 houses a description of the role of each particular vendor provider. The rating field 1704 houses information on assessed rating and capabilities for each particular vendor provider. The ICAO code field 1706 houses information on codes from the International Civil Aviation Organization for each particular vendor provider. The IATA code field 1708 houses information on codes from the International Air Transport Association for each particular vendor provider. The airport field 1710 houses linked information from the airport table 404, on the airport at which the service is to be provided, for each particular vendor provider. The country field 1712 houses linked information from the country table 414, on the country in which the service is to be provided, for each particular vendor provider. The city field 1714 houses linked information from the city table 408, on the city associated with where the service is to be provided, for each particular vendor provider.

The credit availability field 1716 houses information on the ability to provide credit transactions for each particular vendor provider. The manager field 1718 houses information on the manager responsible for the service to be provided for each particular vendor provider. The status field 1720 houses information on the availability status for the service to be provided for each particular vendor provider. The phone number information 1722 houses phone number information to a responsible party for the service to be provided for each particular vendor provider. The permits information 1724 houses permit information for the service to be provided for each particular vendor provider. The representatives information 1726 houses information on each representative for the service to be provided for each particular vendor provider. The notes field 1728 houses any information the operator of the FMS 100 desires to retain for each particular vendor provider.

The web links information 1730 houses information on World Wide Web links and Internet sites for each particular vendor provider. The documents information 1732 houses document information for the service to be provided for each particular vendor provider. The billing account setup information 1734 houses information for setting up billing accounts for each particular vendor provider. The trends information 1736 houses information on activity and usage trends for each particular vendor provider. The quote fees information 1738 houses fee quotes for the service to be provided for each particular vendor provider. The maintenance information 1740 houses maintenance information relating to the service to be provided for each particular vendor provider.

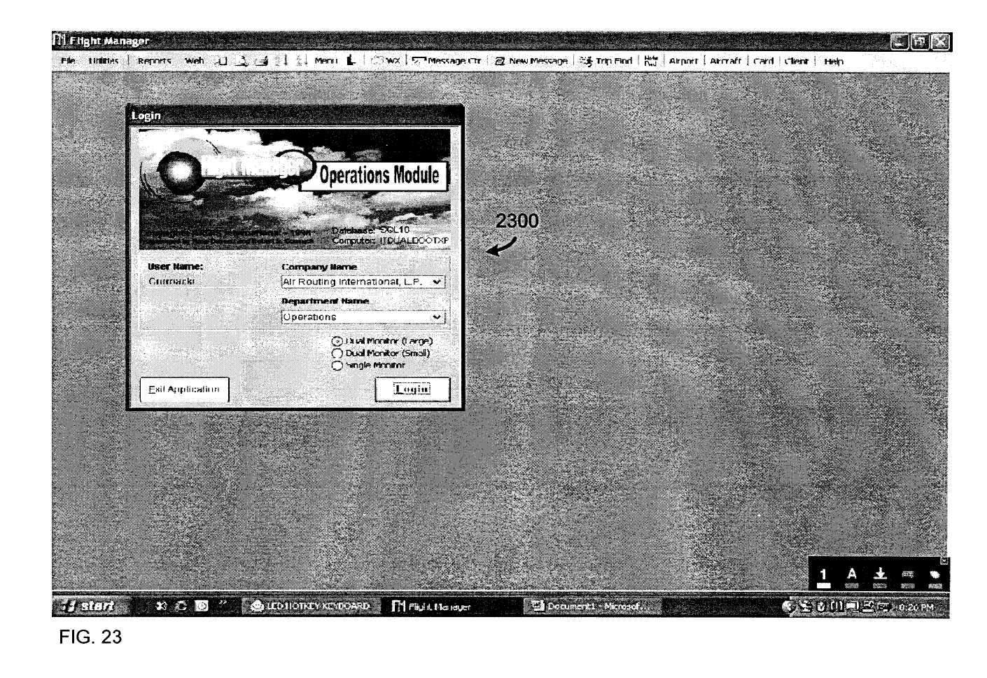

Referring now to FIG. 18, the missing waypoint table 428 includes fields for compiling and organizing information regarding each particular missing waypoint managed in the FMS 100. The identification field 1802 houses information to identify each particular missing waypoint. The country field 1804 houses linked information from the country table 414, on the country in which the waypoint is actually located, for each particular missing waypoint. The positioning information 1806 houses information necessary to locate the actual position of each particular missing waypoint. The usage information field 1808 houses information on usage of each particular missing waypoint.

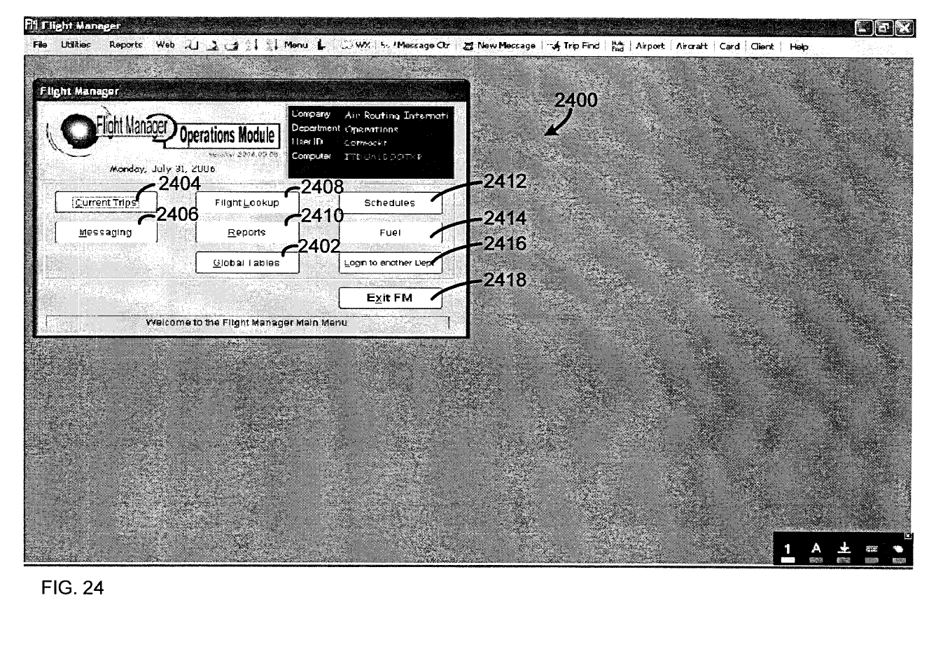

Referring now to FIG. 19, the aircraft type table 430 includes fields for compiling and organizing information regarding each particular aircraft type managed in the FMS 100. The manufacturer field 1902 houses information on the manufacturer for each particular aircraft type. The model field 1904 houses information on the aircraft model for each particular aircraft type. The fuel consumption information 1906 houses information on fuel consumption by distance and time, for each particular aircraft type. The ICAO code field 1908 houses information on the International Civil Aviation Organization codes for each particular aircraft type. The IATA codes field 1910 houses information on the International Air Transport Association codes for each particular aircraft type. The FAA code field 1912 houses information on the U.S. Federal Aviation Administration codes for each particular aircraft type. The runway requirement information field 1914 houses runway requirements information for each particular aircraft type. The capacity information field 1916 houses information on the cargo and people capacity for each particular aircraft type.

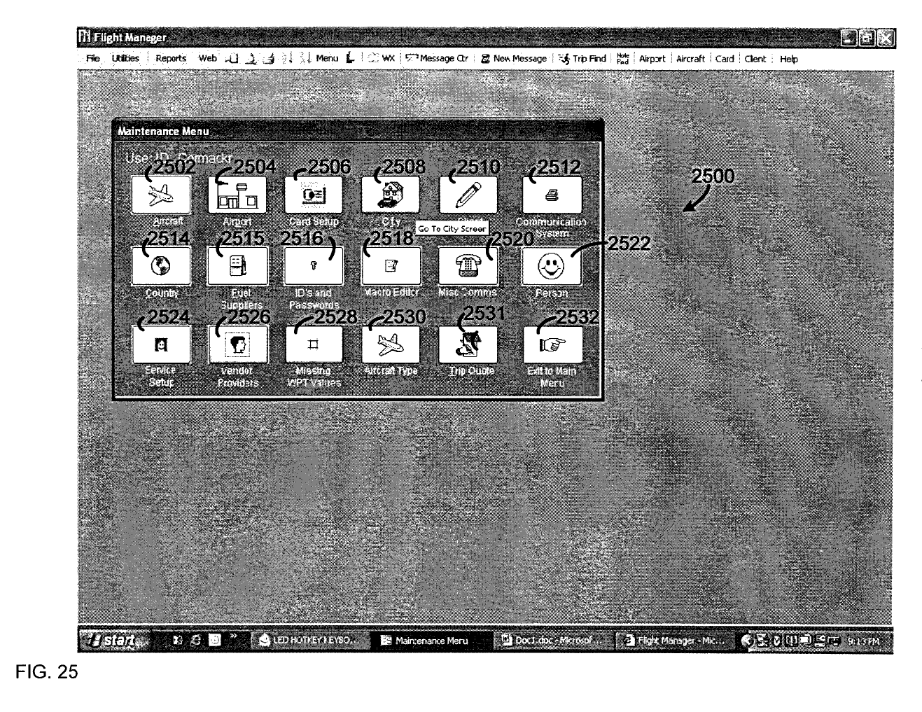

Referring to FIG. 20, the trip database 108 includes fields and tables for organizing and storing the specific data regarding a particular trip. The trip database 108 includes fields for the trip ID number 2002, which allow the FMS 100 to assign a unique number, and the version 2004, which denotes the number of times a trip has been changed. The trip database 108 further includes fields for the client name 2006, the registry 2008 of the aircraft, and the pilot in command 2010. The trip database 108 further includes fields for the route 2012, denoted as a string of airports, the trip begin date 2014, and the folder creation date 2016. The trip database 108 further includes fields for the billing status 2018, a Boolean intra-country trip designator 2020, a Boolean ARIC domestic indicator 2022, and a Boolean cancelled indicator 2024. The trip database 108 further includes fields for a Boolean locked indicator 2026, for who locked the trip 2028, and for a trip task table 2030.

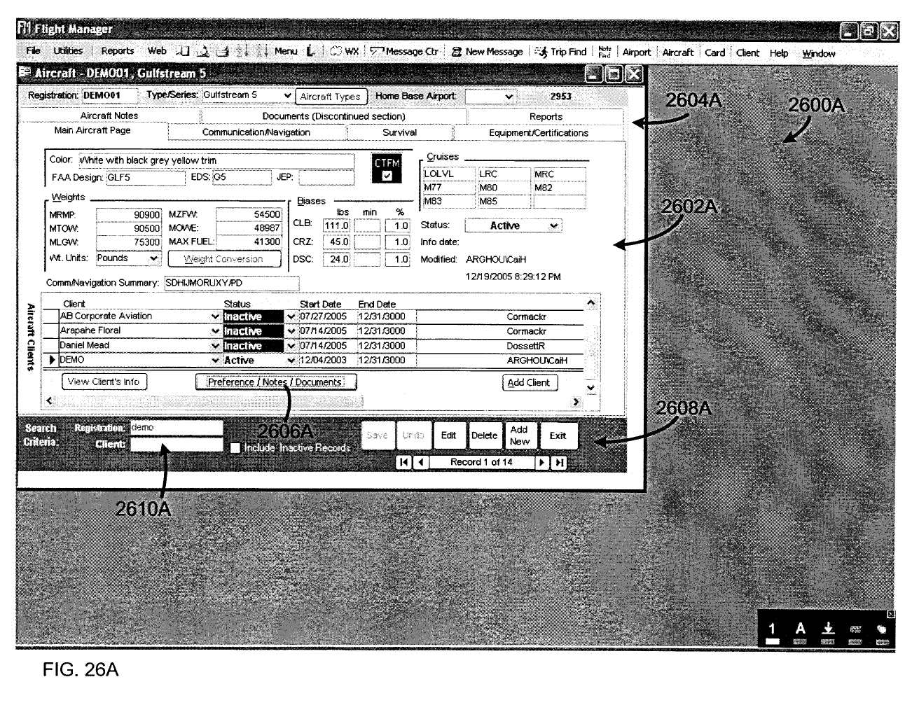

Referring to FIG. 21, the trip task table 2030 includes fields for organizing and storing the specific data regarding the individual particular tasks requested for each leg of a particular trip. The trip task table 2030 further includes fields for the due date 2102 and the due time 2104 for completion of the particular task. The trip task table 2030 further includes fields for the tail number 2106 for the particular aircraft, the task description 2108 for the task to be performed, the country 2110 in which the task is to be performed, and the task status 2112. The trip task table 2030 further includes a field for a domestic Boolean indicator 2114 of whether the leg initiates and terminates in the same country. The trip task table 2030 further includes fields for the departure airport 2116, the departure date 2118 and the departure time 2120, and an actual departure Boolean indicator 2122 as to whether the departure date 2118 and the departure time 2120 are for the actual departure. The trip task table 2030 further includes fields for the arrival airport 2124, the arrival date 2126 and the arrival time 2128, and an actual arrival Boolean indicator 2130 as to whether the arrival date 2126 and the arrival time 2128 are for the actual arrival.

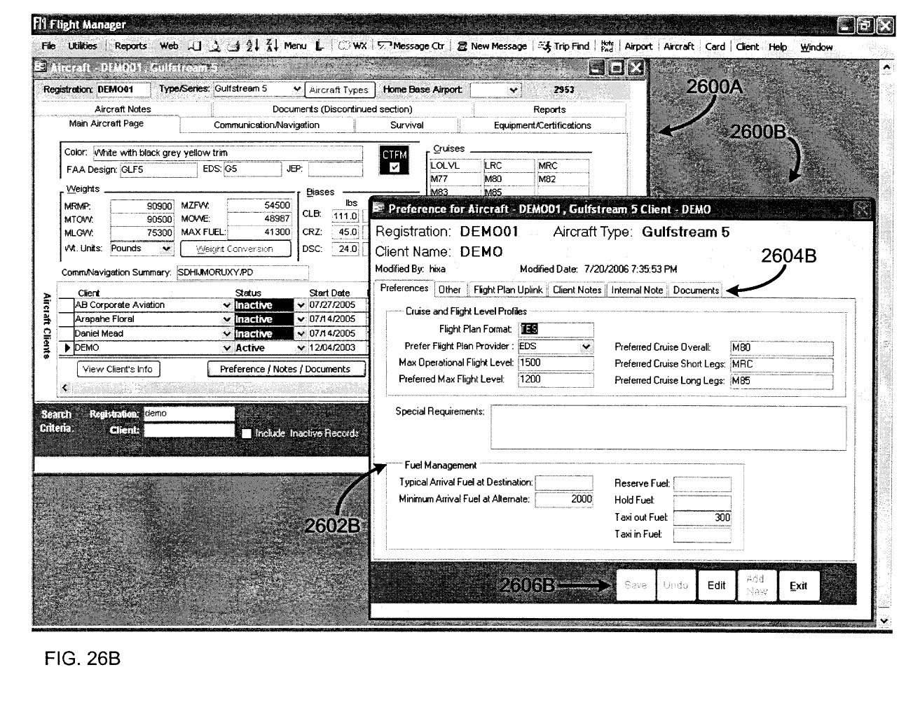

Referring now to FIGS. 22A-G, 23-25, 26A-B, 27A-B, 28, 29-32, 33A-E, 34-37, 38A-B, 39 and 40, a flight management process 2200 (“FMP”) operates the FMS 100 through linked computer generated visual displays, commonly identified as pages, windows or screens, which have an integrated graphic user interface (“GUI”). At 2202, the user of the FMS 100 initiates the FMP 2200. At 2204, a login screen 2300 opens to accept a user's login information. At 2206, the user's login information is verified and the FMP 2200 establishes the user's access and use authorities. If the user's login is not accepted, the FMP 2200 returns to the login screen 2300, at 2204. If the user's login is accepted, the FMP 2200 displays a main menu screen 2400, at 2208.

The main menu screen 2400 presents the user of the FMP 2200 with a series of choices to determine which sub-routine the user wants to initiate. At any choice the user can initiate the particular routine or decide against the particular routine, and move on to the next choice. The choices at 2208 include global tables' activities, at 2210, current trips activities, at 2212, messaging activities, at 2214, flight lookup activities, at 2216, reports activities, at 2218, schedules activities, at 2220, fuel activities, at 2222, new login activities, at 2224, and exit activities, at 2226.

The main menu screen 2400 depicts the series of choices as a grouping of GUI buttons, where one button exists for each choice. The main menu screen 2400 includes a global tables button 2402, a current trips button 2404, a messaging button 2406, a flight lookup button 2408, a reports button 2410, a schedules button 2412, a fuel button 2414, a new login button 2416, and an exit button 2418.

The user of FMP 2200 may choose an activity by clicking on the corresponding button on main menu screen 2400. Selecting the new login activities, at 2224, by clicking on the new login button 2416, causes the FMP 2200 to clear the user access and use authorities, at 2228. The FMP 2200 then returns to the login screen, at 2204. Selecting the exit activities, at 2226, by clicking on the exit button 2418, causes the termination of the FMP 2200.

The user of FMP 2200 may choose to perform global tables activities, at 2210, to allow the user of FMP 2200 to correct, supplement and update information the FMS 100 maintains in support database 106, according to the user authority. Selecting the global tables activities, at 2210, by clicking on the global tables button 2402 accesses a maintenance menu screen 2500, at 2230.

The maintenance menu screen 2500 presents the user with a series of choices to determine which table of information the user wants to access. At any choice the user can access the corresponding table or decide against that particular table, and move on to the next choice. The choices at 2230 include accessing an aircraft table, at 2232, an airport table, at 2234, a card table, at 2236, a city table, at 2238, a client table, at 2240, a communications table, at 2242, a country table, at 2244, an identification and passwords table, at 2246, a macro table, at 2248, a miscellaneous communications table, at 2250, a person table, at 2252, a service table, at 2254, a vendor providers table, at 2256, a missing waypoint table, at 2258, an aircraft table, at 2260, and a exiting the FMP 2200, at 2262.

The maintenance menu screen 2500 depicts the series of choices as a grouping of GUI buttons, where one button exists for each choice. The maintenance menu screen 2500 includes an aircraft button 2502, an airport button 2504, a card button 2506, a city button 2508, a client button 2510, a communications systems button 2512, a country button 2514, an identification and passwords button 2516, a macro button 2518, a miscellaneous communications button 2520, a person button 2522, a services setup button 2524, a vendor providers button 2526, a missing waypoint button 2528, an aircraft type button 2530, and an exit button 2532.

Choosing aircraft button 2502, at 2232, opens aircraft main screen 2600A. Main aircraft screen 2600A is a GUI that facilitates a user's adjustment of the data of aircraft table 402, at 2264. Adjustment of the data includes initial entry of information, supplementation of information, and modification of information. Data that may be adjusted appears in aircraft information fields 2602A, in aircraft information tabs 2604A, and in the supplemental aircraft information screen 2600B, accessible by the preference/notes/documents button 2606A. Data modification in the main aircraft screen 2600A is executed by the user through action buttons 2608A. A particular aircraft may be found through search feature 2610A.

Supplemental aircraft information screen 2600B is also a GUI, which facilitates adjustment of data in information fields 2602B and information tabs 2604B. The user executes data modification in the supplemental aircraft information screen 2600B through action buttons 2606B. Clicking on the respective action buttons 2606B and 2608A to exit, at 2266, closes the supplemental aircraft information screen 2600B and the main aircraft screen 2600A, respectively, taking the user of FMP 2200 back to the maintenance menu screen 2500, at 2230.

Choosing airport button 2504, at 2234, opens main airport screen 2700A. Main airport screen 2700A is a GUI that facilitates the user's adjustment of the data of airport table 404, at 2268. Data that may be adjusted appears in airport information fields 2702A, in airport information tabs 2704A, through linked-page buttons 2706A, and in the supplemental airport information screen 2700B, accessible by view select buttons 2708A. Data modification in the main airport screen 2700A is executed by the user through action buttons 2710. A particular airport may be found through search feature 2712.

Supplemental airport information screen 2700B is also a GUI, which facilitates adjustment of data in information fields 2702B, information tabs 2704B, and information text field 2706B. The user executes data modification in the supplemental aircraft information screen 2700B through action buttons 2708B. Clicking on the exit action button at 2708B or 2710, at 2270, closes either the supplemental airport information screen 2700B or the main airport screen 2700A, respectively, returning the user to the maintenance menu screen 2500, at 2230.

Choosing card setup button 2506, at 2236, opens card setup information screen 2800. Card setup information screen 2800 is a GUI that facilitates a user's adjustment of the data of card table 406, at 2272. Data that may be adjusted appears in card information fields 2802 and through linked-page buttons 2804. Closing the card setup information screen 2800, at 2274, saves adjustments and closes card setup information screen 2800, returning the user to the maintenance menu screen 2500, at 2230.

Choosing city button 2508, at 2238, opens city information screen 2900. City information screen 2900 is a GUI that facilitates the FMP 2200 user's adjustment of the data of city table 408, at 2276. Data that may be adjusted appears in city information fields 2902 and through linked-page buttons 2904. Information on a particular city may be found through search feature 2906. Clicking on the action button 2908 to exit, at 2278, saves adjustments and closes city information screen 2900, returning the user to the maintenance menu screen 2500, at 2230.

Choosing client button 2510, at 2240, opens client information screen 3000. Client information screen 3000 is a GUI that facilitates a user's adjustment of the data of client table 410, at 2280. Data that may be adjusted appears in client information fields 3002, through linked-page buttons 3004, in information tabs 3006, and in text field 3008. Information on a particular client may be found through search feature 3010. Clicking on the action button 3012 to exit, at 2282, saves adjustments and closes client information screen 3000, returning the user to the maintenance menu screen 2500, at 2230.

Choosing communications systems button 2512, at 2242, opens communications systems information screen 3100. Communications systems information screen 3100 is a GUI that facilitates a user's adjustment of the data of communications systems table 412, at 2284. Data that may be adjusted appears in communications systems information fields 3102. Closing the communications systems information screen 3100, at 2286, saves adjustments and closes communications systems information screen 3100, returning the user to the maintenance menu screen 2500, at 2230.

Choosing country button 2514, at 2244, opens country information screen 3200. Country information screen 3200 is a GUI that facilitates a user's adjustment of the data of country table 414, at 2288. Data that may be adjusted appears in country information fields 3202 and information tabs 3204. Information on a particular country may be found through search feature 3206. Clicking on the action button 3208 to exit, at 2290, saves adjustments and closes country information screen 3200, returning the user to the maintenance menu screen 2500, at 2230.

Choosing identification and passwords button 2516, at 2246, opens identification and passwords menu window 3300, at 2292. Identification and passwords menu window 3300 presents a user with a series of choices to determine which type of identification and passwords information the user wants to access. At any choice the user can access the corresponding type of information or decide against that particular type of information, and move on to the next choice. The choices at 2292 include accessing internal user's information, at 2294, client user information, at 2296, agent/vendor user information, at 2298, or closing, at 22100, to the maintenance menu screen 2500, at 2230.

The identification and passwords menu window 3300 depicts the series of choices as a grouping of GUI buttons, where one button exists for each choice. The identification and passwords menu window 3300 includes an internal user's button 3302A, a client logins button 3302B, an agents/vendor provider logins button 3302C, and close button 3304.

Choosing internal users button 3302A, at 2294, opens internal users information screen 3306A. Internal users information screen 3306A is a GUI that facilitates the adjustment of the internal users data of the identification and passwords table 416, at 22102. Data that may be adjusted appears in identification and passwords information fields 3308A, information tabs 3310A, and authority summary fields 3312A. Authority summary fields 3312A display a user's access and use authorization in a string of binary operators that represent specific authorizations. Clicking on role button 3314A opens access code screen 3316A, which displays the specific authorizations for each operator in the authority codes field 3318A. The operators are turned “on” or “off” by selectively checking authority checkboxes 3320A. Closing the access code screen 3316A, and then clicking the action button 3322A to close the internal user's information screen 3306A, at 22104, saves adjustments and closes 3306A, returning the user to the identification and passwords menu window 3300, at 2292.

Choosing client button 3302B, at 2296, opens client user information screen 3306B. Client user information screen 3306B is a GUI that facilitates the user's adjustment of a user's data of the identification and passwords table 416, at 22106. Data that may be adjusted appears in identification and passwords information fields 3308B and the authority summary fields 3310B. A particular client user may be found through search feature 3012B. The user may facilitate various actions through action buttons 3314B. Clicking the action button 3314B to close the client user information screen 3306B, at 22108, saves adjustments and closes client user information screen 3306B, returning the user to the identification and passwords menu window 3300, at 2292.

Choosing agents/vendor provider logins button 3302C, at 2298, opens agents/vendor user information screen 3306C. Agents/vendor user information screen 3306C is a GUI that facilitates the adjustment of the agents/vendor user data of the identification and passwords table 416, at 22110. Data that may be adjusted appears in identification and passwords information fields 3308C and the authority summary fields 3310C. A particular agents/vendor user may be found through search feature 3012C. The user may facilitate various actions through buttons 3314C. Clicking the action button 3314C to close the agents/vendor user information screen 3306C, at 22112, saves adjustments and closes agents/vendor user information screen 3306C, returning the user to the identification and passwords menu window 3300, at 2292.

Choosing macro editor button 2518, at 2248, opens macro editor screen 3400. Macro editor screen 3400 is a GUI that facilitates the user's adjustment of the user data of macro table 418, at 22114. Data that may be adjusted appears in macro editor fields of screen 3400. The create new macro button 3404 creates and opens a new macro, which will then appear in the display field 3402. The open button 3406 opens an existing macro selected from a list of macros displayed in display field 3402. Clicking on action buttons 3208 executes a selected macro file as indicated. Clicking on the close button 3410 closes the macro editor screen 3400, at 22116, returning the user to the maintenance menu screen 2500, at 2230.

Macros adjusted in macro editor screen 3400, may be linked to a country in the country table 414, at 2244. Then at 2288, clicking on the information tab 3204 for macros in the country table 414 opens the country macro tab screen 3411. Macros linked to a country in the country table 414 are shown in macro display field 3412. Additional macros are linked to a country by opening the macro list with the open macro list button 3414, and selecting macros from the available macros. Information on a particular country may be found through search feature 3416. Clicking on the action button 3418 to exit, at 2290, saves adjustments and closes country macro tab screen 3411, returning the user to the maintenance menu screen 2500, at 2230.

Choosing miscellaneous communications button 2520, at 2250, opens miscellaneous communications information screen 3500. Miscellaneous communications information screen 3500 is a GUI that facilitates the adjustment of user data of miscellaneous communications table 420, at 22118. Data that may be adjusted appears in miscellaneous communications information fields 3502. Closing the miscellaneous communications information screen 3500, at 22120, saves adjustments and closes screen 3500, returning the user to the maintenance menu screen 2500, at 2230.

Choosing the person button 2522, at 2252, opens persons information screen 3600. Persons information screen 3600 is a GUI that facilitates the adjustment of user data of persons table 422, at 22122. Data that may be adjusted appears in persons information fields 3602 and through linked-page buttons 3604. Information on a particular person may be found through search feature 3606. Clicking on the action button 3608 to exit, at 22124, saves adjustments and closes persons information screen 3600, returning the user to the maintenance menu screen 2500, at 2230.

Choosing the service setup button 2524, at 2254, opens service information screen 3700. Service information screen 3700 is a GUI that facilitates adjustment of user data of services table 424, at 22126. Data that may be adjusted appears in services information fields 3702. The information seen may be customized through the use of service class buttons 3704. Clicking on the action button 3706 to exit, at 22128, saves adjustments and closes service information screen 3700, returning the user to the maintenance menu screen 2500, at 2230.

Choosing vendor providers button 2526, at 2256, opens the vendor provider main screen 3800A. The main vendor provider's screen 3800A is a GUI that facilitates the adjustment of user data of vendor providers table 426, at 22130. Data that may be adjusted appears in vendor providers information fields 3802A, in information tabs 3804A, and in the location vendor providers information screen 3800B. Data modification in the main vendor providers screen 3800A is executed by the user through action buttons 3806A. A particular vendor provider may be found through search feature 3808A and details about a specific vendor provider location can be accessed by selecting the location from the vendor providers information fields 3802A and clicking on detail button 3810A.

Clicking on detail button 3810A opens the location vendor providers information screen 3800B, at 22132. Supplemental vendor providers information screen 3800B is also a GUI, which facilitates adjustment of data in information fields 3802B and information tabs 3804B, at 22134. The user executes data modification in the supplemental vendor providers information screen 3800B through action buttons 3806B. Clicking on the action button 3806B to exit, at 22136, closes the location vendor providers information screen 3800B, taking the user back to the vendor providers main screen 3800A. Clicking on the action button 3806A to exit, at 22138, closes the main vendor providers screen 3800A, taking the user back to the maintenance menu screen 2500, at 2230.

Choosing missing waypoint button 2528, at 2258, opens missing waypoint information screen 3900. Missing waypoint information screen 3900 is a GUI that facilitates the adjustment of user data of missing waypoint table 428, at 22140. Data that may be adjusted appears in missing waypoint information fields 3902. Closing the missing waypoint information screen 3900, at 22142, saves adjustments and closes screen 3900, returning the user to the maintenance menu screen 2500, at 2230.

Choosing aircraft type button 2530, at 2260, opens aircraft type information screen 4000. Aircraft type information screen 4000 is a GUI that facilitates the adjustment of user data of aircraft type table 430, at 22144. Data that may be adjusted appears in aircraft type information fields 4002. Clicking on the action button 4004 to exit, at 22146, saves adjustments and closes aircraft type information screen 4000, returning the user to the maintenance menu screen 2500, at 2230.

Choosing exit button 2532, at 2262, closes maintenance menu screen 2500, returning the user to the main menu screen 2400, at 2208.

Referring now to FIGS. 1-3, 20-21, 22A-F, 23-24, 41-57, the user of FMP 2200 may choose to perform current trips activities, at 2212, allowing the user to enter, review, modify and delete air travel trips and related tasks that the FMS 100 maintains in trip database 108, according to the user authority. Selecting the current trips activities by clicking on the current trips button 2404, at 2212, the user gains access to the information within trip database 108.

The information of trip database 108 is illustrated through a collection of screens, including a managed trip folder list window 4100, a complete trip folder list window 4200, a trip task list window 4300, a new trip setup window 4400, a list of services window 4500, a trip leg list window 4600, a departure task window 4700A, an arrival task window 4700B, a ground handling details window 4800, a documents window 4900, a communications classic view window 5000A, a communications pivot view window 5000B, a trip message window 5100, a hotel details window 5200, a ground handler agent details window 5300, a merge window 5400, a trip exceptions window 5500, and a revision comparison window 5600.

The managed trip folder list window 4100 includes information display fields 4102, client-managed intra-state trip indicator 4104, folder format button 4106, task format button 4108, trip setup button 4110, open trip button 4112, trip phone call button 4114, trip notes button 4116, trip exceptions button 4118, trip revisions button 4120, merge trip button 4122, and exit button 4124. In an exemplary embodiment, one item displayed in the information display fields 4102 is a column of K-K Trip radio buttons 4126. The “K” refers to the International Civil Aviation Organization (ICAO) airport codes generally reserved for the continental United States. By selecting the K-K Trip radio buttons 4126, a client 114 is able to independently manage and customize any and all trip legs within the “K” airport codes; i.e., within the continental United States. If selected, the FM operator 112 defers all processing requests to the client 114. Client 114 customization includes, among other features, defining a small territory within the United States representative of a region frequently traveled by the client 114.

Information display fields 4102 includes information on current trips organized in the fields of trip database 108. The client-managed intra-state trip indicator 4104, permits the user to display all trips in the trip database 108. Checking the client-managed intra-state trip indicator 4104 opens complete trip folder list window 4200.

Folder format button 4106, causes the information in the trip database 108 to appear in folder format, as in the managed trip folder list window 4100. Task format button 4108, causes the information in the trip database 108 to appear in task format, as in the trip task list window 4300. Trip setup button 4110, initiates the entry of a new trip by opening new trip setup window 4400 and list of services window 4500. Open trip button 4112, permits the user to see details of trips by opening the trip leg list window 4600, the departure task window 4700A, and the arrival task window 4700B.

The managed trip folder list window 4100, along with the other display windows, also have various function buttons that give the user simplified access to frequently needed information or functions. Trip phone call button 4114, provides the user with a list of phone calls associated with a particular trip. Trip notes button 4116, provides the user with a list of notes associated with a particular trip.

Trip exceptions button 4118, causes the review of selected trips and the generation of an exception listing. An exception listing is a listing of items the FMS 100 anticipates in a complete and error-free trip folder. Trip revisions button 4120 causes the review of selected trips and the generation of a revisions review listing. A revisions review listing is a listing of items that differ from one version of a trip folder to the next.

Merge trip button 4122, opens the merge window 5400. The merge window 5400 permits the user to combine duplicate trips, designate newly entered trips as revisions of previously existing trips, and add trip legs to an existing trip. Exit button 4124 closes the managed trip folder list window 4100, and takes the user of the FMP 2200 to the main menu 2400, at 2208.

Checking the client-managed intra-state trip indicator 4104 opens the complete trip folder list window 4200. The complete trip folder list window 4200 has the same visual components as the managed trip folder list window 4100, except the information display fields 4202 replaces information display fields 4102, and includes information on all current trips, including trips managed by both the FM operator 112 and the client 114, organized in the fields of trip database 108. The complete trip folder list window 4200 may also comprise a column of K-K Trip radio buttons 4226 in place of the K-K Trip radio buttons 4126. Buttons and indicators on the complete trip folder list window 4200 with the same or similar name and the same or similar reference numbers to buttons and indicators on the managed trip folder list window 4100 have similar function.

Task format button 4108, causes the information in the trip database 108 to appear in task format, as in the trip task list window 4300. Window 4300 includes information display fields 4302 and information sort buttons 4304. Buttons and indicators on the trip task list window 4300 with the same name and similar reference numbers to buttons and indicators on the managed trip folder list window 4100 have similar function. Information sort buttons 4304 permit the user of the FMP 2200 to manipulate the information displayed in information display fields 4302. Departure information fields 4318 show the location, date and time each departure task will/did occur. Arrival information fields 4320 show the location, date and time each arrival task will/did occur.

The FMS 100 permits the FM operator 112 to create a new trip folder for the client 114. In an exemplary embodiment, the user clicks on the current trips button 2404, at 2212, opening the managed trip folder list window 4100. If the user is not the client 112, the user reviews the trip instructions received from the client 114 through the user interface 102a, to determine whether the trip folder is to be created by the client 114 or the FM operator 112, at 22148. If the FM operator 112 is to create the folder in trip database 108, the FM operator 112 must next determine if the request is for a new trip, at 22150. If a new trip is requested, the FM operator 112 clicks trip setup button 4110 to open new trip setup window 4400 and list of services window 4500, at 22152.

The new trip setup window 4400 includes a information display fields 4402, an auto create legs button 4404, a domestic flight check box 4406, and action buttons 4408, one of which is an exit button 4410. List of services window 4500 includes information display fields 4502, departure services checkboxes 4504, and arrival services checkboxes 4506. Information display fields 4402 are fields for receiving information necessary to establish all the legs and the respective services for a trip. The information entered into information display fields 4402 is coordinated for appropriate storage in corresponding fields and tables of trip database 108. The information entered into information display fields 4402, in conjunction with preferences stored in support database 106, permit FMS 100 to assign any information necessary for a complete trip folder, but not specified in the information display fields 4402, upon the user clicking the auto create legs button 4404. Upon creating the complete trip folder, by clicking the auto create legs button 4404 the user closes both the new trip setup window 4400 and list of services window 4500.

Then at 22154, the user reviews the trip folder completed by the FMS 100. In an exemplary embodiment, the user at 22154 may be the FM operator 112 or the client 114, including an agent of the client 114. Reviewing activities at 22154 is illustrated through a collection of screens that display the details of the trip folder in a sequence, including a trip leg list window 4600, a departure task window 4700A, an arrival task window 4700B, a ground handling details window 4800, a documents window 4900, a communications classic view window 5000A, a communications pivot view window 5000B, a trip message window 5100, a hotel details window 5200, a ground handler agent details window 5300, a merge window 5400, a trip exceptions window 5500, and a revision comparison window 5600.

The trip leg list window 4600 includes information display fields 4602, information tabs 4604, and action buttons 4606, which include exit button 4608. The departure task window 4700A includes an information display field 4702A, an assign due dates button 4704A, a notes button 4706A, a documents button 4708A, a communications button 4710A, a messages button 4712A, a hotel setup button 4714A, a ground handler agent button 4716A, a fuel supplier button 4718A, and an exit button 4720A. The arrival task window 4700B includes an information display field 4702B, an assign due dates button 4704B, a notes button 4706B, a documents button 4708B, a communications button 4710B, a messages button 4712B, a hotel setup button 4714B, a ground handler agent button 4716B, a fuel supplier 4718B, and an exit button 4720B.

The ground handling details window 4800 includes information display fields 4802, create ground handling notes button 4804, and action buttons 4806, which include exit button 4808. The documents window 4900 includes information display fields 4902, information buttons 4904, and action buttons 4906, which include exit button 4908. The communications classic view window 5000A includes information display fields 5002A, data display modifier buttons 5004A, pivot view button 5006A, and action buttons 5008A, which include exit button 5010A. The communications pivot view window 5000B includes information display fields 5002B, data display modifier buttons 5004B, classic view button 5006B, data filter buttons 5008B, and action buttons 5010B, which include exit button 5012B.

The trip message window 5100 includes information display fields 5102, and action buttons 5104, which include exit button 5106. The hotel details window 5200 includes information display fields 5202, and action buttons 5204, which include exit button 5206. The ground handler agent details window 5300 includes information display field 5302, and action buttons 5304, which include exit button 5306. The merge window 5400 includes information display fields 5402, import legs button 5404, make version 1 button 5406, merge trip button 5408, and cancel and exit button 5410.

The trip exceptions window 5500 includes information display field 5502, and action buttons 5504, which include exit button 5506. The revision comparison window 5600 includes information display field 5602, and action buttons 5604, which include exit button 5606.

The review, at 22154, includes a review and, if necessary, modification of the trip legs, at 22156, as seen in the trip leg list window 4600. The review, at 22154, includes a review and, if necessary, modification of the departure tasks, at 22158, as seen in the departure task window 4700A. The review, at 22154, includes a review and, if necessary, modification of the arrival tasks, at 22160, as seen in the arrival task window 4700B. The review, at 22154, includes a review and, if necessary, modification of the ground handling details, at 22162, as seen in the ground handling details window 4800. The review, at 22154, includes a review and, if necessary, modification of the documents, at 22164, as seen in the documents window 4900. The review, at 22154, includes a review and, if necessary, modification of the communications details, at 22166, as seen in the communications classic view window 5000A and the communications pivot view window 5000B. The review, at 22154, includes a review and, if necessary, modification of the trip messages, at 22168, as seen in the trip message window 5100. The review, at 22154, includes a review and, if necessary, modification of the hotel details, at 22170, as seen in the hotel details window 5200. The review, at 22154, includes a review and, if necessary, modification of the ground handler agent details, at 22172, as seen in the ground handler agent details window 5300. The review, at 22154, includes a review and/or modification of the general trip notes accessible from departure task window 4700A and arrival task window 4700B by activating notes button 4706A and 4706B, respectively, at 22174. The review, at 22154, includes a review and, if necessary, modification of duplicate or related trips and trip legs, at 22176, as seen in the merge window 5400.

The view, at 22154, includes a final review, at 22178 which may comprise a review and, if necessary, modification of the trip exceptions, at 22180, as seen in the trip exceptions window 5500. The user initiates the exceptions review by clicking on the exceptions button 4118. The final review, at 22178, also includes a review and, if necessary, modification of the revisions, at 22182, as seen in the revision comparison window 5600. The user initiates the revisions review by clicking on the revisions button 4120. After completing the final review, at 22178, the review, at 22154, is complete. The user then exits the review, at 22154, by clicking exit button 5606, at 22184, to the main menu 2400, at 2208.

The FMS 100 permits the FM operator 112 to modify an existing trip folder for the client 114. If the request is not for a new trip the FM operator 112 opens an existing trip, at 22186, by selecting the trip from the information display window 4102 and clicking the open trip button 4112. Clicking the open trip button 4112, at 22186, opens the trip leg list window 4600, the departure task window 4700A, and the arrival task window 4700B.

After FM operator 112 makes the requested modifications, at 22188, the FM operator 112 initiates the final review of the trip folder, at 22178. After completing the final review the user then exits the review, at 22184, by clicking exit button 5606, to the main menu 2400, at 2208.

If the user of FMP 2200 is the client 114, at 22148, which may include the client's agent, it is understood that client 114 is to create the trip folder. In an exemplary embodiment, if the user is the client 114, at 22190, the client may choose to use third-party software to prepare a trip. In an exemplary embodiment, if the client 114 chooses to manipulate their own folder in trip database 108, the client 114 may further choose to create a new trip, at 22192. If client 114 is not creating a new trip the client 114 opens an existing trip, at 22194, by selecting the trip from the information display window 4102 and clicking the open trip button 4112. Clicking the open trip button 4112, at 22194, opens the trip leg list window 4600, the departure task window 4700A, and the arrival task window 4700B, and functions similarly to that described above.

After the client 114 makes the requested modifications, at 22196, the client 114, as the user of the FMP 2200, initiates the final review of the trip folder, at 22178. After completing the final review the user then exits the review, at 22184, by clicking exit button 5606, to the main menu 2400, at 2208.

If client 114 is creating a new trip, at 22192, the client 114 clicks trip setup button 4110 to open new trip setup window 4400 and list of services window 4500, at 22198. Then at 22154, the user of FMP 2200 reviews each of the trip elements offered by the FMS 100 as in an interview format, entering the client's 114 trip requirements that the FMS 100 will maintain and coordinate for support.

In an exemplary embodiment, if the client 114 chooses to use third-party software to create the folder in trip database 108, at 22190, the client 114 uploads the trip from the third-party software at 22200. The FMS 100 generates a confirmation receipt 5700, at 22202, which repeats the trip information received by FMS 100. Then at 22204, an audit is completed to determine whether the information is complete enough to create a trip folder. Then at 22206, the information is assessed to determine if the request is for a new trip.

If the request is not for a new trip, the user of the FMP 2200 may merge the new trip information into the prior trip, at 22208, by opening the merge window 5400, and clicking on the merge trip button 4122. Information about the requested trip and the prior trip are entered into information display fields 5402. Clicking on the merge trip button 5408 completes the merger, archives the prior trip, and saves the new information into trip database 108 as a more recent revision. Clicking on the cancel and exit button 5410 closes the merge window 5400.

The user of the FMP 2200 then initiates a final review, at 22178. After completing the final review the user then exits the review, at 22184, by clicking exit button 5606, to the main menu 2400, at 2208.

If the request is for a new trip, at 22206, the user must check the client-managed intra-state trip indicator 4104 to view the trip in the information display fields 4102. If the request if for a client managed trip, at 22210, the FM operator 112 will not interfere with the client's 114 use of the FMS 100. The FMP 2200 will offer the results of the final review, at 22178, to the client 114. The user then exits the review, at 22184, by clicking exit button 5606, to the main menu 2400, at 2208.

At any time, however, if a client 114 requests assistance from the FM operator 112, the FM operator 112 can view and access the contents of the trip folder. In an exemplary embodiment, client-managed intra-state trips are identified in trip folder list window 4200 by being marked in the column of K-K Trip radio buttons 4226. In an exemplary embodiment, the intra-state trips are also distinguished by being shadowed in the color gray. When the FM operator 112 assumes management of the client's 114 trip, the FM operator 112 accesses the trip folder list window 4200 and un-marks the specific K-K Trip radio buttons 4226 for the particular trip. In an exemplary embodiment, when a trip is no longer identified as an intra-state trip, thereby restricting the client 114 from being able to access the specific trip folder, in order to protect the integrity of the data in the folder. In an exemplary embodiment, the procedure may be reversed, where the client 114 may regain operational control of an intra-state trip. The FM operator 112 may further have the authority to un-check and/or check specific K-K Trip radio buttons 4226.

The FM operator 112 will then initiate a review, at 22154, of the trip folder. After completing the final review, at 22178, the review, at 22154, is complete. The FM operator 112, as the user of the FMP 2200, then exits the review, at 22154, by clicking exit button 5606, to the main menu 2400, at 2208.

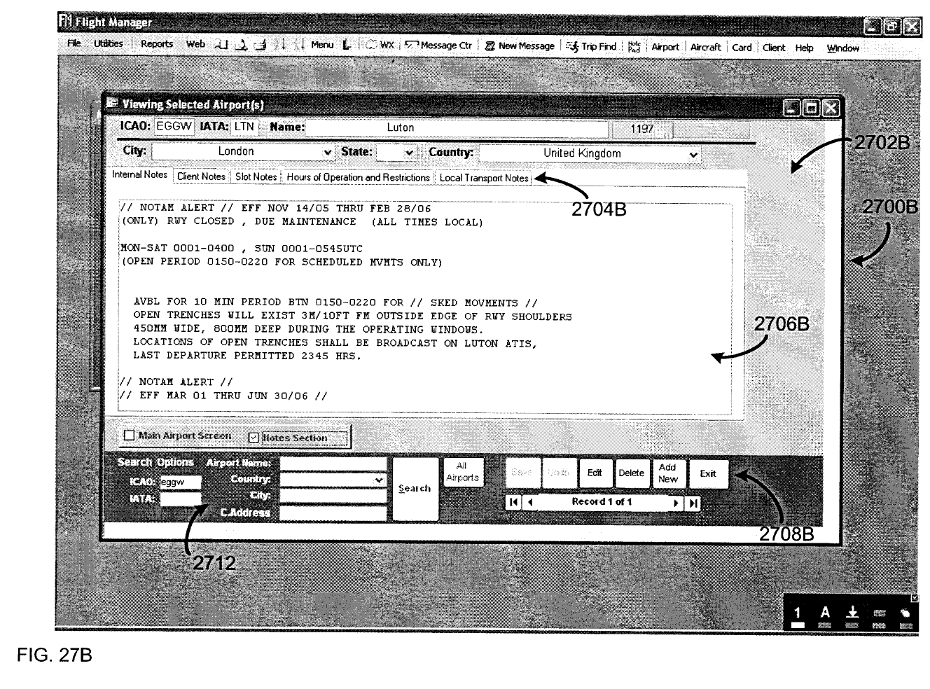

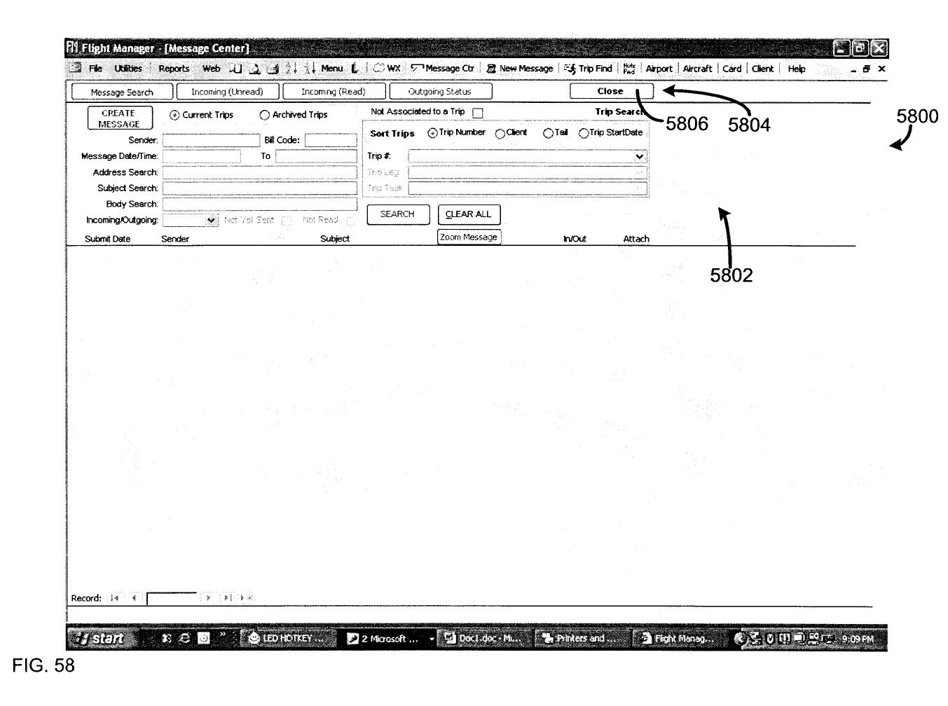

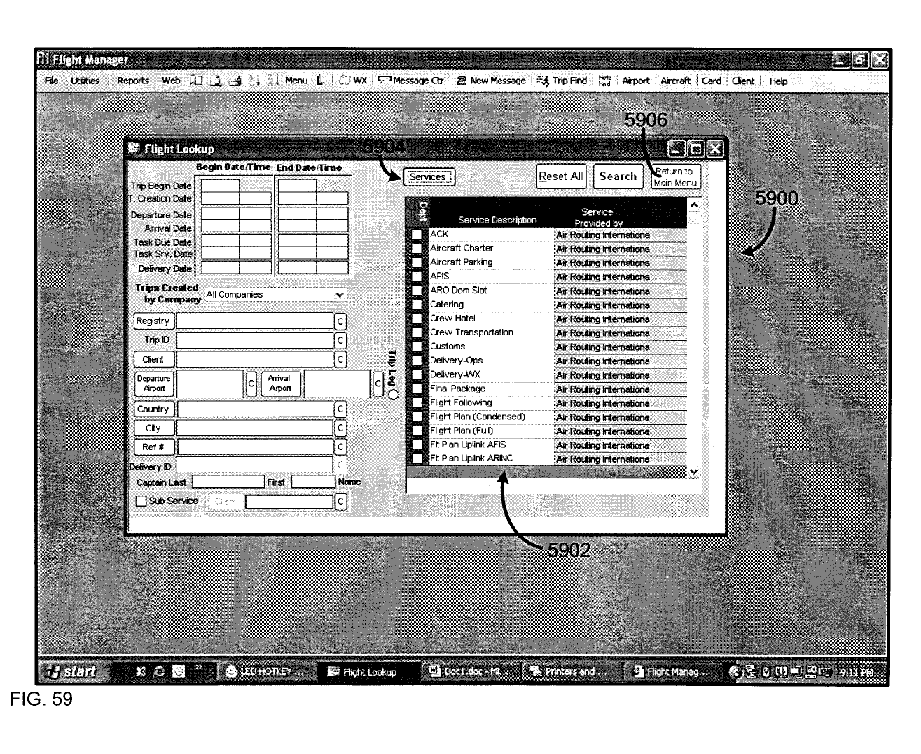

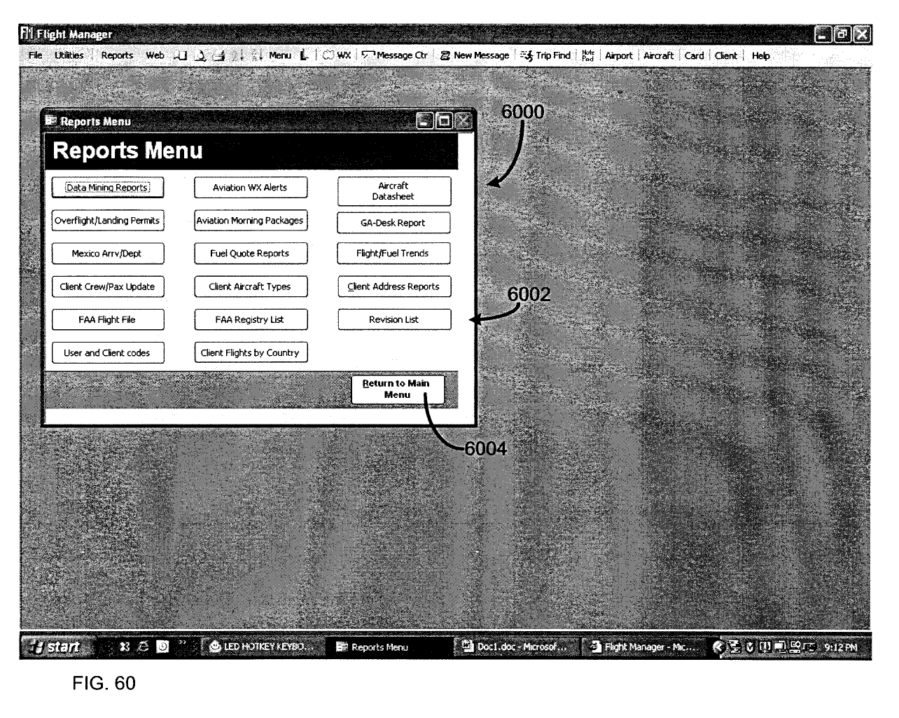

Referring now to FIGS. 1-3, 22A, 24, and 58-60, the user of FMP 2200 may choose to perform messaging activities, at 2214, to allow the user of FMP 2200 to communicate, at 22294, with other parties interested in the trip. In an exemplary embodiment, communication may include actions to contact parties related to a trip, archive contact made to or between parties related to a trip, and review contacts made with parties related to a trip. Selecting to conduct messaging by clicking on the messaging button 2406, at 2214, the user gains access to the information within support database 106 and trip database 108, relating to trip messages.

The message information from support database 106 and trip database 108 is illustrated through messaging window 5800. Messaging window 5800 includes information display field 5802, and a variety of action buttons 5804, which include a close button 5806. The information display field 5802 displays information relating to selected messages. The variety of action buttons 5804 relate to selected message information as indicated by the associated label or icon, including the close button 5806, which closes the messaging window 5800, and redirects the FMP 2200, at 22296, to the main menu 2400, at 2208.

The user of FMP 2200 may choose to perform flight lookup activities, at 2216, allowing to search a particular flight, at 22298, within trip database 108. Selecting the flight lookup activities, at 2216, by clicking on the flight lookup button 2408, the user opens a flight lookup window 5900, which provides access to the information within trip database 108 and includes an information display field 5902, and a variety of action buttons 5904, including a return to main menu button 5906. The information display field 5902 accepts information relating to a desired flight. The action buttons 5904 related to selected flight lookup activity as indicated by the associated label or icon, including the return to main menu button 5906, which closes the flight lookup window 5900, and redirects the FMP 2200, at 22296, to the main menu 2400, at 2208.

The user of FMP 2200 may choose to conduct reports activity, at 2218, which allows the user to produce a variety of standard reports, at 22302, based on the information within trip database 108. Selecting the reports activity, at 2218, by clicking on the reports button 2410 opens a reports menu window 6000, which is a GUI menu that provides access to standard reports and includes a report buttons display fields 6002, and a return to main menu button 6004. The reports buttons display fields 6002 displays an assortment of GUI report buttons, each able to initiate a specific report. The return to main menu button 6004 closes the reports menu window 6000, and redirects the FMP 2200, at 22304, to the main menu 2400, at 2208.

The user of FMP 2200 may choose to conduct schedules activity, at 2220, allowing the user to find and review flight schedules, at 22306, based on the information within trip database 108. Selecting the reports activity, at 2218, by clicking on the schedules button 2412, the user opens a flight lookup window 5900, which provides access to searchable information within trip database 108. The FMP 2200 closes schedules activity, at 22308, and returns to the main menu 2400, at 2208.

Referring now to FIGS. 1-4, 22A, B, D, and G, 24, and 61-72, in an exemplary embodiment, the user of FMP 2200 may choose to modify fuel activity, at 2222, allowing the user to perform a variety of standard fuel inquiries, using the information within trip database 108. Selecting the fuel activity, at 2222, by clicking on the fuel button 2414, the user opens a fuel window 6100, which is a GUI menu that provides access to standard inquiries and includes a fuel inquiry selection field 6102, an open selection button 6104, and an exit button 6106. The fuel inquiry selection field 6102 displays an assortment of selection buttons operable to be marked in order to indicate a request for the associated inquiry. The open selection button 6104 opens a page for the corresponding selection button inquiry marked in the inquiry selection field 6102. The exit button 6106 closes the fuel window 6100, and redirects the FMP 2200 to the main menu 2400, at 2208.

In an exemplary embodiment, the assortment of selection buttons in the fuel inquiry selection field 6102 may include a fuel prices lookup button 6108, a fuel prices data entry button 6110, a request status button 6112, an old fuel quotes button 6114, a taxes and fees button 6116, a client markups button 6118, a commissions button 6120, a fuel scale button 6122, a fuel posted prices button 6124, a fuel agents quick edit button 6126, a vendor providers button 6128, an activate fuel countries button 6130, and an AirFuel website button 6132. In an exemplary embodiment, at 22212, the user of the FMP 2200 selects a button from the fuel inquiry selection field 6102 and then activates the respective activity by clicking on the open selection button 6104. In an exemplary embodiment, activating the open selection button 6104 may cause the FMP 2200 to limit the information regarding a specific client. In an exemplary embodiment, fuel client selection window 6134 may open requiring the user of the FMP 2200 to enter the client name and company for whom the information pertains.

In an exemplary embodiment, if the user selects the fuel prices lookup button 6108 and enters the selected client in the fuel client selection window 6134, at 22214, then at 22216, a fuel price lookup window 6200 opens to provide the user of the FMP 2200 access to the respective data displayed in fuel price data field 6202. In an exemplary embodiment, the fuel information shown to the client is compiled and calculated based on information held in the airport table 404, the client table 410, and the vendor providers table 426. Clicking the appropriate action button 6204 closes the fuel price lookup window 6200, at 22218, and saves adjustments that may have been permitted. In an exemplary embodiment, this returns the user of FMP 2200 to the fuel window 6100, at 22212.

In an exemplary embodiment, if the user selects the fuel prices data entry button 6110 and enters the selected client in the fuel client selection window 6134, at 22220, then at 22222, a fuel price entry window 6300 opens to provide the user access to the respective data displayed in fuel price entry fields 6302. Clicking the appropriate action button 6304 closes the fuel price entry window 6300, at 22224, and saves adjustments that may have been permitted. In an exemplary embodiment, this returns the user of FMP 2200 to the fuel window 6100, at 22212.

In an exemplary embodiment, if the user selects the request status button 6112 and enters the selected client in the fuel client selection window 6134, at 22226, then at 22228, a fuel request status window 6400 opens to provide the user access to the respective data displayed in fuel request status field 6402. Clicking the appropriate action button 6404 closes the fuel request status window 6400, at 22230, and saves entries that may have been made. In an exemplary embodiment, this returns the user of FMP 2200 to the fuel window 6100, at 22212.

In an exemplary embodiment, the user may obtain additional details on the entries in fuel request fields 6402 by opening the desired entry. In an exemplary embodiment, the desired entry may be opened by double-clicking on the entry or by selecting the entry and clicking the appropriate action button 6404 to view the details. In an exemplary embodiment, opening the desired entry may open fuel request detail window 6500, which displays details of the request in the fuel request detail field 6502. In an exemplary embodiment, details on the pricing of the quote may be obtained by clicking the fuel arrangement button 6504, which may open fuel quote detail window 6600A or alternate fuel quote detail window 6600B. In an exemplary embodiment, the information presented in fuel quote detail field 6602A includes a single price for fuel. In an alternate exemplary embodiment, the information presented in fuel quote detail fields 6602B includes a scaled price for fuel, dependent on the quantity of fuel purchased. Clicking on the appropriate action button 6604A or 6604B closes the fuel quote detail window 6600A or 6600B, respectively, and saves adjustments that may have been permitted. In an exemplary embodiment, clicking on the close window button 6506 closes the fuel request detail window 6500, and saves adjustments that may have been permitted. Then, as described above, clicking on the appropriate action button 6404 closes the fuel request status window 6400, at 22230, and saves entries that may have been made. In an exemplary embodiment, this returns the user to the fuel window 6100, at 22212.

In an exemplary embodiment, if the user selects the old fuel quotes button 6114 and enters the selected client in the fuel client selection window 6134, a window similar to the fuel price lookup window 6200 may open to display information regarding historical quotes. Such a window may have an appropriate action button 6204 that closes the historical quote information window, and returns the user to the fuel window 6100, at 22212.

In an exemplary embodiment, if the user selects the taxes and fees button 6116 and enters the selected client in the fuel client selection window 6134, at 22238, then at 22240, a taxes and fees window 6700 may open to provide the user access to the respective data displayed in a taxes and fees field 6702. Clicking on the appropriate action button 6704 closes the taxes and fees window 6700, at 22242, and saves adjustments that may have been permitted. In an exemplary embodiment, this returns the user to the fuel window 6100, at 22212.

In an exemplary embodiment, if the user selects the client markups button 6118 and enters the selected client in the fuel client selection window 6134, at 22244, then at 22246, a fuel client markup window 6800 may open to provide the user access to the respective data displayed in fuel client markup field 6802. Clicking on the appropriate action button 6804 closes the fuel client markup window 6800, at 22248, and saves adjustments that may have been permitted. In an exemplary embodiment, this returns the user of FMP 2200 to the fuel window 6100, at 22212.

In an exemplary embodiment, if the user selects the commissions button 6120 and enters the selected client in the fuel client selection window 6134, at 22250, then at 22252, a commissions window (not illustrated) may open to provide the user access to the respective data regarding commissions either or both due and owed on the client's trips. Clicking on an appropriate action button closes the commissions window, at 22254, and saves adjustments that may have been permitted. In an exemplary embodiment, this returns the user to the fuel window 6100, at 22212.

In an exemplary embodiment, if the user selects the fuel scale button 6122 and enters the selected client in the fuel client selection window 6134, at 22256, then at 22258, a fuel scale window (not illustrated) may open to provide the user access to the respective data regarding the scaled price of fuel scale and the varied quantities at which the scaled pricing may be effective. Clicking on an appropriate action button closes the fuel scale window, at 22260, and saves adjustments that may have been permitted. In an exemplary embodiment, this returns the user to the fuel window 6100, at 22212.

In an exemplary embodiment, if the user selects the fuel posted prices button 6124 and designates an airport, at 22262, then at 22264, a fuel posted prices window (not illustrated) may open to provide the user access to the respective posted fuel prices for the designated airport. The information that will be shown may be customized for the particular user and the particular country in which the airport is located. Clicking on an appropriate action button closes the fuel posted prices window, at 22266, and saves adjustments that may have been permitted. In an exemplary embodiment, this returns the user of FMP 2200 to the fuel window 6100, at 22212.

In an exemplary embodiment, if the user selects the fuel agents quick edit button 6126 and enters the selected client in the fuel client selection window 6134, at 22268, then at 22270, a fuel vendor quick edit window 6900 may open to provide the user access to the respective data displayed in fuel vendor quick edit field 6902. In an exemplary embodiment, the fuel vendor quick edit field 6902 permits the user to set preferred and alternately preferred vendors for each service. Clicking on the appropriate action button 6904 closes the fuel vendor quick edit window 6900, at 22272, and saves adjustments that may have been permitted. In an exemplary embodiment, this returns the user to the fuel window 6100, at 22212.

In an exemplary embodiment, if the user selects the vendor providers button 6128 and enters the selected client in the fuel client selection window 6134, at 22274, then at 22276, a vendor providers main screen 3800A may open to provide the user access to the respective data regarding vendor providers from the vendor provider table 426, as described above at 2256. Clicking on an appropriate action button may close the vendor provider window, at 22278, and saves adjustments that may have been permitted. In an exemplary embodiment, this returns the user of FMP 2200 to the fuel window 6100, at 22212.

In an exemplary embodiment, if the user selects the country fuel activation button 6130 and enters the selected client in the fuel client selection window 6134, at 22280, then at 22282, a country fuel activation window 7000 may open to provide the user access to the respective data displayed in country fuel activation field 7002. Clicking on the appropriate action button 7004 closes the country fuel activation window 7000, at 22284, and saves adjustments that may have been permitted. In an exemplary embodiment, this returns the user of FMP 2200 to the fuel window 6100, at 22212.

In an exemplary embodiment, if the user selects the AirFuel website button 6132 and enters the selected client in the fuel client selection window 6134 a client view emulation entry window 7100, at 22286, then opens. In an exemplary embodiment, client view emulation entry window 7100 provides the user access to the respective client's fuel price data in a format that emulates how the data may be displayed to the client entering the system through user interface 102b, such as from the Internet. In an exemplary embodiment, client view emulation entry window 7100 has an entry field 7102, a get price button 7104, and action buttons 7106. In an exemplary embodiment, the user enters the desired fueling location in entry field 7102 and actuates the get price button 7104 to access to the respective fuel price data, in client view emulation information window 7200, for the chosen client, at 22288.

In an exemplary embodiment, client view emulation information window 7200 includes entry field 7202, get price button 7204, print quote button 7206, quote details field 7208, select quote box 7210, order fuel button 7212, and action buttons 7214. In an exemplary embodiment, entering a refueling location in entry field 7202 and actuating get price button 7204 may result in a price quote meeting the chosen parameters being shown in quote details field 7208. In an exemplary embodiment, the user may order fuel at the quoted location and price by clicking on the select quote box 7210 and clicking the order fuel button 7212. The user may then print the quote shown in the quote details field 7208 by clicking print quote button 7206. Clicking on the appropriate action button 7214 closes the client view emulation information window 7200, at 22290. In an exemplary embodiment, this returns the user to the fuel window 6100, at 22212.

In an exemplary embodiment, if the user of the FMP 2200 selects the exit button 6106, at 22292, the FMP 2200 returns to the main menu screen 2400, at 2208.

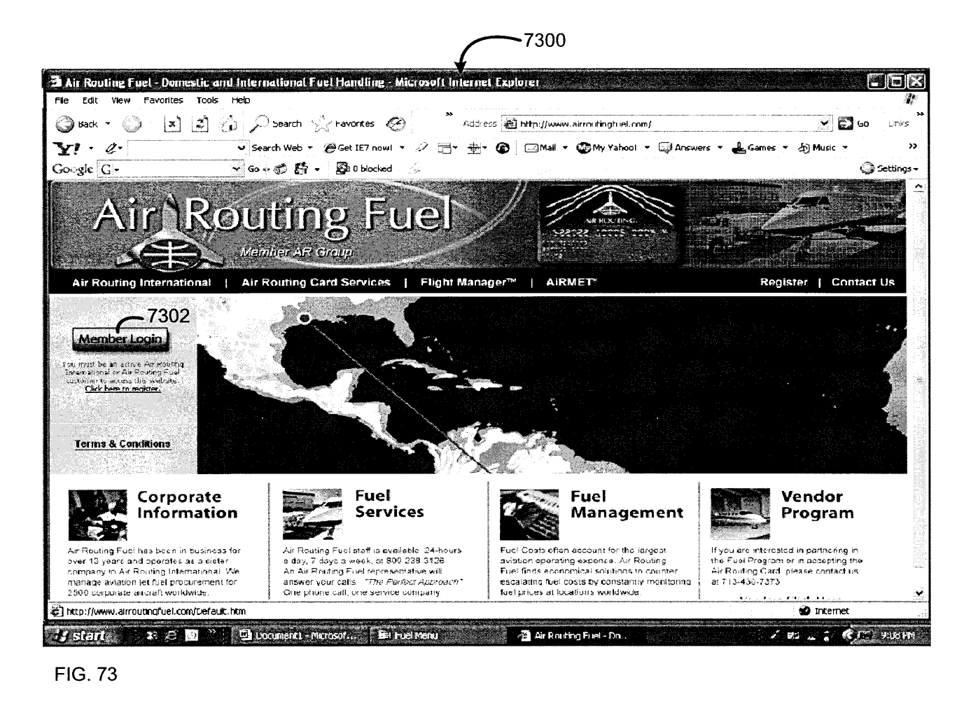

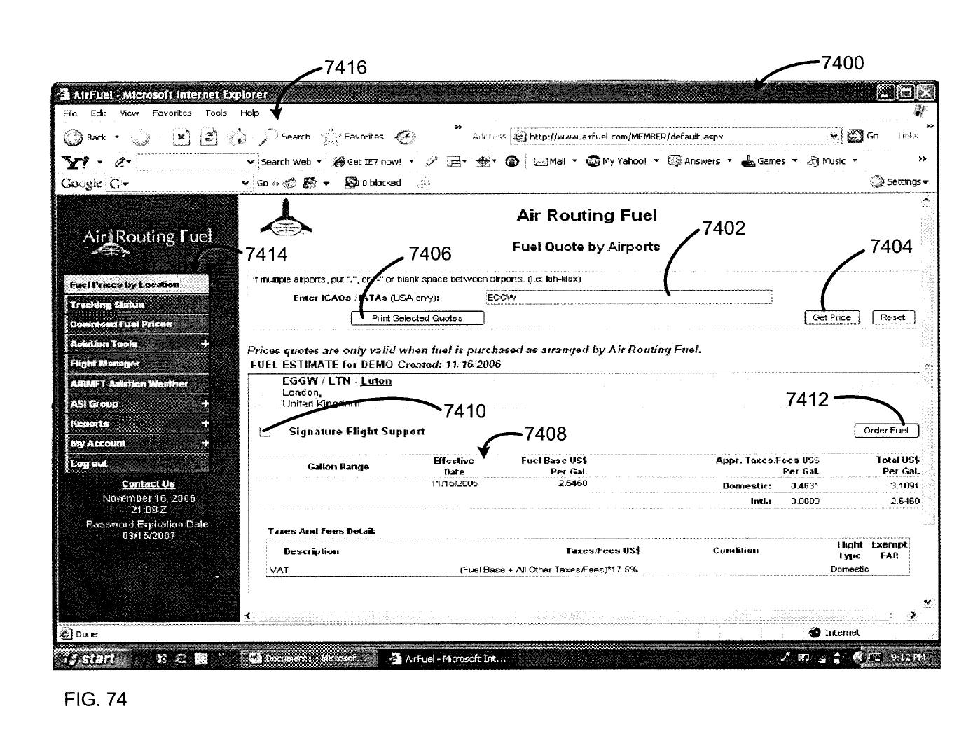

Referring now to FIGS. 1, 22A, 22G, 73, and 74, in an exemplary embodiment, the client may access data from the trip database 108 via an external computer network such as the World Wide Web. In an exemplary embodiment, entry of a specific domain name, e.g., www.airfuel.com, into a web browser may route the client of FMP 2200 to a client web-view entry window 7300, which may have a member login button 7302 that initiates a sign-in procedure. In an exemplary embodiment, navigating the external network permits the user to go directly to accessing the AirFuel web-site, at 22286. In an exemplary embodiment, the sign-in procedures may be similar to the login procedure, at 2204, and the verification and setup user procedure, at 2206, as described above.

In an exemplary embodiment, successful sign-in may provide the user with access to a client web-view information window 7400, at 22288, which may be similar to the client view emulation information window 7200. In an exemplary embodiment, the client web-view information window 7400 may include an entry field 7402, get price button 7404, print quote button 7406, quote details field 7408, select quote box 7410, order fuel button 7412, web page link buttons 7414, and web browser function GUI's 7416. In an exemplary embodiment, entering a refueling location in entry field 7402 and actuating get price button 7404 may result in a price quote meeting the chosen parameters being shown in quote details field 7408. In an exemplary embodiment, the user may order fuel at the quoted location and price by clicking on the select quote box 7410 and clicking the order fuel button 7412. The user may print the quote shown in quote details field 4708 by clicking print quote button 7406. In an exemplary embodiment, selecting a web page link button 7414 may take the user to web pages that may or may not have access to the trip database 108. Clicking on the appropriate web browser function GUI's 7416 closes the client web-view information window 7400, at 22290.

One exemplary embodiment of the invention may provide a system for planning and managing at least one air travel trip, wherein the system includes a trip database configured to organize data related to at least one air travel trip; a support database configured to organize data related to at least one support function configured to support air travel; a data engine operatively coupled to the trip database and the support database, configured to jointly manipulate data held in each of the trip database and support database; and a user interface operatively coupled with the data engine, the trip database and the support database, configured to provide access to a user of the system to data held in the trip database and support database. The trip database may further include at least one table configured to organize tasks related to at least one air travel trip, and the support database may include at least one data table configured to consolidate like data in order to reduce redundancy of data held in the support database. Additionally, the data engine may further include a table engine configured to organize and access related data held in distinct tables; an auto-fill engine configured to identify and fill missing trip data based on rules and preferences established in the support database; an audit engine configured to identify missing information from trip data held in distinct tables; and an archive engine configured to archive trip data as the data is added and modified. The data engine may provide access to data from more than one table of either or both trip database and support database to dynamically integrate the planning, coordination, and trip managing arrangements in the form of output information on one air travel trip, and the user interface may further include an access engine configured to provide multiple users access, in accordance with each user's access authorities, from multiple locations, by multiple communication links, to the air travel trip data. The user interface may also further include an input/output (I/O) engine configured to control the flow of air travel trip data between the system and multiple users, in accordance with each user's access authorities, from multiple locations, by multiple communication links.

The system may further include an operational center configured to house the system within a controlled area; an operator having access to the controlled area; and the user interface accessible from either or both within and outside the controlled area. The system may further include an embodiment where the user interface provides access to the trip database, the support database, and data engine in order to electively plan, manage, and execute a trip entirely from outside the controlled area. Additionally, the user interface may further include an access engine configured to provide multiple users access, in accordance with each user's access authorities, from multiple locations, by multiple communication links, to the air travel trip data. The user interface of the operational center may further include an input/output (I/O) engine configured to control the flow of air travel trip data between the system and multiple users, in accordance with each user's access authorities, from multiple locations, by multiple communication links.

Another exemplary embodiment of the invention provides a method for planning and managing at least one air travel trip, including creating a trip database configured to organize data related to at least one air travel trip within distinct fields and tables; creating a support database configured to organize data related to at least one support function configured to support air travel in distinct tables; manipulating the data held in each of the trip database and support database jointly with a data engine operatively coupled to the trip database and the support database so as to dynamically integrate the planning, coordination, and trip managing arrangements in the form of output information on one air travel trip; and providing access to a user of the system to the data held in each of the trip database and support database through a user interface operatively coupled with the data engine, the trip database and the support database to allow the user to either supply or receive information on at least one air travel trip in real-time.

The method may further include consolidating like data in distinct tables in order to reduce redundancy of data held in the support database, or identifying and filling missing trip data based on rules and preferences established in the support database with an auto-fill engine, or identifying missing information from trip data held in distinct tables with an audit engine. The method may further include archiving trip data as the data is added and modified with an archive engine, or providing access to data from more than one table of either or both trip database and support database to output information on an air travel trip with the data engine, or providing access configured to multiple users, in accordance with each user's access authorities, from multiple locations, by multiple communication links, to the air travel trip data with an access engine, or controlling the flow of air travel trip data between the system and multiple users, in accordance with each user's access authorities, from multiple locations, by multiple communication links with an I/O engine. The method may further include housing the system within a controlled area of an operational center; providing access to the controlled area to an operator; and providing access to the user interface from either or both within and outside the controlled area, or providing access to the trip database, the support database, and data engine in order to selectively plan, manage, and execute a trip entirely from outside the controlled area, through the user interface.

One of ordinary skill in the art will recognize that the above-noted method may be practiced as a method of doing business.

Another exemplary embodiment of the invention generally provides system for planning and managing at least one air travel trip, including: means for creating a trip database for organizing data related to at least one air travel trip within distinct tables; means for creating a support database for organizing data related to at least one support function for supporting air travel in distinct tables; means for manipulating data held in each of the trip database and support database jointly with a data engine operatively coupled to the trip database and the support database; and means for providing access to a user of the system to the data held in each of the trip database and support database through a user interface operatively coupled with the data engine, the trip database and the support database.

The exemplary system noted above may further include means for consolidating like data in distinct tables in order to reduce redundancy of data held in the support database, and/or means for identifying and filling missing trip data based on rules and preferences established in the support database with an auto-fill engine, and/or means for identifying missing information from trip data held in distinct tables with an audit engine. The exemplary system may further include means for archiving trip data as the data is added and modified with an archive engine, and/or means for providing access to data from more than one table of either or both trip database and support database to output information on one air travel trip with the data engine, and/or means for providing access for multiple users, in accordance with each user's access authorities, from multiple locations, by multiple communication links, to the air travel trip data with an access engine. The system may further include means for controlling the flow of air travel trip data between the system and multiple users, in accordance with each user's access authorities, from multiple locations, by multiple communication links with an I/O engine, and/or means for housing the system within a controlled area of an operational center; means for providing access to the controlled area to an operator; and means for providing access to the user interface from either or both within and outside the controlled area, and/or means for providing access to the trip database, the support database and data engine in order to electively plan, manage and execute a trip entirely from outside the controlled area, through the user interface.

In another exemplary embodiment of the invention, a computer program embodied on a computer readable medium that is configured to control a method for planning and managing at least one air travel trip is provided. The method controlled by the program includes creating a trip database for organizing data related to at least one air travel trip within distinct tables; creating a support database for organizing data related to at least one support function for supporting air travel in distinct tables; manipulating data held in each of the trip database and support database jointly with a data engine operatively coupled to the trip database and the support database; and providing access to a user of the system to the data held in each of the trip database and support database through a user interface operatively coupled with the data engine, the trip database and the support database. The method further includes consolidating like data in distinct tables in order to reduce redundancy of data held in the support database, and/or identifying and filling missing trip data based on rules and preferences established in the support database with an auto-fill engine, and/or identifying missing information from trip data held in distinct tables with an audit engine, and/or archiving trip data as the data is added and modified with an archive engine. The computer program may further include providing access to data from more than one table of either or both trip database and support database to output information on one air travel trip with the data engine, providing access for multiple users, in accordance with each user's access authorities, from multiple locations, by multiple communication links, to the air travel trip data with an access engine, controlling the flow of air travel trip data between the system and multiple users, in accordance with each user's access authorities, from multiple locations, by multiple communication links with an I/O engine, and/or housing the system within a controlled area of an operational center, providing access to the controlled area to an operator; and providing access to the user interface from either or both within and outside the controlled area.

The exemplary computer program may further include providing access to the trip database, the support database and data engine in order to electively plan, manage and execute a trip entirely from outside the controlled area, through the user interface, consolidating like data in distinct tables in order to reduce redundancy of data held in the support database, identifying and filling missing trip data based on rules and preferences established in the support database with an auto-fill engine, and/or identifying missing information from trip data held in distinct tables with an audit engine. The computer program may further include archiving trip data as the data is added and modified with an archive engine, providing access to data from more than one table of either or both trip database and support database to output information on one air travel trip with the data engine, providing access for multiple users, in accordance with each user's access authorities, from multiple locations, by multiple communication links, to the air travel trip data with an access engine, controlling the flow of air travel trip data between the system and multiple users, in accordance with each user's access authorities, from multiple locations, by multiple communication links with an input/output (I/O) engine, and/or housing the system within a controlled area of an operational center, providing access to the controlled area to an operator; and providing access to the user interface from either or both within and outside the controlled area. The exemplary computer program may further include providing access to the trip database, the support database and data engine in order to selectively plan, manage and execute a trip entirely from outside the controlled area, through the user interface,

Another exemplary embodiment of the invention generally provides a support database for a computer system for planning and managing at least one air travel trip, including: an aircraft table, an airport table, an card table, an city table, an client table, an communications systems table, an country table, an identification and passwords table, an macro table, an miscellaneous communications table, an persons table, an services table, an vendor providers table, an missing waypoint table, and an aircraft type table.

Another exemplary embodiment of the invention generally provides a trip database for a computer system for planning and managing at least one air travel trip, including: a trip ID number, a version, a client name, a registry, a pilot in command, a route, a trip begin date, a folder creation date, a billing status, an intra-country trip designator, an ARIC domestic indicator, a cancelled indicator, a locked indicator, a who locked the trip field, and a trip task table.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A system for planning and managing at least one air travel trip, comprising:
a trip database configured to organize and store system data related to at least one air travel trip within distinct data fields and tables;
a support database configured to organize the system data in distinct data tables related to at least one support function designed to support air travel;
a data engine operatively coupled to the trip database and the support database, and configured to jointly manipulate the system data held in each of the trip database and the support database; and
at least one user interface operatively coupled to the data engine, the trip database and the support database, and configured to provide user-access to the system data held in the trip database and the support database, whereby a user is able to supply and receive information in real-time on at least one air travel trip.

2. The system of claim 1, wherein the distinct data fields and tables of the trip database include:
a trip identification field;
a trip version field;
a client name field;
an aircraft registry field;
a pilot in command field;
a trip route field;
a trip begin date field;
a folder creation date field;
a billing status field;
an intra-country trip designator field;
an ARIC domestic flight indicator field;
a cancelled indicator field;
a locked indicator field;
a locked by field; and
a trip task table.

3. The system of claim 1, wherein the distinct data tables of the trip database include:
an aircraft table;
an airport table;
a charge card table;
a city table;
a client table;
a communications systems table;
a country table;
an identification and passwords table;
a macro table;
a miscellaneous communications table;
a persons table;
a services table;
a vendor providers table;
a missing waypoint table; and
an aircraft type table.

4. The system of claim 1, wherein the data engine further comprises:
a table engine configured to organize and access related system data held in the distinct fields and tables of the trip database and the support database;
an audit engine configured to identify missing or potentially inconsistent trip data held in the distinct fields and tables of the trip database and the support database;
an auto-fill engine configured to fill-in missing trip data held in the distinct fields and tables of the trip database and the support database and based on the rules and preferences established in the support database; and
an archive engine configured to archive trip data as the data is added and/or modified.

5. The system of claim 1, wherein the at least one user interface further comprises:
an access engine configured to provide multi-user access to the air travel trip data from multiple locations and via multiple communication links; and
an I/O engine configured to control the flow of air travel trip data between the system and various users from multiple locations and via multiple communication links.

6. The system of claim 1, further comprising:
an operational center configured to house the system within a controlled area; and
an operator having access to the controlled area, wherein the at least one user interface is accessible from within and/or without the controlled area through a plurality of external user interfaces.

7. The system of claim 6 wherein the plurality of external user interfaces provides access for at least one client from without the controlled area to the trip database, support database and data engine in order to plan, manage, and execute a trip.

8. The system of claim 7 wherein the at least one client is capable of communicating through at least one of the external user interfaces by employing third-party trip management software.

9. The system of claim 6 wherein the plurality of external user interfaces provides access to at least one flight service vendor from without the controlled area to the trip database, support database and data engine in order to review, manage, and execute flight service vendor data.

10. A method for planning and managing at least one air travel trip, comprising:
organizing and storing system data related to at least one air travel trip within distinct data fields and tables using a trip database;
organizing the system data into distinct data tables using a support database wherein the distinct data tables relate to at least one support function designed to support air travel;
manipulating the system data held in the trip database and the support database jointly with a data engine operatively coupled to the trip database and the support database; and
providing user-access to the system data held in the trip database and the support database through at least one user interface operatively coupled to the data engine, the trip database and the support database whereby a user is able to supply and receive information in real-time on at least one air travel trip.

11. The method of claim 10, wherein the distinct data fields and tables of the trip database include:
a trip identification field;
a trip version field;
a client name field;
an aircraft registry field;
a pilot in command field;
a trip route field;
a trip begin date field;
a folder creation date field;
a billing status field;
an intra-country trip designator field;
an ARIC domestic flight indicator field;
a cancelled indicator field;
a locked indicator field;
a locked by field; and
a trip task table.

12. The method of claim 10, wherein the distinct data fields and tables of the trip database include:
an aircraft table;
an airport table;
a charge card table;
a city table;
a client table;
a communications systems table;
a country table;
an identification and passwords table;
a macro table;
a miscellaneous communications table;
a persons table;
a services table;
a vendor providers table;
a missing waypoint table; and
an aircraft type table.

13. The method of claim 10 wherein the step of manipulating data further includes:
organizing and accessing related system data held in the distinct fields and tables of the trip database and the support database by using a table engine;
identifying missing or potentially inconsistent trip data held in the distinct fields and tables of the trip database and the support database by using an audit engine;
filling in missing trip data held in the distinct fields and tables of the trip database and the support database and based on rules and preferences established in the support database by using an auto-fill engine; and
archiving trip data as the data is added or modified by using an archive engine.

14. The method of claim 10 wherein the step of providing user-access to the system data further includes:
facilitating multi-user access to the air travel trip data from multiple locations and via multiple communication links by using an access engine; and
controlling the flow of the air travel trip data between the system and various users from multiple locations and via multiple communication links with an I/O engine.

15. The method of claim 10, further comprising the steps of:
housing the data engine, the support database, the trip database, and the at least one user interface within a controlled area of an operational center; and
granting an operator access to the controlled-area, wherein the at least one user interface is accessible from within and/or without the controlled area through a plurality of external user interfaces.

16. The method of claim 15 wherein the plurality of external user interfaces provides access for at least one client from without the controlled area to the trip database, support database and data engine in order to plan, manage, and execute a trip.

17. The method of claim 16 wherein the at least one client is capable of communicating through at least one of the external user interfaces by employing third-party trip management software.

18. The method of claim 15 wherein the plurality of external user interfaces provides access to at least one flight service vendor from without the controlled area to the trip database, support database and data engine in order to review, manage, and execute flight service vendor data.

19. A computer readable medium containing instructions for a computer to perform a method for planning and managing at least one air travel trip, comprising instructions for:
providing a trip database configured to organize and store system data related to at least one air travel trip within distinct data fields and tables;
providing a support database configured to organize the system data related to at least one support function configured to support air travel in distinct data tables;
manipulating the system data held in the trip database and the support database jointly with a data engine operatively coupled to the trip database and the support database; and
providing user-access to the system data held in the trip database and the support database through at least one user interface operatively coupled to the data engine, the trip database and the support database thereby producing information on at least one air travel trip.

20. The computer readable medium of claim 19 wherein the instructions for manipulating data further include instructions for:
providing a table engine configured to organize and access related system data held in the distinct fields and tables of the trip database and the support database;
providing an audit engine configured to identify missing or potentially inconsistent trip data held in the distinct fields and tables of the trip database and the support database;
providing an auto-fill engine configured to fill-in missing trip data held in the distinct fields and tables of the trip database and the support database and based on rules and preferences established in the support database; and
providing an archive engine configured to archive trip data as the data is added and/or modified.

21. The computer readable medium of claim 19 wherein the instructions for providing user-access to the system data further include the instructions for:
providing an access engine configured to facilitate multi-user access to the air travel trip data from multiple locations and via multiple communication links; and
providing an I/O engine configured to control the flow of the air travel trip data between the system and various users from multiple locations and via multiple communication links.

22. The computer readable medium of claim 19, further comprising the instructions of:
providing an operational center configured to house the data engine, the support database, the trip database, and the at least one user interface within a controlled area; and
granting an operator access to the controlled area, wherein the at least one user interface is accessible from within and/or without the controlled area through a plurality of external user interfaces.

23. The computer readable medium of claim 22 wherein the plurality of external user interfaces provides access for at least one client from without the controlled area to the trip database, support database and data engine in order to plan, manage, and execute a trip.

24. The computer readable medium of claim 23 wherein the at least one client is capable of communicating through at least one of the external user interfaces by employing third-party trip management software.

25. The computer readable medium of claim 22 wherein the plurality of external user interfaces provides access to at least one flight service vendor from without the controlled area to the trip database, support database and data engine in order to review, manage, and execute flight service vendor data.
